(19) United States
(12) Patent Application Publication
(10) Pub. No.: US 2026/0210986 A1
(43) Pub. Date: Jul. 23, 2026

(54) INSTRUMENTATION OF OPTICAL GENOME MAPPING SYSTEMS

(71) Applicant: Bionano Genomics, Inc., San Diego, CA (US)

(72) Inventor: Werner Willemse, San Diego, CA (US)

(21) Appl. No.: 19/142,882

(22) PCT Filed: Dec. 26, 2023
(86) PCT No.: PCT/US2023/085880

§ 371 Date: Jun. 24, 2025

Related U.S. Application Data
(60) Provisional application No. 63/435,273, filed on Dec. 25, 2022.
(60) Provisional application No. 63/516,523, filed on Jul. 30, 2023.

(51) Int. Cl. G01N 35/02; G01N 21/64; G01N 35/04

(52) U.S. Cl. CPC G01N 35/025; G01N 21/6428; G01N 21/6458; G01N 35/04; G01N 2021/6439; G01N 2035/0441; G01N 2035/0475

(57) ABSTRACT

Provided include instrumentation designs and operating mechanisms for optical genome mapping (OGM) systems.

### RELATED APPLICATIONS

The present application is a U.S. national phase application under 35 U.S.C. § 371 of International Application No. PCT/US2023/085880, filed on Dec. 26, 2023 and published as WO 2024/145270 A1 on Jul. 4, 2024, which claims the benefit under 35 U.S.C. § 119 (e) of U.S. Provisional Patent Application Ser. No. 63/435,273, filed Dec. 25, 2022; and U.S. Provisional Patent Application Ser. No. 63/516,523, filed Jul. 30, 2023. The content of each of these related applications is incorporated herein by reference in its entirety for all purposes.

### BACKGROUND

The present disclosure generally relates to Optical Genome Mapping (OGM). More specifically, instrumentation design of OGM systems.

OGM is powerful technique for analyzing biological analytes. Using an OGM system, a biological sample can be loaded into a fluidic device, e.g., a container or a microfluidic cartridge having a fluidic chamber or a more complex fluidic network, and then at least a portion of the fluidic device is imaged to detect one or more analytes in the biological sample. The analytes can be nucleic acids, for example DNA (including high molecular weight genomic DNA (gDNA)). OGM can be used to interrogate genome structural variation (SV) in megabase length DNA molecules outside the detection range of next generation sequencing (NGS). These genome mapping in fluidic channel technologies, such as nick label repair stain chemistry (NLRS) or directly labeled (non-damaging) using the direct label and stain chemistry (DLS) (both from Bionano Genomics, San Diego, CA), are able to generate structurally accurate genome assemblies for large and complex plant and animal genomes.

### SUMMARY

Disclosed herein include carousels of such as carousels for microscopy, including fluorescent microscopy (e.g., optical genome mapping). In some embodiments, a carousel comprises a plurality of parallel processing lines (or units). Each parallel processing line (or unit) can hold (or can be for holding) a cartridge (e.g., any cartridge disclosed herein). A parallel processing line (or unit) can comprise a set of electrical contacts (e.g., 2 electrical contracts). The set of electrical contacts can be for electrophoretically loading a nucleic acid sample (e.g., a DNA sample) into channels (e.g., nanochannels) in a flow cell of the cartridge.

In some embodiments, the plurality of parallel processing lines (or units) comprises 2, 3, 4, 5, 6, 7, 8, 9, 10, 11, 12, 13, 14, 15, 16, 17, 18, 19, 20, 21, 22, 23, 24, 25, or a number or a range between any two of these values, parallel processing lines. In some embodiments, the plurality of parallel processing lines comprises 15 parallel processing lines.

Disclosed herein include systems for microscopy, including fluorescent microscopy (e.g., optical genome mapping). In some embodiments, an OGM system can comprise any system, subsystem, platform, or component disclosed herein. In some embodiments, an OGM system comprises a carousel of the present disclosure. In some embodiments, the carousel is upstream of an imaging subsystem of the OGM system. In some embodiments, the carousel is physically detached from motion axes of the imaging subsystem.

In some embodiments, the imaging subsystem is associated with or comprises a motion platform. The motion platform can be for (or can be capable of) holding the cartridge and imaging the DNA sample. In some embodiments, the motion platform comprises 2 motors for adjusting a x-y motion stage. The motion platform can comprise a tip and the tilt (TnT) motion stage of the motion platform.

In some embodiments, a set of consumable engagement effectors (e.g., 2 consumable engagement effectors) is associated with or comprised in the imaging subsystem. The set of consumable engagement effectors can be activated based on a position of the x-y motion stage. A cartridge can be a consumable.

In some embodiments, the imaging subsystem is associated with or comprises a set of electrical contacts (e.g., 2 electrical contacts). In some embodiments, the set of electrical contacts are spring-loaded. The set of electrical contacts can be for electrophoretically loading a nucleic acid sample (e.g., a DNA sample) into channels in a flow cell of the cartridge. In some embodiments, the imaging subsystem is associated with or comprises a set of consumable engagement effectors (e.g., 2 consumable engagement effectors). The set of consumable engagement effectors can comprise the set of electrical contacts. The set of consumable engagement effectors can contribute or enable to precisely positioning the cartridge.

In some embodiments, the cartridge comprises a set of cartridge electrical contacts (e.g., 2 cartridge electrical contacts; e.g., wires, such as U-shaped wires of a cartridge described herein). The set of cartridge electrical contacts can be for contacting the set of electrical contacts. In some embodiments, the cartridge comprises two notches each comprising a cartridge electrical contact of the set of cartridge electrical contacts. The two notches can be V-shaped. The two notches can be at opposite sides of the cartridge. The set of consumable engagement effectors can be capable of engaging with the two notches.

In some embodiments, the OGM system comprises a cartridge transfer mechanism. The cartridge transfer mechanism can be for transferring the cartridge between the imaging subsystem, the carousel, and a shuttle mechanism. In some embodiments, the cartridge transfer mechanism comprises an arm mounted to a rotary motor.

In some embodiments, the OGM system comprises a shuttle mechanism. The shuttle mechanism can be for transferring a cartridge from a nest external of the OGM instrument to a floating core of the OGM instrument. In some embodiments, the shuttle mechanism comprises a motion axis. In some embodiments, the motion axis comprises a zone spatially located related to a chassis of the OGM instrument and/or a zone spatially located relative to a floating core of the OGM instrument. In some embodiments, the motion axis is detached from a floating core of the OGM instrument when not transferring a cartridge from a nest external of the OGM instrument to a floating core of the OGM instrument.

### BRIEF DESCRIPTION OF THE DRAWINGS

FIGS. 1A-1C depict a non-limiting embodiment of carousel wheel

FIG. 2 depicts a non-limiting embodiment of the instrumentation design described herein.

FIG. 3 depicts a non-limiting exemplary consumable mechanism of an OGM system.

FIG. 4 illustrates a non-limiting exemplary illustration of a motion platform.

FIG. 5 shows a non-limiting exemplary illustration of components of a motion platform for adjusting an axis (a tip axis illustrated) of a motion stage (e.g., a tip and tilt motion stage).

FIG. 6 shows a non-limiting exemplary illustration of components of a motion platform for adjusting an axis (a tilt axis illustrated) of a motion stage (e.g., a tip and tilt motion stage).

FIG. 7 shows a non-limiting exemplary illustration of adjusting an axis (a tilt axis illustrated) of a motion stage (e.g., a tip and tilt motion stage).

FIGS. 8A-8Z and 8AA-8AD are frames of a video showing a non-limiting exemplary adjustment of an axis (a tip axis illustrated) of a motion stage (e.g., a tip and tilt motion stage) followed by a non-limiting exemplary adjustment of another axis (a tilt axis illustrated) of the motion stage. The design presented herein can move the Y axis to the edge of its travel where it engages with a pawl (FIGS. 8A-8B; see FIGS. 4-5) which permits the sample carrier to be moved along two inclined journals (goniometers) that can affect the tip axis (FIGS. 8C-8K; see FIGS. 4-5). The design thereafter can move the Y axis to the opposite end where a different pawl engages a slanted bearing (FIGS. 8L-8Y; see FIGS. 6-7). Once the secondary pawl is engaged with the slanted bearing, motion in the X-axis affects an effective tilt motion (FIGS. 8Z-8AB; see FIGS. 6-7). This novel design enables four axes (tip, tilt, x, y) to be affected by only two motors rather than four, and the motors are mounted stationary, rather than on the TnT axis, thereby further reducing the moving-mass.

FIG. 9. Exemplary gradient planes and angles definitions.

FIG. 10A. Exemplary leveling measurement during alignment measures chip gradient φC.

FIG. 10B. Exemplary image Z stack measures the difference between the chip plane and the FOV focal plane, φ_{L}.

FIG. 11. Exemplary hardware configuration parameters.

FIG. 12. Exemplary planar transform.

FIG. 13. Exemplary internal X, Z coordinate system.

FIG. 14. Exemplary parametric t calculation.

FIG. 15. Exemplary plate correction.

FIG. 16. Exemplary q approximation.

FIG. 17. Exemplary stage X offset to apply X component of gradient.

FIG. 18. Exemplary rotational shift x and z components.

FIG. 19. Exemplary plate vector calculations.

FIG. 20. Exemplary calibrating gonio slopes. Residuals added until desired slope of 1 achieved.

FIGS. 21A-21E depict views of a non-limiting embodiment of a cartridge for microscopy, such as fluorescent microscopy (e.g., OGM). The cartridge shown is a multibody part cartridge. A bottom cover when attached to the cartridge can form a flow cell. The top surface of the bottom cover can include one or more flow channels. In the embodiment depicted, the electrodes can be solid electrodes (also referred to herein as pins). The cartridge can include a seal, which can have an overmolded TPE material, such as an overmolded Versaflex seal (the middle pieces in FIGS. 21D and 21E).

FIGS. 22A-22E depict various views of a non-limiting embodiment of a cartridge described herein (such as the embodiment depicted in FIGS. 21A-21D). A cartridge disclosed herein can be used for microscopy, such as fluorescent microscopy (e.g., OGM).

FIGS. 23A-23F show views of a non-limiting embodiment of a cartridge for microscopy, such as fluorescent microscopy (e.g., OGM). In the embodiment depicted, the electrodes can be solid electrodes (also referred to herein as pins). In the embodiment shown, wires (solid lines in FIGS. 23A-23D) can be used for electrical connectivity to an instrument, such as an OGM instrument. In the embodiment depicted, the cartridge can include a seal, which can have an overmolded TPE material, such as an overmolded Versaflex seal (which can have an oral shape as shown in FIG. 23E).

FIGS. 24A-24G illustrate non-limiting exemplary embodiments of a cartridge described herein (e.g., the embodiment of the cartridge depicted in FIGS. 23A-23F) and components of the cartridge.

FIGS. 25A-25B depict a non-limiting embodiment of a cartridge described herein (e.g., the embodiments of the cartridge depicted in FIGS. 23A-23F and/or FIGS. 24A-24G): top isomeric view and open configuration without a label (FIG. 25A) and top view and open configuration with a label (FIG. 25B).

FIGS. 26A-26C depict a non-limiting embodiment of a cartridge described herein (e.g., the embodiments of the cartridge depicted in FIGS. 23A-23F, FIG. 24A-24G, and/or FIGS. 25A-25B): a close configuration (FIG. 26A) and closed configurations (FIGS. 26B-26C).

FIGS. 27A-27C depict a non-limiting embodiment of a cartridge described herein. Relative to the embodiments of the cartridge depicted in FIGS. 23-23F, FIGS. 24A-24G, FIGS. 25A-25B, and/or FIGS. 26A-26C, the cartridge shown in FIGS. 27A-27C can include two extrusions (e.g., half-moon shaped extrusions). The two extrusions can be in contact with the wires and/or maintain the wires in contact with the base when the cartridge is in a closed configuration. A flow cell orientation key is shown in FIG. 27B.

FIG. 28 illustrates a non-limiting exemplary workflow of OGM.

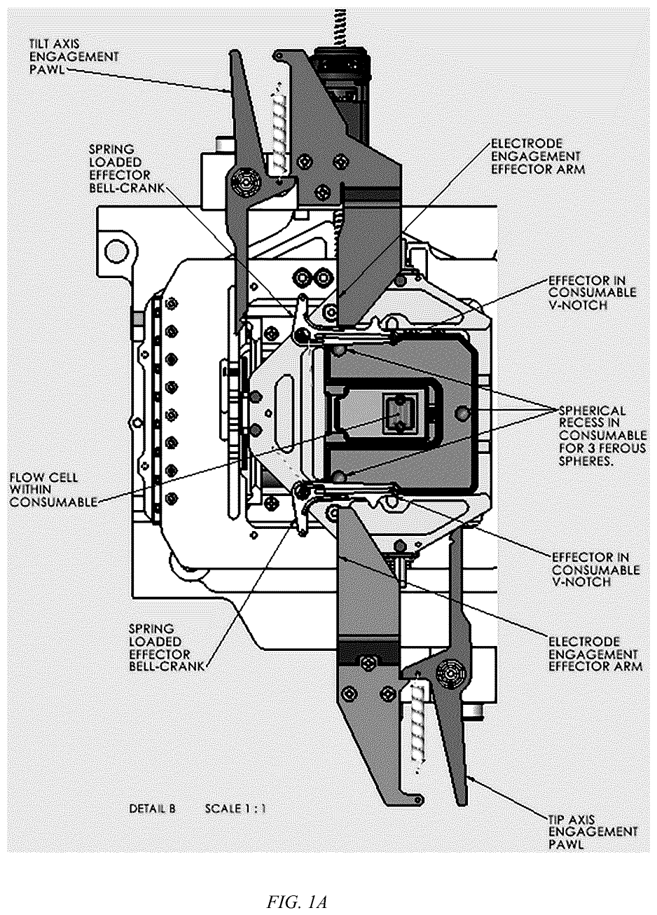

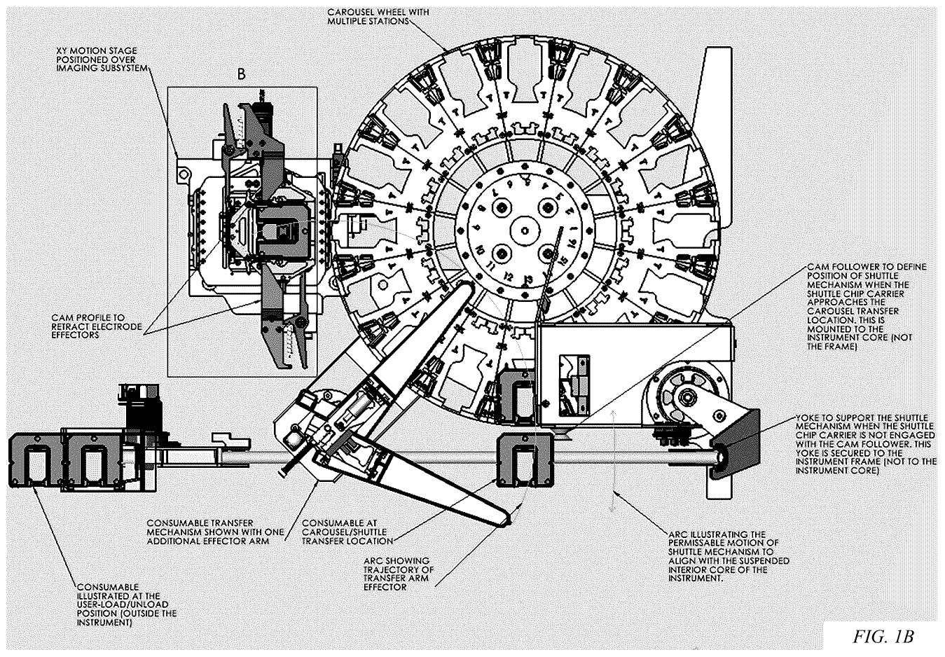

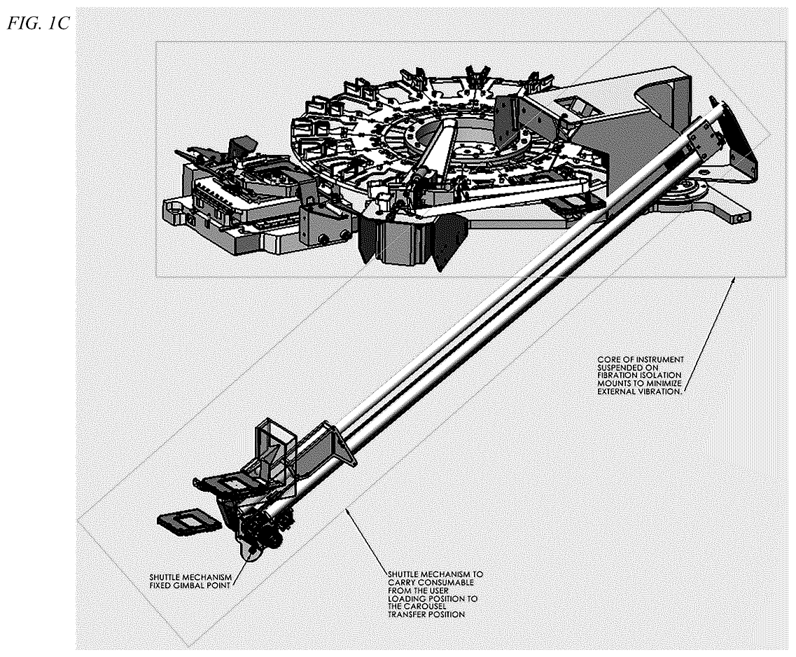

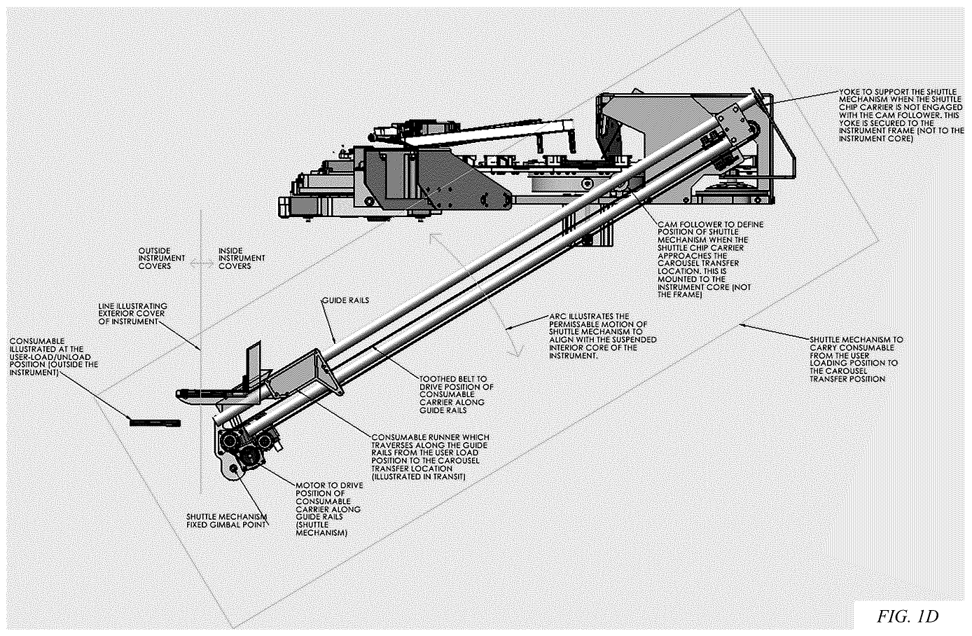

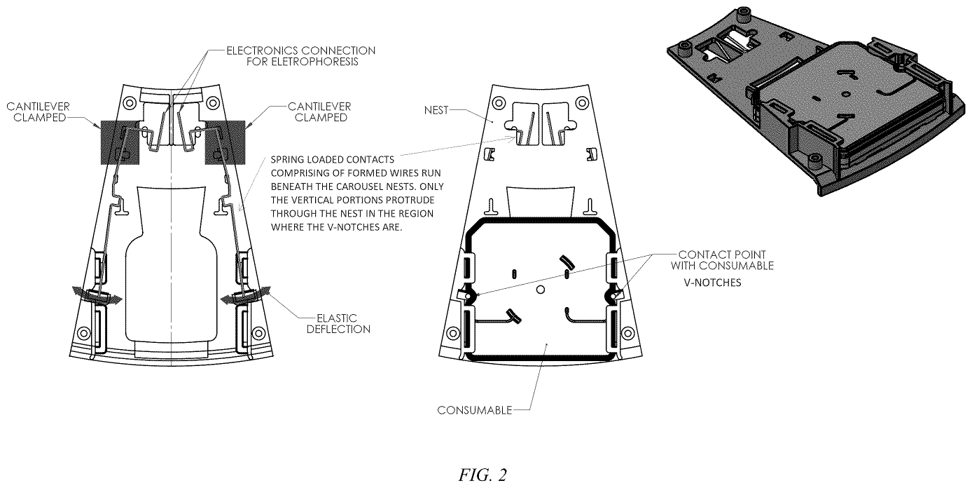

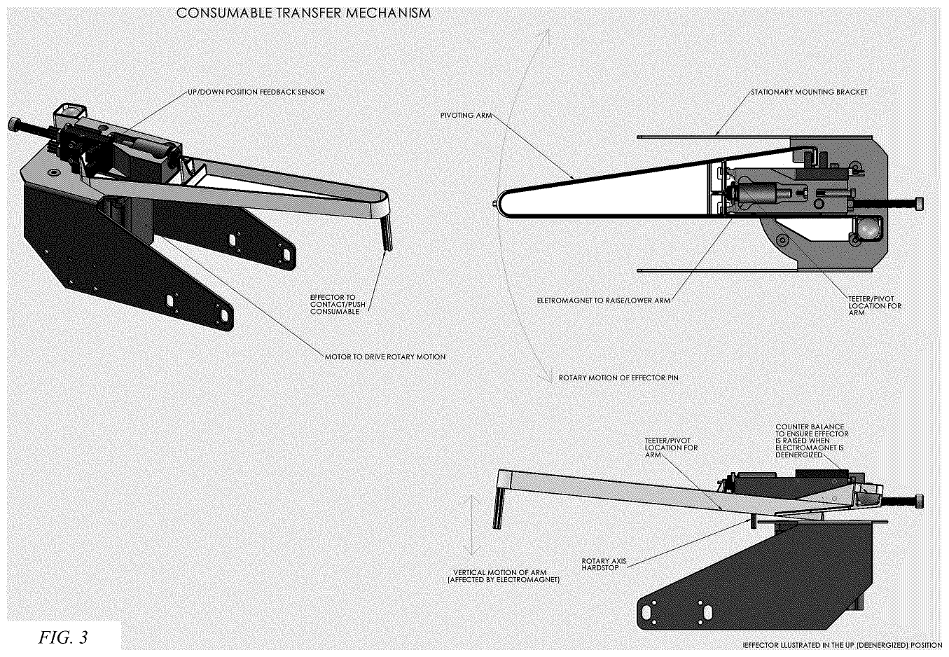

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein and made part of the disclosure herein.

All patents, published patent applications, other publications, and sequences from GenBank, and other databases referred to herein are incorporated by reference in their entirety with respect to the related technology.

Disclosed herein include carousels of such as carousels for microscopy, including fluorescent microscopy (e.g., optical genome mapping). In some embodiments, a line (or unit) can hold (or be for holding) a cartridge (e.g., any cartridge disclosed herein). A parallel processing line (or unit) can comprise a set of electrical contacts (e.g., 2 electrical contacts). The set of electrical contacts can be for electrophoretically loading a nucleic acid sample (e.g., a DNA sample) into channels (e.g., nanochannels) in a flow cell of the cartridge.

Disclosed herein include systems for microscopy, including fluorescent microscopy (e.g., optical genome mapping). In some embodiments, an OGM system can comprise any system, subsystem, platform, or component disclosed herein. In some embodiments, an OGM system comprises a carousel of the present disclosure. In some embodiments, the carousel is upstream of an imaging subsystem of the OGM system. In some embodiments, the carousel is physically detached from motion axes of the imaging subsystem.

### Exemplary OGM Instrumentations

Instrumentation design generally requires a system architecture that maximizes the quantity of quality data output, at minimum instrument cost. The design of optical genome mapping (OGM) systems similarly prefers that high quality data (e.g., maximum quality-data) are gathered, while using the low cost instrument subsystems. OGM instrumentation costs are largely impacted by the costs of the imaging subsystem (e.g., excitation lasers, camera, lenses, and optical filters), rather than the ancillary components that make up the rest of the instrument. The optimal architecture requires balancing the throughput capability of the instrument subsystems, and ensuring high utilization of the costliest subsystem at all times. In some embodiments, subsystems are preferably quicker (e.g., marginally quicker) than the imaging subsystem. Instrument architectures suitable to achieve these needs are disclosed herein.

In the study of production process optimization, the Theory of Constraints (ToC) highlights a “Drum-Buffer-Rope” schema to optimize throughput. “Drum” refers to the tact time of the slowest subsystem. “Buffer” refers to the need for an instantaneous supply which can be pulled by the “Rope”, to feed the slowest subsystem without delay. Due to the high component costs, the imaging subsystem is identified as the Capacity Constrained Resource (CCR) which must be highly utilized (e.g., 100% utilized) constantly (e.g., at all times). The instrument architectures disclosed herein include a carousel wheel that serves as the “buffer”. Parallel processing on the carousel enables the system to pull (“rope”) product to the CCR (at its own drumbeat) when needed, to ensure high utilization (including maximal utilization) of the imaging subsystem.

OGM instrumentation enables repeatedly loading DNA into nanochannels within the consumable, imaging the DNA, and purging the imaged DNA from the nanochannels by electophoretically loading new DNA into the nanochannels. This process can be repeated many times per sample. Since loading the DNA into the nanochannels takes ~10× longer than imaging the DNA in the nanochannels, at least 10 parallel processing lines are required to ensure that the imaging subsystem remains the CCR. In the OGM instrumentation design described herein, multiple (e.g., 5, 10, 15, 16, 17, 18, 19, 20, 25, 30, 40, or more, or a number or a range between any two of these values) positions (each position can include, e.g., one or more sets of electrical contacts) are provided on the carousel to ensure excess supply of chips ready for imaging. In some embodiments, 15 positions (each position can include, e.g., one or more sets of electrical contacts) are provided on the carousel. In some embodiments, 15 sets of electrical contacts are provided on carousel. Also described herein include electrical connections to the multiple positions within the carousel. It can be advantageous, in some embodiments, for the process of electrophoretically loading DNA into the nanochannels to use the imaging system to visualize the movement of the DNA for facilitating and/or guiding the process. In such embodiments, one or more sets of electrical contacts can be provided on the imaging subsystem, for example, one set of electrical contacts is included in the imaging subsystem so that the total number of electrical contact sets can be 16 (e.g., 15 on the carousel plus 1 on the imaging subsystem).

In some embodiments, the electrical contacts on the carousel can be comprised of static spring-loaded wires positioned laterally on either side of each chip location. In some embodiments, chamfered edges on both leading corners of the chip enables insertion of the chip between each set of spring-loaded contacts on the carousel. For example, the spring-loaded wires on either side of the chip can retain the chip in position by engaging with a V-shaped notch on either side of the consumable. Electrical contacts from said notches can be provided to the DNA sample within the chip.

It is advantageous for chips transferred to the imaging station from the carousel to be located precisely following each transfer. This can reduce the time required for the instrument to realign the chip with the optical system by visually searching for features on the chip. As described herein, the OGM instrumentation design, in some embodiments, uses actively actuated electrical effectors utilized to make electrical contact with the chip and additionally precisely positions the chip in the imaging subsystem thereby reducing the time needed for the instrument to visually search and align to the regions of interest before scanning of the DNA starts.

In some embodiments, the chip is precisely located on the imaging subsystem by a kinematic mounting scheme. Three spherical ferrous lobes within the consumable can, for example, be attracted to three magnets mounted within the imaging platform. These three points establish the Z-plane. Two electrodes engages with the two notches on either side of the consumable to establish electrical contact and to physically position the consumable along a definitive line. Five of the six degrees of freedom have been defined. The remaining degree of freedom is to define the consumable's position along said line between the two notches. This is achieved by designing the one electrical contact to exert substantially higher force than the opposing electrical contact. That way the consumable is biased against an definitive edge close to the weaker v-notch. Actuation of the electrical effectors that make contact within the V-shaped notches is performed by moving the XY motion stage to a region beyond the travel limits where DNA is scanned. At this extended travel location a cam profile retracts the electrical effectors. By using the existing XY motion axes that are mainly intended for raster scanning we achieve a secondary actuation means without adding an additional motion axis. This can reduce overall instrument cost and lower the physical mass of the XY motion platform. The overall mass of the XY stage is directly related to its ability to accelerate, and therefore speed.

The chips can be moved between the carousel and the imaging station by means of a rotary swingarm which can be raised or lowered by means of an electromagnet mounted on the swingarm.

External vibration can significantly compromise the image quality of the DNA being scanned. For this reason the entire inner functional core of the instrument is mounted on a floating platform that isolates it from instrument chassis. External vibration effects will be reduced, however the physical position of the floating core cannot be well defined given the intentionally low stiffness between the chassis and the core. High throughput installations of the instrument will require a robot to load and unload consumables from the instrument autonomously. The precise spatial placement accuracy of a robot creates a challenge given the relatively poor spatial positioning of the floating internal core. To overcome this challenge the present disclosure implements a motion axis that shuttles the consumables from a nest external of the instrument to a handoff position with the floating core of the instrument. This axis is mounted on a gimbal on the end where interfacing with the outside world occurs. The opposite end of the axis is able to float and align with the floating core when consumables are being transferred to the floating core, but is physically detached from the when transfers are not being made, thereby preventing external vibration from being coupled from the exterior environment to the sensitive internal core. A motor moves a chip carrier along linear rails between the load/unload position and the location where the consumables are transferred to the floating core. This handoff is at the carousel location. The same transfer mechanism that moves consumables from the carousel to the imaging station is used to move consumables from the shuttle to the carousel.

Disclosed herein includes a parallel processing buffering scheme upstream of the imaging subsystem (e.g., the imaging subsystem of a Saphyr® or Marvel OGM system or newer of Bionano Genomics, Inc.). The buffering described herein can be detached from the imaging station. In some embodiments, the buffering scheme is physically detached from the imaging subsystem's motion axes. Without being bound to any particular theory, it is believed that such design can reduce mass and improve speed.)

In some embodiments, effectors are used to make electrical contact with the consumable (for electrophoresis) of the OGM system. The same effectors can be used to position the consumable.

Also disclosed herein includes a consumable comprising of integral electrical contacts capable of automatically engaging with the instrument described herein to enable electrophoresis. The disclosure herein includes defining a motion platform wherein the travel range is subdivided into sequential functional activities to thereby effectively achieve four degrees of motion while using only two motion axes. Also disclosed includes a motion platform wherein the travel range is subdivided into sequential functional activities to thereby achieve controlled actuation of the consumable engagement effectors without adding an additional motion axes.

As described herein, electrical contacts with the consumable can be achieved for electrophoresis by physically inserting the consumable between a set of spring-loaded contacts (rather through a motorized means). In some embodiments, the physical insertion of the consumable between the set of spring-loaded contacts is the only electrical contacts with the consumable used for electrophoresis. This embodiment relates to the operation on the carousel's multiple positions that are passive rather than the actuated effectors at the imaging station.

Disclosed herein includes a mechanism for moving a consumable between various stations (e.g., carousel, imaging) comprising of an arm mounted to rotary motor, and having a means to effect the engagement of the arm with the consumable.

Disclosed herein includes a shuttle mechanism for OGM systems. In some embodiments, the shuttle mechanism includes a motion axis configured to have at least one zone that is spatially located relative to the instrument chassis (lab bench), and at least one zone that is spatially located relative to a free-floating (suspended vibration isolated) core of the instrument, wherein said axis physically connects to the floating core of the instrument exclusively when consumables are being transferred between said axis and the fee-floating core.

Disclosed herein include carousels of such as carousels for microscopy, including fluorescent microscopy (e.g., optical genome mapping). In some embodiments, a line (or unit) can hold (or be for holding) a cartridge (e.g., any cartridge disclosed herein). A parallel processing line (or unit) can comprise a set of electrical contacts (e.g., 2 electrical contacts). The set of electrical contracts can be for electrophoretically loading a nucleic acid sample (e.g., a DNA sample) into channels (e.g., nanochannels) in a flow cell of the cartridge.

In some embodiments, the plurality of parallel processing lines (or units) comprises 2, 3, 4, 5, 6, 7, 8, 9, 10, 11, 12, 13, 14, 15, 16, 17, 18, 19, 20, 21, 22, 23, 24, 25, or a number or a range between any two of these values, parallel processing lines. In some embodiments, the plurality of parallel processing lines comprises 15 parallel processing lines.

Disclosed herein include systems for microscopy, including fluorescent microscopy (e.g., optical genome mapping). In some embodiments, an OGM system can comprise any system, subsystem, platform, or component disclosed herein. In some embodiments, an OGM system comprises a carousel of the present disclosure. In some embodiments, the carousel is upstream of an imaging subsystem of the OGM system. In some embodiments, the carousel is physically detached from motion axes of the imaging subsystem.

In some embodiments, the imaging subsystem is associated with or comprises a motion platform. The motion platform can be for (or can be capable of) holding the cartridge and imaging the DNA sample. In some embodiments, the motion platform comprises 2 motors for adjusting a x-y motion stage. The motion platform can comprise a tip and the tilt (TnT) motion stage of the motion platform.

In some embodiments, a set of consumable engagement effectors (e.g., 2 consumable engagement effectors) is associated with or comprised in the imaging subsystem. The set of consumable engagement effectors can be activated based on a position of the x-y motion stage. A cartridge can be a consumable.

In some embodiments, the imaging subsystem is associated with or comprises a set of electrical contacts (e.g., 2 electrical contracts). In some embodiments, the set of electrical contacts are spring-loaded. The set of electrical contracts can be for electrophoretically loading a nucleic acid sample (e.g., a DNA sample) into channels in a flow cell of the cartridge. In some embodiments, the imaging subsystem is associated with or comprises a set of consumable engagement effectors (e.g., 2 consumable engagement effectors). The set of consumable engagement effectors can comprise the set of electrical contacts. The set of consumable engagement effectors can contribute or enable to precisely positioning the cartridge.

In some embodiments, the cartridge comprises a set of cartridge electrical contacts (e.g., 2 cartridge electrical contacts; e.g., wires, such as U-shaped wires of a cartridge described herein). The set of cartridge electrical contracts can be for contacting the set of electrical contacts. In some embodiments, the cartridge comprises two notches each comprising a cartridge electrical contact of the set of cartridge electrical contacts. The two notches can be V-shaped. The two notches can be at opposite sides of the cartridge. The set of consumable engagement effectors can be capable of engaging with the two notches.

In some embodiments, the OGM system comprises a cartridge transfer mechanism. The cartridge transfer mechanism can be for transferring the cartridge between the imaging subsystem, the carousel, and a shuttle mechanism. In some embodiments, the cartridge transfer mechanism comprises an arm mounted to a rotary motor.

In some embodiments, the OGM system comprises a shuttle mechanism. The shuttle mechanism can be for transferring a cartridge from a nest external of the OGM instrument to a floating core of the OGM instrument. In some embodiments, the shuttle mechanism comprises a motion axis. In some embodiments, the motion axis comprises a zone spatially located related to a chassis of the OGM instrument and/or a zone spatially located relative to a floating core of the OGM instrument. In some embodiments, the motion axis is detached from a floating core of the OGM instrument when not transferring a cartridge from a nest external of the OGM instrument to a floating core of the OGM instrument.

### Exemplary Motion Platforms

### Exemplary Motion Platform Design

Microscopy instruments, such as fluorescent imaging instruments (e.g., optical genome mapping (OGM) instruments), can require high-magnification optics to produce images with sufficiently resolution of the molecules being imaged (e.g., DNA molecules being imaged). High-magnification optics can have a narrow depth-of-focus, meaning that the sample being imaged must be placed precisely at the appropriate distance from the optics to produce focused images. Throughput of instruments can be generally proportionate to the field of view (FoV) size of images acquired. Instrument architecture can therefore require the largest possible FoV size, however, at the cost of having to precisely position the sample at the precise distance from the optics. To position samples at the precise position relative to the optics, microscopy instruments can generally employ an XY motion stage (or XY stage), paired with a Tip and Tilt (TnT) motion stage (Or TnT stage). The XY motion stage (or XY stage) is also referred to herein as an x-y motion stage (or x-y stage). The XY motion stage can move the center of the FoV to the appropriate location of the sample to be imaged, while the TnT stage can pivot to an appropriate plane to ensure that the FoV (e.g., the complete or entire FoV or a sufficiently large FoV) is sufficiently perpendicular to the optical axis. Images acquired without the appropriate TnT adjustment can produce images with only a portion (e.g., a linear portion) of the image being in focus rather than the entire FoV (or a sufficient large FoV) being in focus.

A lot of (e.g., most of) fluorescence microscopy instruments raster scans many successive images. Thus, minimizing move times between FoVs to maximize instrument throughput can be advantageous. To minimize move times, the moving mass can be kept to a minimum. Motorized TnT motion mechanisms are generally heavy. To minimize moving mass, microscopy instruments can therefore be architected with the XY motion stage on top of the TnT motion stage. This design has historically produced the lowest moving-mass design. However this design can introduce a fundamental constraint.

The dynamic nature of TnT stages means that they have poor structural stiffness (which can be almost by design). By mounting the XY stage on top of a TnT stage, a lightweight design is achieved; however the XY motion (also referred to herein as x-y motion) can impart a shockwave impulse into the structure that vibrationally perturbs it. A lengthy ringdown period after the XY move (also referred to herein as x-y move) can be required to dissipate the energy before image acquisition can start. Initiating image acquisition before resonance has been attenuated can produce blurry images. Fluorescent imaging, such as OGM imaging, can require attenuation of resonance to less than, for example, 40 nm before imaging may commence. For reference, this is approximately 1/10^{th} the wavelength of blue light, and can be exceptionally challenging to achieve consistently.

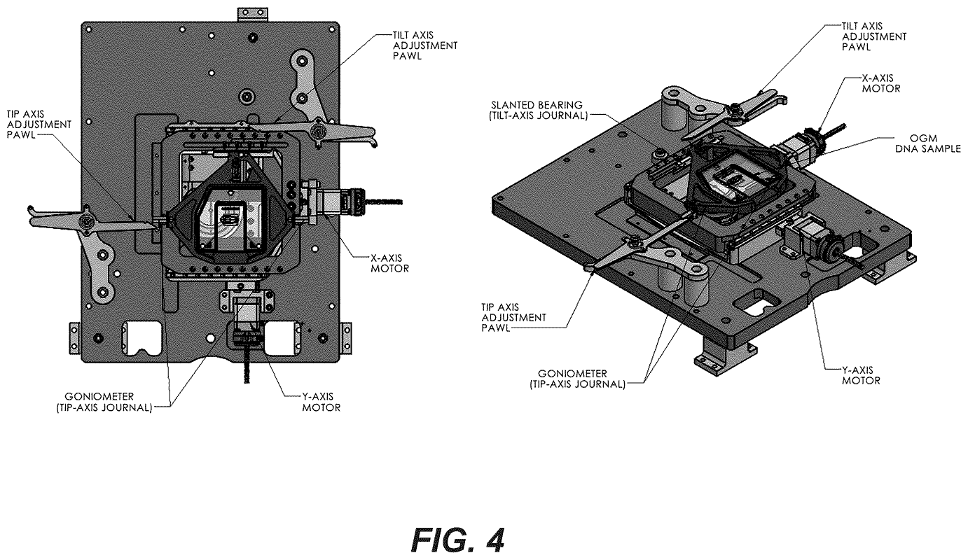

An alternative design (or architecture) is disclosed herein with the mass of the TnT stage being substantially reduced to a point where it can be mounted on top of the XY stage, rather than beneath it (see FIG. 4 for an illustration). This architecture presents a mass lighter (nimbler) than legacy designs and can avert the fundamental flaw of mounting an XY axis on a TnT stage which inherently compromises structural stiffness.

Legacy TnT stages employ a servo-controlled motor for each of the tip and tilt axes. Each of these axes will furthermore require journals or bearings to allow the motion of each axis. The motors can typically constitute the majority of the mass that renders legacy designs too heavy to be mounted on top of XY stages. The novel design disclosed herein can minimize (e.g., completely omit) the motors that drive the tip and tilt axes. The design being presented can utilize the underlying XY motors to adjust the TnT axes before commencing with raster scanning. Legacy systems would control the four servo motors that control X, Y, tip, and tilt independently.

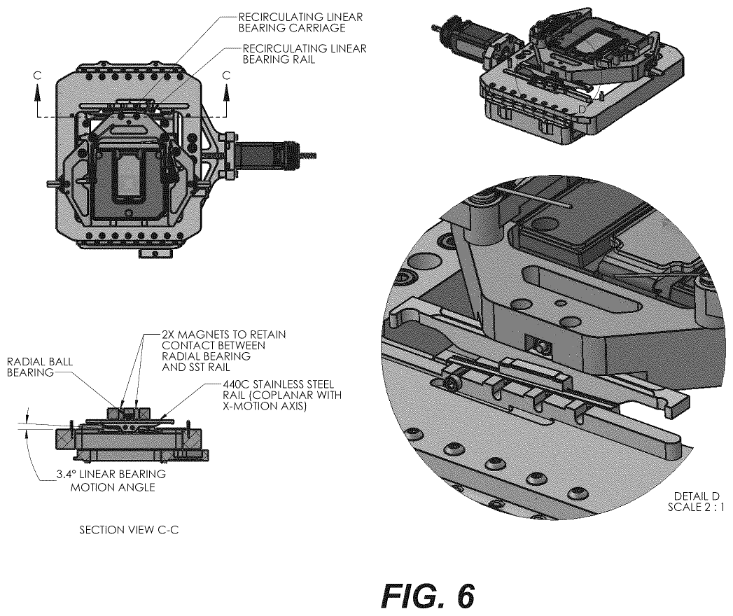

In some embodiments, the design presented herein can move the Y axis to the edge of its travel where it engages with a pawl (see FIGS. 4-5 and FIGS. 8A-8B for illustrations) which permits the sample carrier to be moved along two inclined journals (goniometers) that can affect the tip axis (see FIGS. 4-5 and FIGS. 8C-8K for illustrations). The system thereafter can move to the opposite end of the Y axis where a different pawl engages a slanted bearing (see FIGS. 6-7 and FIGS. 8L-8Y for illustrations). Once the secondary pawl is engaged with the slanted bearing, motion in the X-axis affects an effective tilt motion (see FIGS. 6-7 and FIGS. 8Z-8AB for illustrations). This novel design enables four axes (tip, tilt, x, y) to be affected by only two motors rather than four, and the motors are mounted stationary, rather than on the TnT axis, thereby further reducing the moving-mass.

Exemplary use. In some embodiments, designs disclosed herein can offer utility in high magnification microscopy applications (e.g., all high magnification microscopy applications) that employ relatively large FoVs and high numerical aperture (NA) optics.

Exemplary improvements and advantages. In some embodiments, motion times can be significantly reduced with the designs disclosed herein. For example, the move times between successive FoVs can be significantly reduced compared to legacy (or prior) designs. Prior designs can generally require ~210 milliseconds for an XY move (with ringdown), whereas the design disclosed herein can achieve an XY move in ~90 milliseconds. Such reduction can increase system throughput. In some embodiments, initial instrument cost (COGS) can be reduced (e.g., significantly reduced) since two motors perform the tasks previously requiring four motors. In some embodiments, maintenance cost can be reduced since there are fewer motors to maintain. In some embodiments, a design of the present disclosure can have a smaller physical size (more compact). In some embodiments, software required to manipulate and navigate the geometric space can be simplified and easier to develop.

Ringdown period. Long ringdown periods (e.g., about 130 milliseconds) can be reduced (e.g., to about 20 milliseconds) on the platforms disclosed herein. In some embodiments, the ringdown time is, is about, is at least, is at least about, is at most, or is at most about, 5 milliseconds (ms), 6 ms, 7 ms, 8 ms, 9 ms, 10 ms, 11 ms, 12 ms, 13 ms, 14 ms, 15 ms, 16 ms, 17 ms, 18 ms, 19 ms, 20 ms, 21 ms, 22 ms, 23 ms, 24 m, 25 ms, 26 ms, 27 ms, 28 ms, 29 ms, 30 ms, 35, ms, 40 ms, 45 ms, 50 ms, 55 ms, 60 ms, 65 ms, 70 ms, 75 ms, 80 ms, 85 ms, 90 ms, 95 ms, 100 ms, 105 ms, 110 ms, or a number or a range between any two of these values.

Motion times. The benefit can be recognized in the difference of ringdown duration. A typical move consists of a 70 millisecond move time, followed by either a 20 millisecond ringdown period (for the systems and designs disclosed herein) versus a 130 millisecond ringdown for the legacy designs. This equates to about 210 millisecond move (including ringdown time) for the legacy system compared to only 90 ms for the systems and designs disclosed herein. In some embodiments, the motion time of designs, systems, platforms, and methods of the present disclosure is, is about, is at least, is at least about, is at most, or is at most about, 70 milliseconds (ms), 75 ms, 80 ms, 85 ms, 90 ms, 95 ms, 100 ms, 105 ms, 110 ms, 115 ms, 120 ms, 125 ms, 130 ms, 135 ms, 140 ms, 145 ms, 150 ms, 155 ms, 160 ms, 165 ms, 170 ms, 175 ms, 180 ms, or a number or a range between any two of these values.

Throughput. A design of the present disclosure can have a throughput improvement (relative to the throughput of a prior design) of, of about, of at least, of at least about, of at most, or of at most about, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, 300%, 310%, 320%, 330%, 340%, 350%, 360%, 370%, 380%, 390%, 400%, or a number or a range between any two of these values.

Materials. In some embodiments, a component (e.g., a bearing) of a design disclosed herein can be made from alloys (e.g., aluminum alloys). In some embodiments, a component (e.g., a bearing) of the design herein can be fabricated from a steel (e.g., stainless steel). In some embodiments, an alloy can comprise aluminum alloys, zinc alloys, copper alloys, titanium alloys, tin alloys, beryllium alloys, bismuth alloys, chromium alloys, cobalt alloys, gallium alloys, indium alloys, iron alloys, manganese alloys, nickel alloys, rhodium alloys, or a combination thereof. In some embodiments, a component (e.g., a bearing) of the design herein can be fabricated from a steel, such as cold rolled steel, stainless steel and steel surface-treated steel. In some embodiments, a steel can be crucible steel, carbon steel, spring steel, alloy steel, maraging steel, stainless steel, high-speed steel, weathering steel, tool steel, or a combination thereof. In some embodiments, a component of the design herein can comprise brass.

Weights. The legacy designs would include two motors for the TnT functionality along with their respective supports and bearings. The collective mass for those would generally be greater than 700 grams. The presently disclosed mechanism's net weight to achieve the TnT functionality can be less than 150 grams, for example. In some embodiments, the presently disclosed mechanism's net weight to achieve the TnT functionality can be, be about, be at least, be at least about, be at most, or be at most about, 100 grams (g), 110 g, 120 g, 130 g, 140 g, 150 g, 160 g, 170 g, 180 g, 190 g, 200 g, 225 g, 250 g, 275 g, 300 g, 325 g, 350 g, 375 g, 400 g, 425 g, 450 g, 475 g, 500 g, or a number or a range between any two of these values.

Size. The design disclosed herein can result in, for example, at least a 50% reduction in physical volume consumed by the mechanisms compared to prior designs. In some embodiments, the reduction in physical volume of a design disclosed herein can be, be about, be at least, be at least about, be at most, or be at most about, 80%, 75%, 70%, 65%, 60%, 55%, 50%, 45%, 40%, 35%, 30%, 25%, or a number or a range between any two of these values.

### Exemplary Motion Platform

Disclosed herein includes embodiments of a motion platform. Referring to FIG. 4, a motion platform can comprise: a base. A dimension (e.g., length or depth) of a component of a motion platform, e.g., a base, or a component or a base, can be, be about, be at least, be at least about, be at most, or be at most about, 10 cm, 15 cm, 20 cm, 25 cm, 30 cm, 40 cm, 50 cm, 60 cm, 70 cm, 80 cm, 90 cm, 100 cm, or a number or a range between any two of these values. An area of a component of a motion platform, e.g., a base (such as top surface area where the x-y motion stage is mounted), or a component or a base of the component of the motion platform or the component of the base can be, be about, be at least, be at least about, be at most, or be at most about, 100 cm², 150 cm², 200 cm², 250 cm², 300 cm², 400 cm², 500 cm², 600 cm², 700 cm², 800 cm², 900 cm², 1000 cm², 2500 cm², 5000 cm², 7500 cm², 10000 cm², or a number or a range between any two of these values.

The motion platform can comprise: an x-y motion stage. A dimension (e.g., length or depth) of a component of a motion platform, e.g., an x-y motion stage, or a component of an x-y motion stage, can be, be about, be at least, be at least about, be at most, or be at most about, 5 cm, 6, cm, 7 cm, 8 cm, 9 am, 10 cm, 15 cm, 20 cm, 25 cm, 30 cm, 40 cm, 50 cm, 60 cm, or a number or a range between any two of these values. An area of a component of a motion platform, e.g., an x-y motion stage (such as the top surface area wherein the TnT motion stage is on), or a component of an x-y motion stage can be, be about, be at least, be at least about, be at most, or be at most about, 100 cm², 150 cm², 200 cm², 250 cm², 300 cm², 400 cm², 500 cm², 600 cm², 700 cm², 800 cm², 900 cm², 1000 cm², 2500 cm², 3000 cm², 400 cm², 5000 cm², or a number or a range between any two of these values. The x-y motion stage can be on (e.g., attached to, such as securely attached to) the base.

The motion platform can comprise: a tip-axis adjustment pawl (or a tip-axis adjustment engagement component) on the base. The motion platform can comprise: a tilt-axis adjustment pawl (or a tilt-axis adjustment engagement component) on (e.g., attached to, such as securely attached to) the base. A dimension (e.g., length or depth) of a tip-axis adjustment engagement component or tilt-axis adjustment engagement component can be, be about, be at least, be at least about, be at most, or be at most about, 2 cm, 3 cm, 4 cm, 5 cm, 6 cm, 7 cm, 8 cm, 9 cm, 10 cm, 11 cm, 12 cm, 13 cm, 14 cm, 15 cm, or a number or a range between any two of these values. The motion platform can comprise: a tip and tilt (TnT) motion stage. The TnT motion stage can be on the x-y motion stage. A dimension (e.g., width or length) of a component of the motion platform or a component of the TnT motion stage, e.g., a tip-axis adjustment engagement component, a tilt-axis adjustment engagement component, a journal, a slanted pin, a linear bearing carriage, a slanted linear bearing rail, or a sample carrier, can be, be about, be at least, be at least about, be at most, or be at most about, 3 cm, 4 cm, 5 cm, 6, cm, 7 cm, 8 cm, 9 am, 10 cm, 15 cm, 20 cm, 25 cm, 30 cm, 40 cm, or a number or a range between any two of these values. An area of a component of the motion platform or a component of the TnT motion stage, e.g., a tip-axis adjustment engagement component, a tilt-axis adjustment engagement component, a journal, a slanted pin, a linear bearing carriage, a slanted linear bearing rail, or a sample carrier, can be, be about, be at least, be at least about, be at most, or be at most about, 10 cm², 20 cm², 30 cm², 40 cm², 50 cm², 75 cm², 100 cm², 150 cm², 200 cm², 250 cm², 300 cm², 400 cm², 500 cm², 600 cm², 700 cm², 800 cm², 900 cm², 1000 cm², 1500 cm², 2000 cm², or a number or a range between any two of these values.

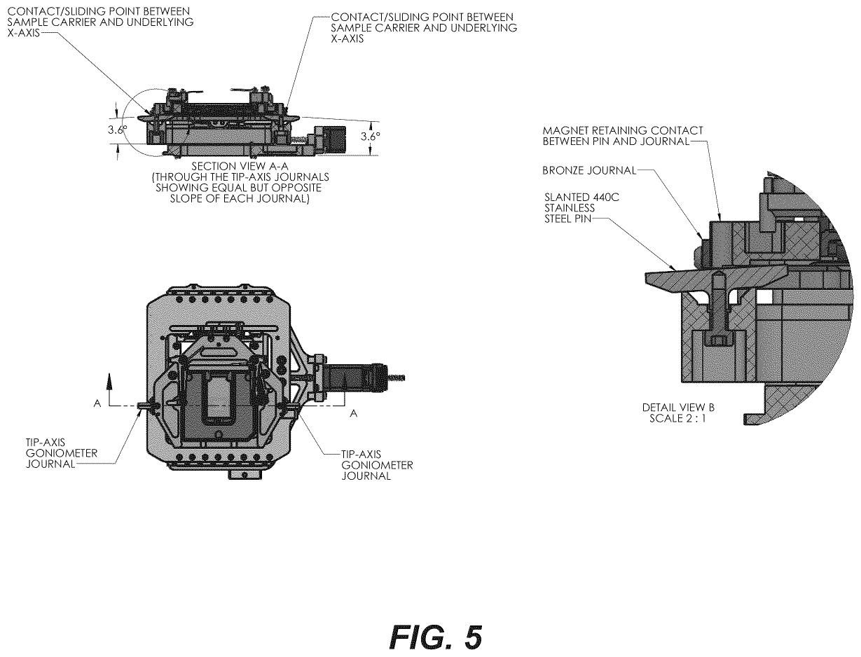

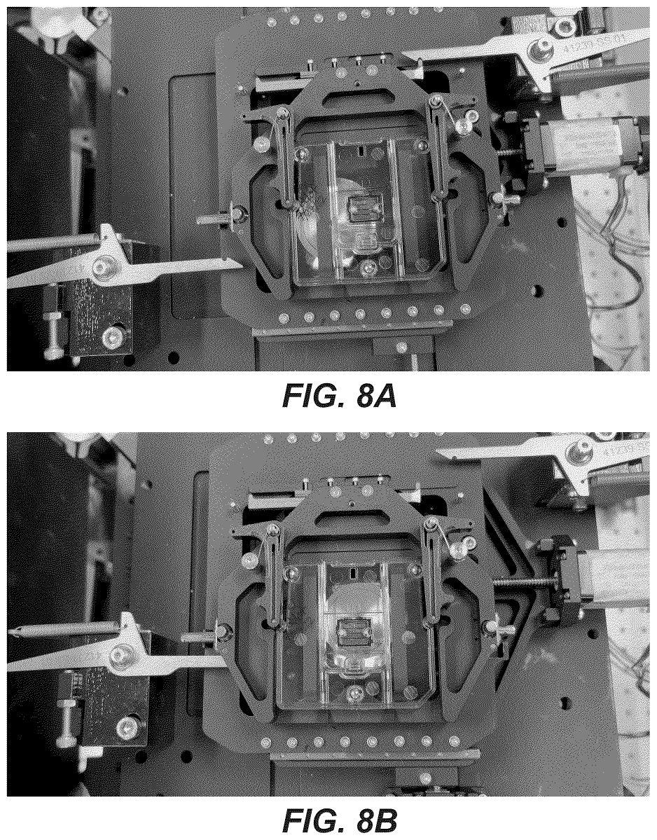

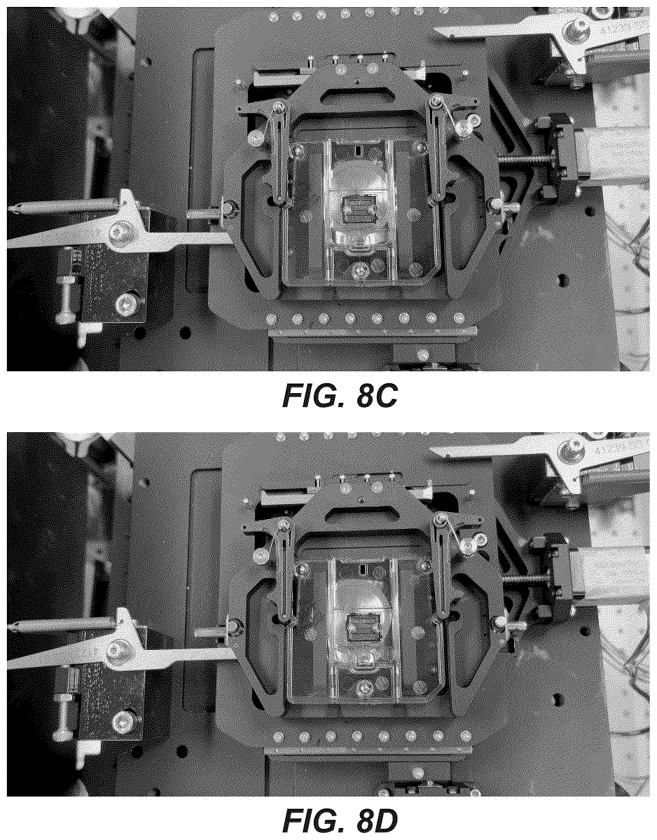

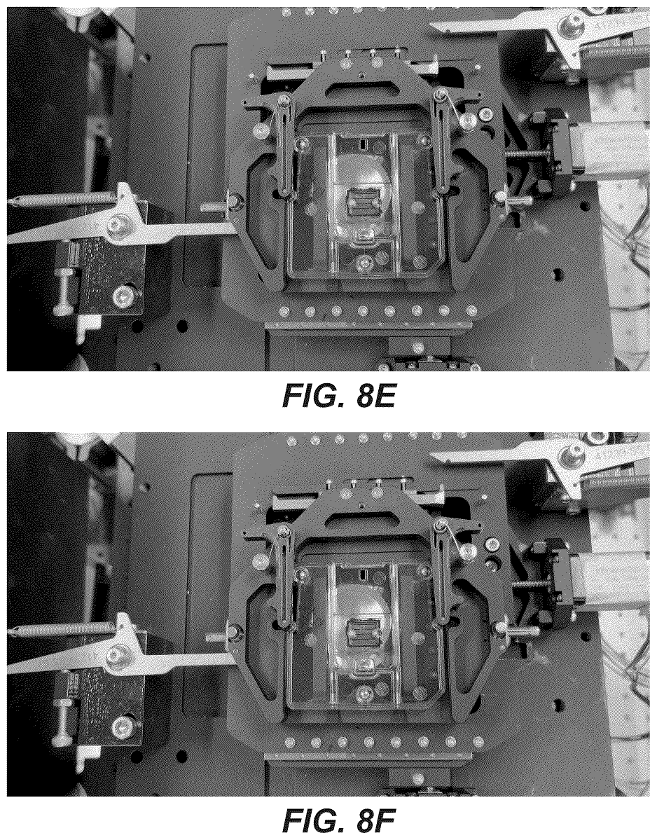

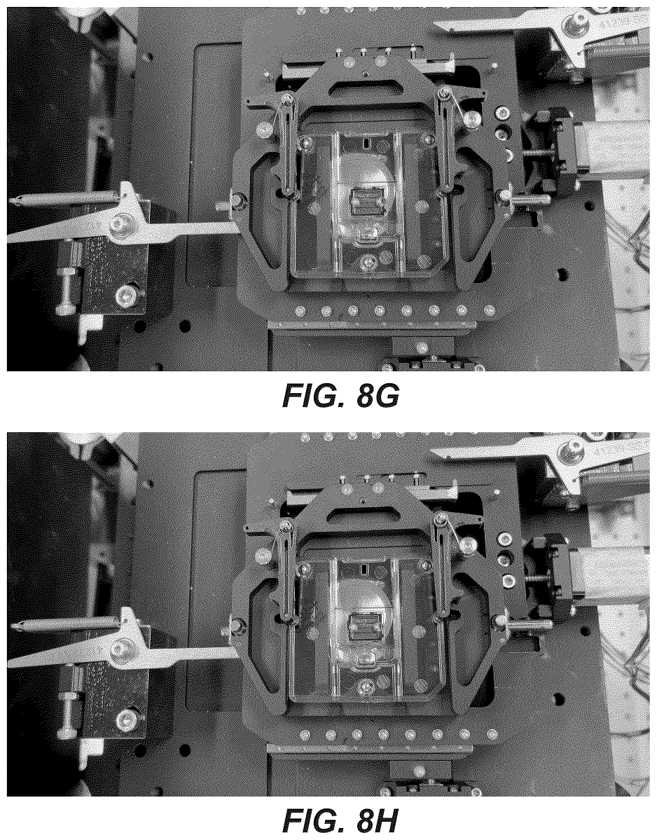

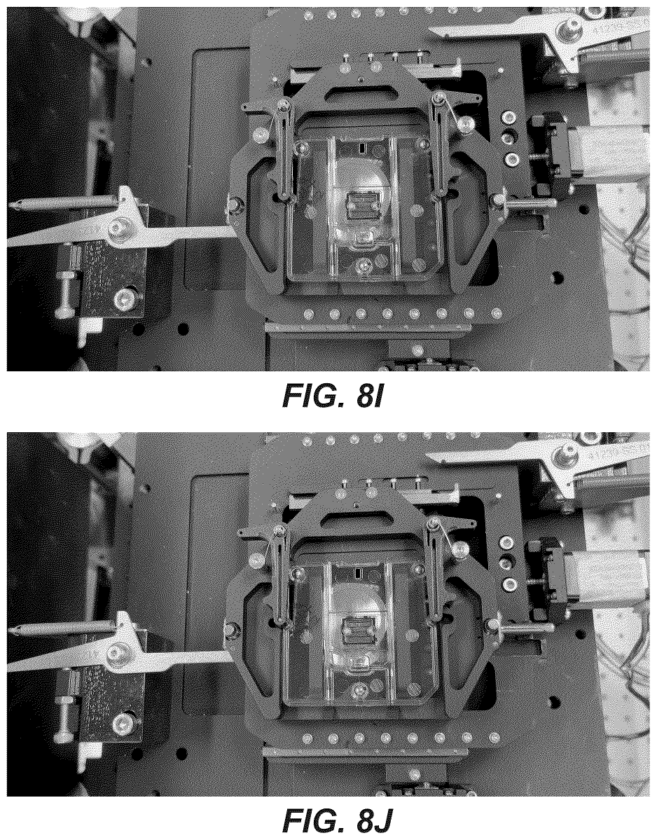

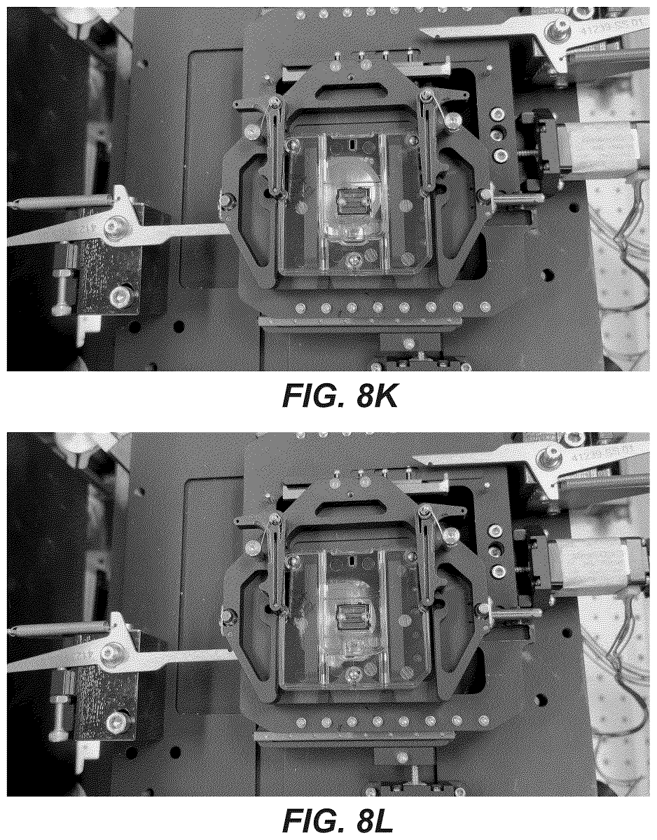

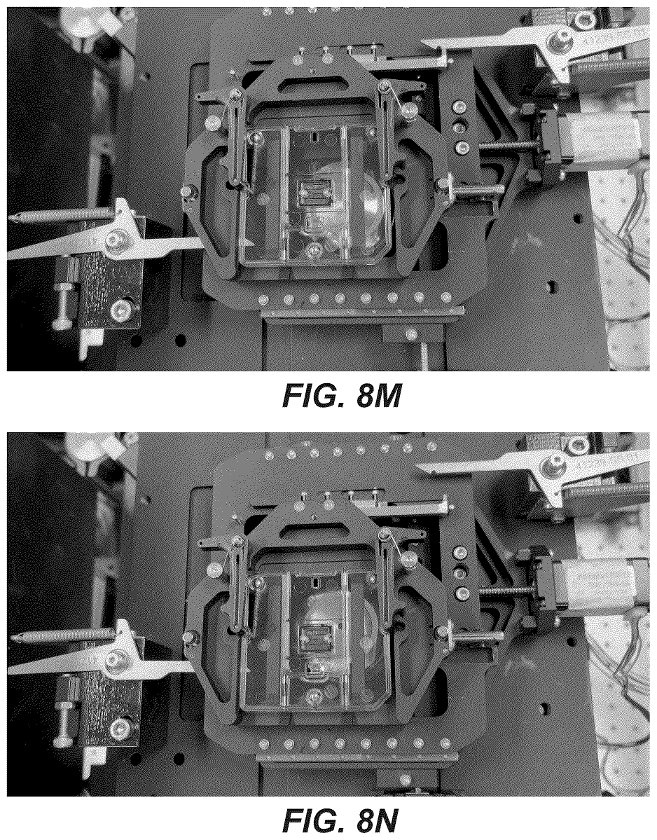

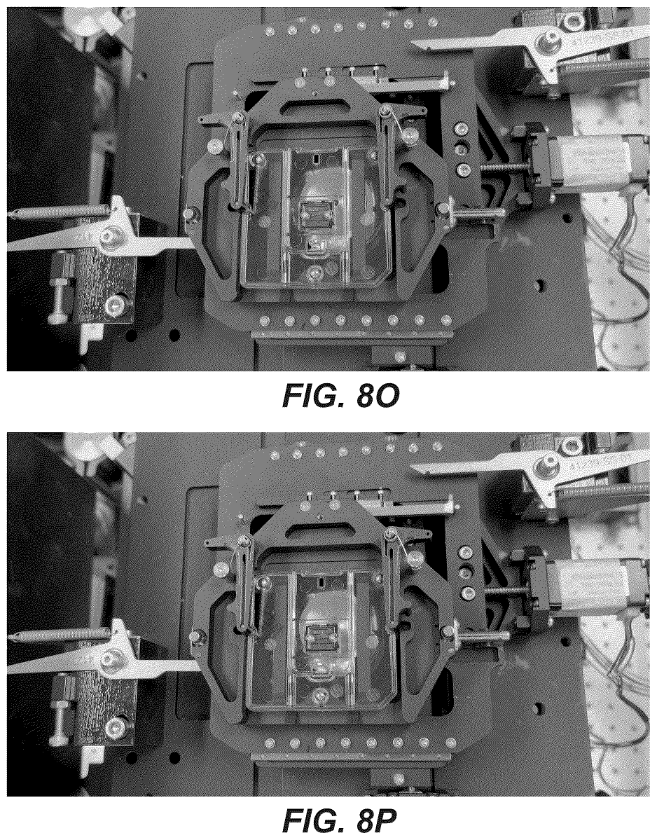

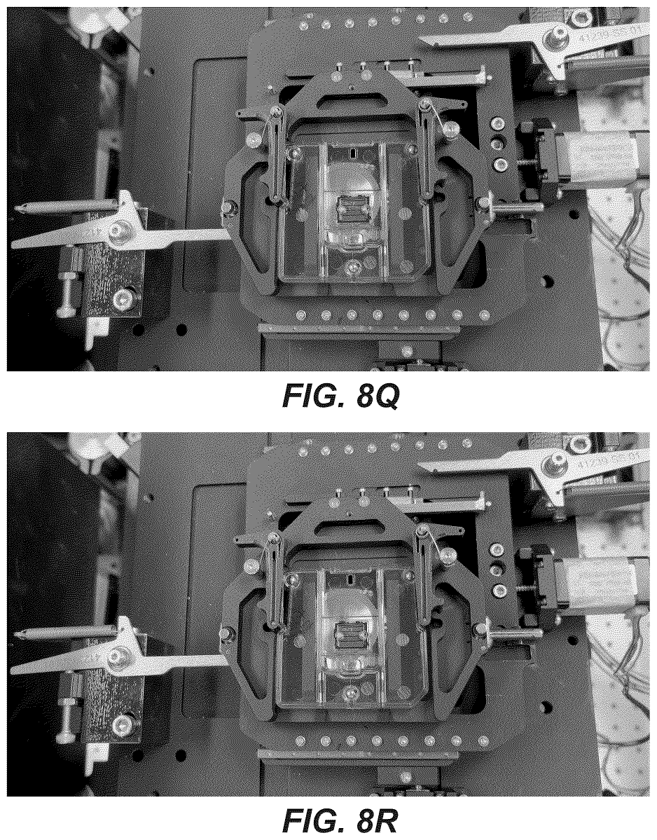

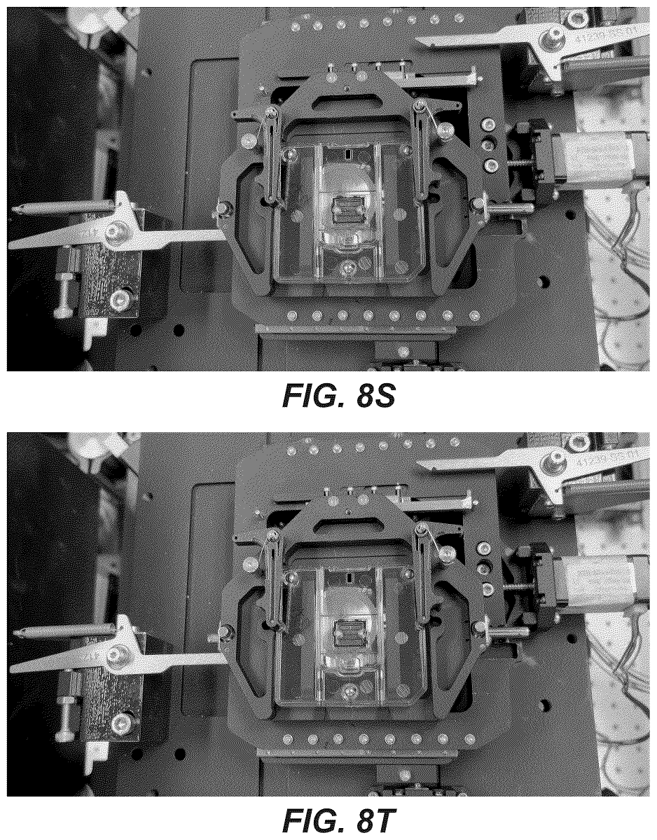

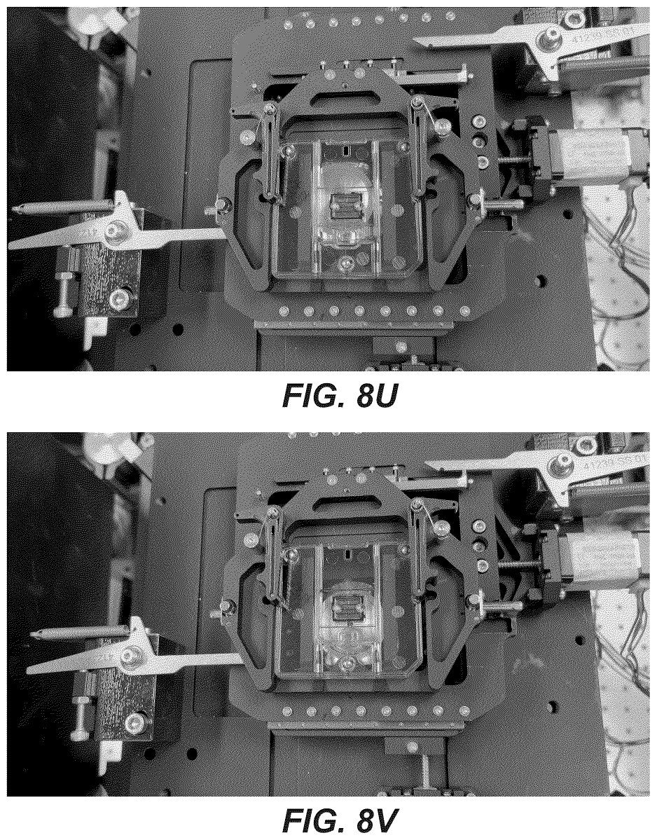

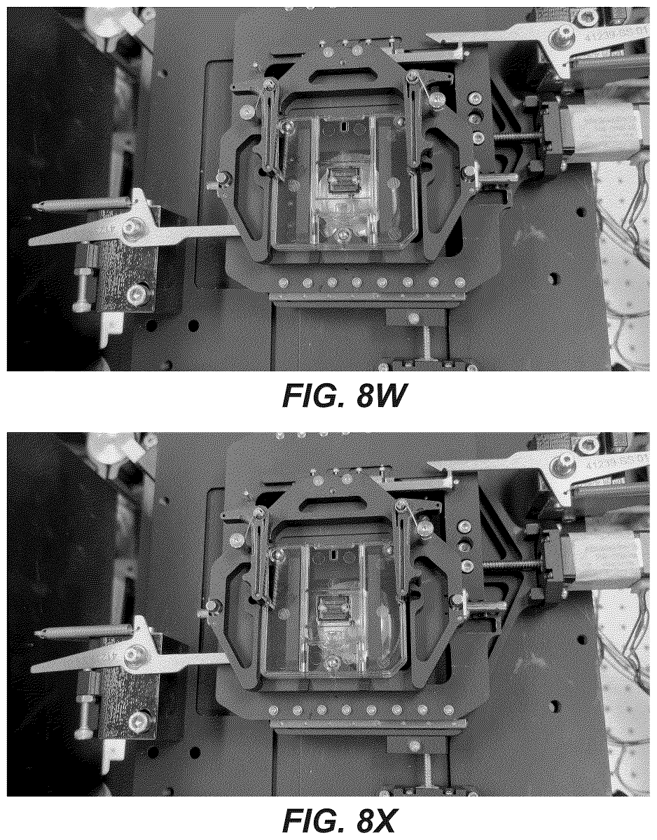

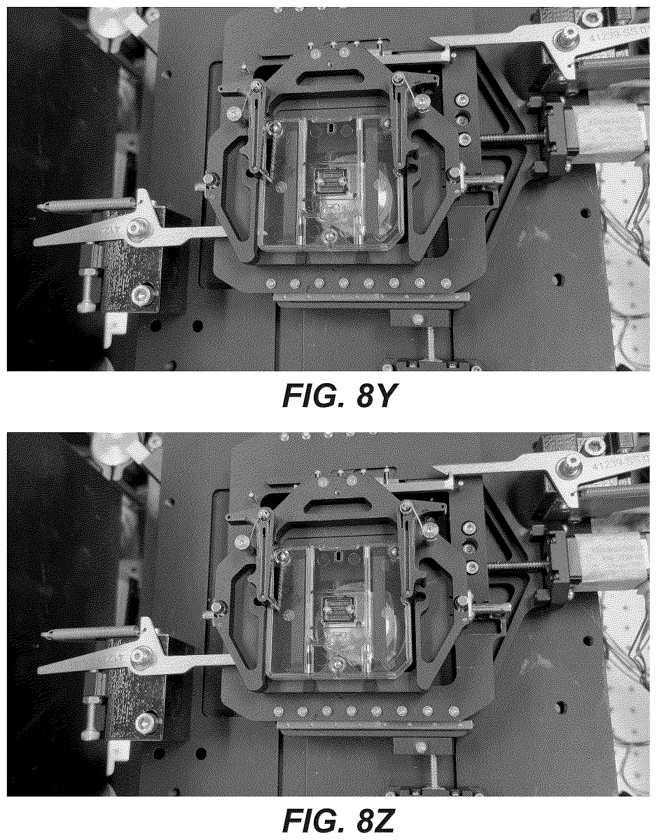

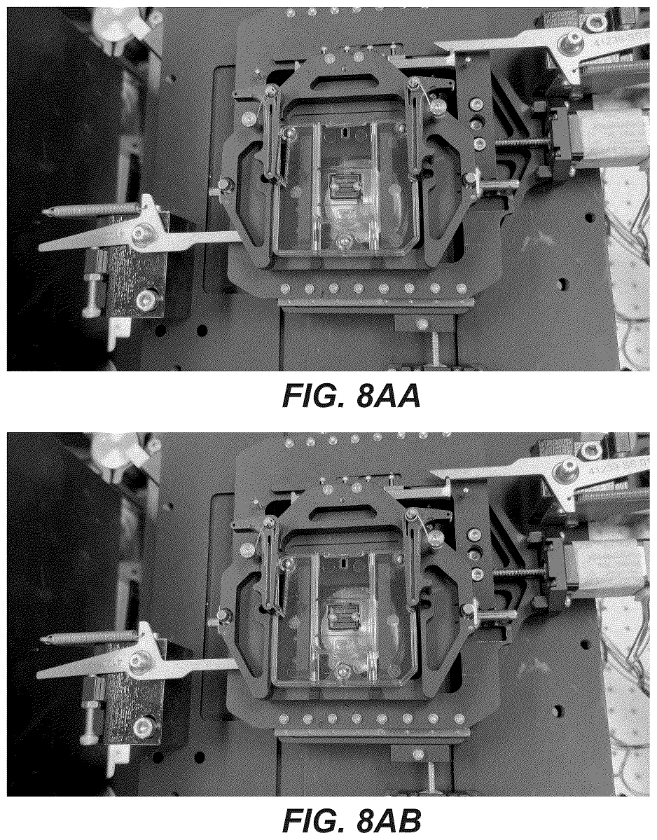

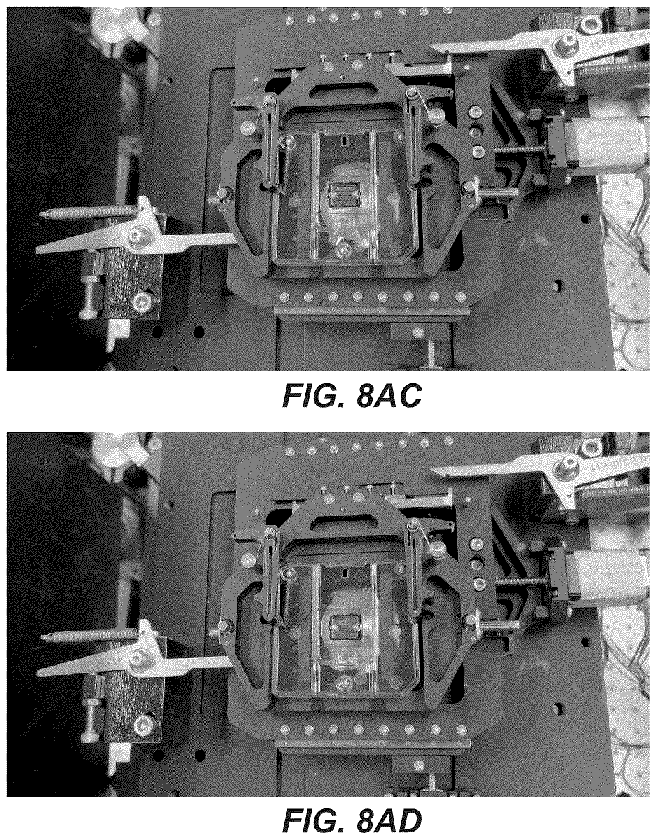

Referring to FIGS. 4-5, the TnT motion stage can comprise: two tip-axis goniometers with different slopes (e.g., 3.6° and −3.6° respectively as illustrated in FIG. 5) relative to one axis (e.g., x-axis) of the x-axis and the y-axis (e.g., of the motion platform or the motion stage). The TnT motion stage can comprise: a bearing, such as a tilt-axis slanted linear bearing (e.g., slanted relative to the plane of the platform and/or the x-y motion stage). The bearing can be a recirculating linear bearing. The bearing can be a non-recirculating linear bearing. Referring to FIGS. 4 and 6-7, the TnT motion stage can comprise: a tip-axis adjustment notch (or a tip-axis complementary adjustment engagement component). The TnT motion stage can comprise: a tilt-axis adjustment notch (or a tilt-axis complementary adjustment engagement component). In some embodiments, the TnT motion stage can comprise: a sample carrier. Referring to FIGS. 8A-8AD, in some embodiments, when the tip-axis adjustment pawl is engaged with the tip-axis adjustment notch, a movement of the x-y motion stage along the one axis results in a movement of the TnT motion stage along the two tip-axis goniometers. This can result in a change in the tip of the TnT motion stage. In some embodiments, when the tilt-axis adjustment pawl is engaged with the tilt-axis adjustment notch, a movement of the x-y motion stage along the one axis results in a movement of the TnT motion stage along the tilt-axis slanted linear bearing. This can result in a change in the tilt of the TnT motion stage.

In some embodiments, a motion platform can comprise: a base. The motion platform can comprise: an x-y motion stage on the base. The motion platform can comprise: a tip-axis adjustment pawl (or a tip-axis adjustment engagement component) on the base. The motion platform can comprise: a motion stage. The tip motion stage can be on the x-y motion stage.

The Tip motion stage can comprise: one or more (e.g., 2, or 3, 4, 5, or more) tip-axis goniometers with different (or the same) slopes relative to one axis of the x-axis and the y-axis. The TnT motion stage can comprise: a tip-axis adjustment notch. When the tip-axis adjustment pawl is engaged with the tip-axis adjustment notch, a movement of the x-y motion stage along the one axis can result in a movement of the Tip motion stage along the one or more tip-axis goniometers. This can result in a change in the tip of the Tip motion stage. In some embodiments, the tip motion stage can comprise: a sample carrier.

The motion platform can further comprise: a tilt-axis adjustment pawl (or a tilt-axis adjustment engagement component) on the base. The tip motion stage can be a tip and tilt (TnT) motion stage. The TnT motion stage can further comprise: a tilt-axis slanted linear bearing. The TnT motion stage can further comprise: a tilt-axis adjustment notch (or a tilt-axis complementary adjustment engagement component). When the tilt-axis adjustment pawl is engaged with the tilt-axis adjustment notch, a movement of the x-y motion stage along the one axis (e.g., x-axis) results in a movement of the TnT motion stage along the tilt-axis slanted linear bearing. This can result in a change in the tilt of the TnT motion stage.

Disclosed herein include embodiments of a motion platform. In some embodiments, a motion platform can comprise: a base. The motion platform can comprise: an x-y motion stage on the base. The motion platform can comprise: a tilt-axis adjustment pawl (or a tilt-axis adjustment engagement component) on the base. The motion platform can comprise: a tilt motion stage. The tilt motion stage can be on the x-y motion stage. The tilt motion stage can comprise: a tilt-axis slanted linear bearing. The tilt motion stage can comprise: a tilt-axis adjustment notch (or a tilt-axis complementary adjustment engagement component). When the tilt-axis adjustment pawl is engaged with the tilt-axis adjustment notch, a movement of the x-y motion stage along the one axis results in a movement of the tilt motion stage along the tilt-axis slanted linear bearing. This can result in a change in the tilt of the tilt motion stage. In some embodiments, the tilt motion stage can comprise: a sample carrier.

The motion platform can further comprise: a tip-axis adjustment pawl on the base. The tilt motion stage can be a tip and tilt (TnT) motion stage. The TnT motion stage can further comprise: one or more (e.g., 2, or 3, 4, 5, or more) tip-axis goniometers with different (or the same) slopes relative to one axis of the x-axis and the y-axis. The TnT motion stage can further comprise: a tip-axis adjustment notch (or a tip-axis complementary adjustment engagement component). In some embodiments, when the tip-axis adjustment pawl is engaged with the tip-axis adjustment notch, a movement of the x-y motion stage along the one axis results in a movement of the TnT motion stage along the one or more tip-axis goniometers. This can result in a change in the tip of the TnT motion stage.

Referring to FIG. 4, a motion platform can comprise an x-axis motor on (e.g., attached to, such as securely attached to) the base. The motion platform can comprise a y-axis motor on (e.g., attached to, such as securely attached to) the base. The x-axis motor can move the x-y motion stage along the x-axis. The y-axis motor can move the x-y motion stage along the y-axis. The x-axis motor and the y-axis motor can be used to change (or adjust) the tip and/or tilt of the TnT motion stage. The motion platform can comprise no additional motor other than the x-axis motor and the y-axis motor for changing (or adjusting) the tip and/or tilt of the TnT motion stage. In some embodiments, the x-axis motor is a servomotor. The y-axis motor can be a servomotor. In some embodiments, the TnT motion stage comprises no motor.

In some embodiments, the TnT motion stage is in contact with the x-y motion stage via the two tip-axis goniometers and the tilt-axis slanted linear bearing. In some embodiments, the TnT motion stage is in contact with the x-y motion stage via (e.g., only via) the two tip-axis goniometers and the tilt-axis slanted linear bearing.

In some embodiments, the TnT motion stage comprises no motor. In some embodiments, the TnT motion stage is in contact with the x-y motion stage via the one or more first-axis goniometers and the second-axis bearing. In some embodiments, the TnT motion stage is in contact with the x-y motion stage via (e.g., only via) the one or more first-axis goniometers and the second-axis bearing.

In some embodiments, the tip-axis adjustment pawl and the tilt-axis adjustment pawl point in the opposite directions. In some embodiments, the tip-axis adjustment notch and the tilt-axis adjustment notch point in the opposite directions. In some embodiments, the tip-axis adjustment pawl and the tilt-axis adjustment pawl are elevated from the base. In some embodiments, tip-axis adjustment pawl and the tilt-axis adjustment pawl are at different heights relative to the base. The tilt-axis adjustment notch and the tip-axis adjustment notch can be at different heights relative to the base. In some embodiments, the tip-axis adjustment pawl and the tilt-axis adjustment pawl are at an identical height relative to the base. The tilt-axis adjustment notch and the tip-axis adjustment notch can be at an identical height relative to the base. In some embodiments, the tip-axis adjustment engagement component and the tilt-axis adjustment engagement component can point in the opposite directions. In some embodiments, the tip-axis complementary adjustment engagement component and the tilt-axis complementary adjustment engagement component can point in the opposite directions. In some embodiments, the tip-axis adjustment engagement component and the tilt-axis complementary adjustment engagement component can be elevated from the base. In some embodiments, the tip-axis adjustment engagement component and the tilt-axis adjustment engagement component can be at different heights relative to the base. The tilt-axis complementary adjustment engagement component and the tip-axis complementary adjustment engagement component can be at different heights relative to the base. In some embodiments, the tip-axis adjustment engagement component and the tilt-axis adjustment engagement component are at an identical height relative to the base. The tilt-axis complementary adjustment engagement component and the tip-axis complementary adjustment engagement component can be at an identical height relative to the base.

A height of a component of the motion platform, of the x-y motion stage, or of the TnT motion stage (e.g., the tip-axis adjustment engagement component, tip-axis complementary adjustment engagement component, the tilt-axis adjustment engagement component, or tilt-axis complementary adjustment engagement component) relative to the x-y motion stage can be, be about, be at least, be at least about, be at most, or be at most about, 0.2 cm, 0.3 cm, 0.4 cm, 0.5 cm, 0.6 cm, 0.7 cm, 0.8 cm, 0.9 cm, 1 cm, 1.1 cm, 1.2 cm, 1.3 cm, 1.4 cm, 1.5 cm, 1.6 cm, 1.7 cm, 1.8 cm, 1.9 cm, 2 cm, 3 cm, 4 cm, 5 cm, 6 cm, 7 cm, 8 cm, 9 cm, 10 cm, or a number or a range between any two of these values.

In some embodiments, the two tip-axis goniometers have different slopes relative to the x-axis (or the y-axis). In some embodiments, the angle of the slope of one of the two tip-axis goniometers can be, be about, be at least, be at least about, be at most, or be at most about, 1°, 1.1°, 1.2°, 1.3°, 1.4°, 1.5°, 1.6°, 1.7°, 1.8°, 1.9°, 2°, 2.1°, 2.2°, 2.3°, 2.4°, 2.5°, 2.6°, 2.7°, 2.8°, 2.9°, 3.0°, 3.1°, 3.2°, 3.3°, 3.4°, 3.5°, 3.6°, 3.7°, 3.8°, 3.9°, 4°, 4.1°, 4.2°, 4.3°, 4.4°, 4.5°, 4.6°, 4.7°, 4.8°, 4.9°, 5°, 5.1°, 5.2°, 5.3°, 5.4°, 5.5°, 5.6°, 5.7°, 5.8°, 5.9°, 6°, 6.1°, 6.2°, 6.3°, 6.4°, 6.5°, 6.6°, 6.7°, 6.8°, 6.9°, 7°, 7.1°, 7.2°, 7.3°, 7.4°, 7.5°, 7.6°, 7.7°, 7.8°, 7.9°, 8°, 8.1°, 8.2°, 8.3°, 8.4°, 8.5°, 8.6°, 8.7°, 8.8°, 8.9°, 9°, 9.1.°, 9.2°, 9.3°, 9.4°, 9.5°, 9.6°, 9.7°, 9.8°, 9.9°, 10°, or a number or a range between any two of these values. In some embodiments, the angle of the slope of the other of the two tip-axis goniometers can be, be about, be at least, be at least about, be at most, or be at most about, −1°, −1.1°, −1.2°, −1.3°, −1.4°, −1.5°, −1.6°, −1.7°, −1.8°, −1.9°, −2°, −2.1°, −2.2°, −2.3°, −2.4°, −2.5°, −2.6°, −2.7°, −2.8°, −2.9°, −3.0°, −3.1°, −3.2°, −3.3°, −3.4°, −3.5°, −3.6°, −3.7°, −3.8°, −3.9°, −4°, −4.1°, −4.2°, −4.3°, −4.4°, −4.5°, −4.6°, −4.7°, −4.8°, −4.9°, −5°, −5.1°, −5.2°, −5.3°, −5.4°, −5.5°, −5.6°, −5.7°, −5.8°, −5.9°, −6°, −6.1°, −6.2°, −6.3°, −6.4°, −6.5°, −6.6°, −6.7°, −6.8°, −6.9°, −7°, −7.1°, −7.2°, −7.3°, −7.4°, −7.5°, −7.6°, −7.7°, −7.8°, −7.9°, −8°, −8.1°, −8.2°, −8.3°, −8.4°, −8.5°, −8.6°, −8.7°, −8.8°, −8.9°, −9°, −9.1.°, −9.2°, −9.3°, −9.4°, −9.5°, −9.6°, −9.7°, −9.8°, −9.9°, −10°, or a number or a range between any two of these values. In some embodiments, the slopes of the two tip-axis goniometers have different absolute angles. In some embodiments, the slopes of the two tip-axis goniometers have an identical absolute angle. In some embodiments, the absolute angle of the slope of one or each of the two tip-axis goniometers is about 3.6° (see FIG. 5 for an illustration). In some embodiments, the absolute angle of the slope of one or each of the two tip-axis goniometers can be, be about, be at least, be at least about, be at most, or be at most about, 1°, 1.1°, 1.2°, 1.3°, 1.4°, 1.5°, 1.6°, 1.7°, 1.8°, 1.9°, 2°, 2.1°, 2.2°, 2.3°, 2.4°, 2.5°, 2.6°, 2.7°, 2.8°, 2.9°, 3.0°, 3.1°, 3.2°, 3.3°, 3.4°, 3.5°, 3.6°, 3.7°, 3.8°, 3.9°, 4°, 4.1°, 4.2°, 4.3°, 4.4°, 4.5°, 4.6°, 4.7°, 4.8°, 4.9°, 5°, 5.1°, 5.2°, 5.3°, 5.4°, 5.5°, 5.6°, 5.7°, 5.8°, 5.9°, 6°, 6.1°, 6.2°, 6.3°, 6.4°, 6.5°, 6.6°, 6.7°, 6.8°, 6.9°, 7°, 7.1°, 7.2°, 7.3°, 7.4°, 7.5°, 7.6°, 7.7°, 7.8°, 7.9°, 8°, 8.1°, 8.2°, 8.3°, 8.4°, 8.5°, 8.6°, 8.7°, 8.8°, 8.9°, 9°, 9.1.°, 9.2°, 9.3°, 9.4°, 9.5°, 9.6°, 9.7°, 9.8°, 9.9°, 10°, or a number or a range between any two of these values.

In some embodiments, one or each of the two tip-axis goniometers is at or adjacent to a side surface (e.g., a vertical surface relative to the platform or the x-y motion stage) of the TnT motion platform. The two tip-axis goniometers can be at or adjacent to the same side surface or different side surfaces of the TnT motion platform. In some embodiments, one or each of the two tip-axis goniometers comprises a journal and a slanted pin. The material of the journal can comprise bronze. The material of the journal can comprise bronze, aluminum, zinc, copper, titanium, tin, beryllium, bismuth, chromium, cobalt, gallium, indium, iron, manganese, nickel, rhodium, or a combination thereof. The material of the pin can comprise a steel, such as a stainless steel. A steel can be, for example, cold rolled steel, stainless steel and steel surface-treated steel. For example, a steel can be crucible steel, carbon steel, spring steel, alloy steel, maraging steel, stainless steel, high-speed steel, weathering steel, tool steel, or a combination thereof. In some embodiments, one or each of the two tip-axis goniometers comprises a magnet. The magnet can retain contact between the journal and the slanted pin.

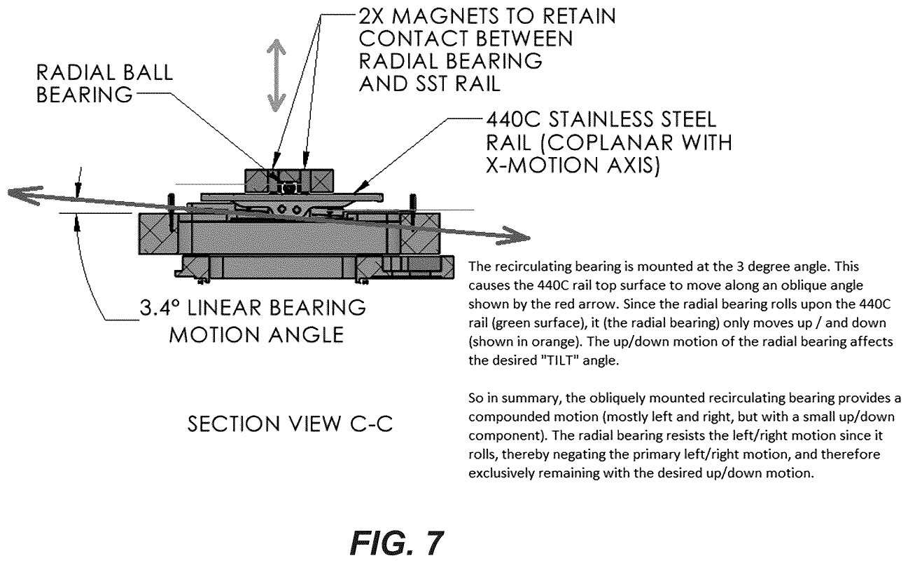

In some embodiments, the tilt-axis slanted linear bearing comprises a linear bearing carriage and a slanted linear bearing rail. In some embodiments, the linear bearing motion angle of the tilt-axis slanted linear bearing is about 3.4° (see FIGS. 6-7 for an illustration). In some embodiments, the linear bearing motion angle of the tilt-axis slanted linear bearing is, is about, is at least, is at least about, is at most, or is at most about, 1°, 1.1°, 1.2°, 1.3°, 1.4°, 1.5°, 1.6°, 1.7°, 1.8°, 1.9°, 2°, 2.1°, 2.2°, 2.3°, 2.4°, 2.5°, 2.6°, 2.7°, 2.8°, 2.9°, 3.0°, 3.1°, 3.2°, 3.3°, 3.4°, 3.5°, 3.6°, 3.7°, 3.8°, 3.9°, 4°, 4.1°, 4.2°, 4.3°, 4.4°, 4.5°, 4.6°, 4.7°, 4.8°, 4.9°, 5°, 5.1°, 5.2°, 5.3°, 5.4°, 5.5°, 5.6°, 5.7°, 5.8°, 5.9°, 6°, 6.1°, 6.2°, 6.3°, 6.4°, 6.5°, 6.6°, 6.7°, 6.8°, 6.9°, 7°, 7.1°, 7.2°, 7.3°, 7.4°, 7.5°, 7.6°, 7.7°, 7.8°, 7.9°, 8°, 8.1°, 8.2°, 8.3°, 8.4°, 8.5°, 8.6°, 8.7°, 8.8°, 8.9°, 9°, 9.1.°, 9.2°, 9.3°, 9.4°, 9.5°, 9.6°, 9.7°, 9.8°, 9.9°, 10°, or a number or a range between any two of these values. In some embodiments, the linear bearing motion angle of the tilt-axis slanted linear bearing is, is about, is at least, is at least about, is at most, or is at most about, −1°, −1.1°, −1.2°, −1.3°, −1.4°, −1.5°, −1.6°, −1.7°, −1.8°, −1.9°, −2°, −2.1°, −2.2°, −2.3°, −2.4°, −2.5°, −2.6°, −2.7°, −2.8°, −2.9°, −3.0°, −3.1°, −3.2°, −3.3°, −3.4°, −3.5°, −3.6°, −3.7°, −3.8°, −3.9°, −4°, −4.1°, −4.2°, −4.3°, −4.4°, −4.5°, −4.6°, −4.7°, −4.8°, −4.9°, −5°, −5.1°, −5.2°, −5.3°, −5.4°, −5.5°, −5.6°, −5.7°, −5.8°, −5.9°, −6°, −6.1°, −6.2°, −6.3°, −6.4°, −6.5°, −6.6°, −6.7°, −6.8°, −6.9°, −7°, −7.1°, −7.2°, −7.3°, −7.4°, −7.5°, −7.6°, −7.7°, −7.8°, −7.9°, −8°, −8.1°, −8.2°, −8.3°, −8.4°, −8.5°, −8.6°, −8.7°, −8.8°, −8.9°, −9°, −9.1.°, −9.2°, −9.3°, −9.4°, −9.5°, −9.6°, −9.7°, −9.8°, −9.9°, −10°, or a number or a range between any two of these values. In some embodiments, the absolute value of the linear bearing motion angle of the tilt-axis slanted linear bearing is, is about, is at least, is at least about, is at most, or is at most about, 1°, 1.1°, 1.2°, 1.3°, 1.4°, 1.5°, 1.6°, 1.7°, 1.8°, 1.9°, 2°, 2.1°, 2.2°, 2.3°, 2.4°, 2.5°, 2.6°, 2.7°, 2.8°, 2.9°, 3.0°, 3.1°, 3.2°, 3.3°, 3.4°, 3.5°, 3.6°, 3.7°, 3.8°, 3.9°, 4°, 4.1°, 4.2°, 4.3°, 4.4°, 4.5°, 4.6°, 4.7°, 4.8°, 4.9°, 5°, 5.1°, 5.2°, 5.3°, 5.4°, 5.5°, 5.6°, 5.7°, 5.8°, 5.9°, 6°, 6.1°, 6.2°, 6.3°, 6.4°, 6.5°, 6.6°, 6.7°, 6.8°, 6.9°, 7°, 7.1°, 7.2°, 7.3°, 7.4°, 7.5°, 7.6°, 7.7°, 7.8°, 7.9°, 8°, 8.1°, 8.2°, 8.3°, 8.4°, 8.5°, 8.6°, 8.7°, 8.8°, 8.9°, 9°, 9.1.°, 9.2°, 9.3°, 9.4°, 9.5°, 9.6°, 9.7°, 9.8°, 9.9°, 10°, or a number or a range between any two of these values.

In some embodiments, the tilt-axis slanted linear bearing is at or adjacent a (or a second) side surface (e.g., a vertical surface relative to the platform or the x-y motion stage) of the TnT motion platform. In some embodiments, the TnT motion stage comprises a radial bearing in contact with a radial bearing rail. A material of the radial bearing can comprise a steel, such as a stainless steel. A material of the radial bearing rail can comprise a steel, such as a stainless steel. A steel can be cold rolled steel, stainless steel and steel surface-treated steel. A steel can comprise a steel can be crucible steel, carbon steel, spring steel, alloy steel, maraging steel, stainless steel, high-speed steel, weathering steel, tool steel, or a combination thereof. The radial bearing rail can be co-planar with the x-axis. In some embodiments, the TnT motion stage comprises at least one magnet (e.g., 2 magnets) which retains contact between the radial bearing and the radial bearing rail. In some embodiments, the radial bearing is at or adjacent to a side surface (or the second side surface). In some embodiments, the TnT motion stage comprises 8 side surfaces. In some embodiments, the TnT motion stage comprises 3, 4, 5, 6, 7, 8, 9, 10, 11, 12, 13, 14, 15, or a number or a range between any two of these values, side surfaces.

In some embodiments, when the tip-axis adjustment pawl is engaged with the tip-axis adjustment notch, the tilt-axis adjustment pawl is not engaged with the tilt-axis adjustment notch. When the tilt-axis adjustment pawl is engaged with the tilt-axis adjustment notch, the tip-axis adjustment pawl may be not engaged with the tip-axis adjustment notch. In some embodiments, when the tip-axis adjustment pawl is engaged with the tip-axis adjustment notch, a movement of the x-y motion stage along the x-axis results in a movement of the TnT motion stage along the two tip-axis goniometers. This can result in a change in the tip of the TnT motion stage. In some embodiments, when the tilt-axis adjustment pawl is engaged with the tilt-axis adjustment notch, a movement of the x-y motion stage along the x-axis results in a movement of the TnT motion stage along the tilt-axis slanted linear bearing. This can result in a change in the tilt of the TnT motion stage. In some embodiments, when the tip-axis adjustment engagement component is engaged with the tip-axis complementary adjustment engagement component, the tilt-axis adjustment engagement component is not engaged with the tilt-axis complementary adjustment engagement component. When the tilt-axis adjustment engagement component is engaged with the tilt-axis complementary adjustment engagement component, the tip-axis adjustment engagement component may not be engaged with the tip-axis complementary adjustment engagement component. In some embodiments, when the tip-axis adjustment engagement component is engaged with the tip-axis complementary adjustment engagement component, a movement of the x-y motion stage along the one axis (e.g., x-axis) results in a movement of the TnT motion stage along the one or more (e.g., 2) tip-axis goniometers. This can result in a change in the tip of the TnT motion stage. In some embodiments, when the tilt-axis adjustment engagement component is engaged with the tilt-axis complementary adjustment engagement component, a movement of the x-y motion stage along the one axis (e.g., x-axis) results in a movement of the TnT motion stage along the tilt-axis bearing (e.g., tilt-axis slanted linear bearing). This can result in a change in the tilt of the TnT motion stage.

In some embodiments, when the TnT motion stage is moved along the y-axis to the edge of its travel in one direction of the y-axis, the tip-axis adjustment pawl engages with the tip-axis adjustment notch. When the TnT motion stage is moved along the y-axis to the edge of its travel in the other direction of the y-axis, the tilt-axis adjustment pawl can engage with the tilt-axis adjustment notch. In some embodiments, when the TnT motion stage is moved along one axis (e.g., the y-axis) to the edge of its travel in one direction of the axis, the tip-axis adjustment engagement component engages with the tip-axis complementary adjustment engagement component. When the TnT motion stage is moved along the axis (e.g., the y-axis) to the edge of its travel in the other direction of the axis, the tilt-axis adjustment engagement component can engage with the tilt-axis complementary adjustment engagement component.

In some embodiments, a motion platform can comprise: a base. The motion platform can comprise: an x-y motion stage. The x-y motion stage can be on (e.g., attached to, such as securely attached to) the base. The motion platform can comprise: a first-axis (e.g., a tip-axis or a tilt-axis) adjustment engagement component (e.g., a pawl or a notch) on (e.g., attached to, such as securely attached to) the base. The motion platform can comprise: a second motion stage (which can be a tip motion stage, a tilt motion stage, or a tip and tilt (TnT) motion stage). The second motion stage can be on the x-y motion stage. The motion platform can comprise: a first-axis goniometer or bearing. The motion platform can comprise: a first-axis complementary adjustment engagement component (e.g., a notch or a pawl), The first-axis adjustment engagement component and the first-axis complementary adjustment engagement component can engage (or be in engagement, such as secure engagement) with each other. For example, the first-axis adjustment engagement component and the first-axis complementary engagement component can be a pawl and a notch and can be in engagement (e.g., secure engagement) with each other. When the first-axis adjustment component is engaged with the first-axis complementary adjustment engagement component, a movement of the x-y motion stage along one axis (e.g., x-axis) of the x-axis and the y-axis can result. in a movement of the second motion stage along the first-axis goniometer or bearing. This can result in a change in the first-axis (e.g., tip-axis) of the second motion stage. In some embodiments, the motion platform can comprise: a sample carrier.

In some embodiments, the motion platform can further comprise a second-axis (e.g., a tilt-axis or a tip-axis) adjustment engagement component (e.g., a pawl or a notch). The second motion stage can further comprise: a second-axis goniometer or bearing. The second motion stage can further comprise: a second-axis complementary adjustment engagement component (e.g., a notch or a pawl). The second-axis adjustment engagement component and the second-axis complementary adjustment engagement component can engage (or be in engagement, such as secure engagement) with each other. For example, the second-axis adjustment engagement component and the second-axis complementary engagement component can be a pawl and a notch and can be in engagement (e.g., secure engagement) with each other. When the second-axis adjustment engagement component is engaged with the second-axis complementary adjustment engagement component, a movement of the x-y motion stage along the one axis can result in a movement of the second motion stage along the second-axis goniometer or bearing. This can result in a change in the second-axis (e.g., tilt-axis) of the second motion stage.

In some embodiments, the first-axis is the tip-axis. The second-axis can be the tilt-axis. In some embodiments, the first-axis is the tilt-axis. The second-axis can be the tip-axis. In some embodiments, the first-axis goniometer can comprise one or more (e.g., 2, or 3, 4, 5, or more) first-axis goniometers. In some embodiments, the first-axis bearing comprises a first-axis slanted linear bearing.

The motion platform can comprise an x-axis motor on (e.g., attached to, such as securely attached to) the base. The x-axis motor can move the x-y motion stage along the x-axis. The motion platform can comprise a y-axis motor on (e.g., attached to, such as securely attached to) the base. The y-axis motor can move the x-y motion stage along the y-axis. The motion platform can comprise no additional motor other than the x-axis motor and the y-axis motor for changing (or adjusting) the tip and/or tilt of the second motion stage. In some embodiments, the x-axis motor is a servomotor. The y-axis motor can be a servomotor.

In some embodiments, the second motion stage comprises no motor. In some embodiments, the second motion stage is in contact with the x-y motion stage via the one or more goniometers (e.g., tip-axis goniometers) and the bearing (e.g., tilt-axis slanted linear bearing). In some embodiments, the TnT motion stage is in contact with the x-y motion stage only via the one or more goniometers (e.g., tip-axis goniometers) and the bearing (e.g., tilt-axis slanted linear bearing).

In some embodiments, the first-axis adjustment engagement component and the second-axis adjustment engagement component can point in the opposite directions. In some embodiments, the first-axis complementary adjustment engagement component and the second-axis complementary adjustment engagement component can point in the opposite directions. In some embodiments, the first-axis adjustment engagement component and the second-axis complementary adjustment engagement component can be elevated from the base. In some embodiments, the first-axis adjustment engagement component and the second-axis adjustment engagement component can be at different heights relative to the base. The first-axis complementary adjustment engagement component and the second-axis complementary adjustment engagement component can be at different heights relative to the base. In some embodiments, the first-axis adjustment engagement component and the second-axis adjustment engagement component are at an identical height relative to the base. The first-axis complementary adjustment engagement component and the second-axis complementary adjustment engagement component can be at an identical height relative to the base.

In some embodiments, two goniometers have different slopes relative to the x-axis (or the y-axis). In some embodiments, the angle of the slope of one of two goniometers can be, be about, be at least, be at least about, be at most, or be at most about, 1°, 1.1°, 1.2°, 1.3°, 1.4°, 1.5°, 1.6°, 1.7°, 1.8°, 1.9°, 2°, 2.1°, 2.2°, 2.3°, 2.4°, 2.5°, 2.6°, 2.7°, 2.8°, 2.9°, 3.0°, 3.1°, 3.2°, 3.3°, 3.4°, 3.5°, 3.6°, 3.7°, 3.8°, 3.9°, 4°, 4.1°, 4.2°, 4.3°, 4.4°, 4.5°, 4.6°, 4.7°, 4.8°, 4.9°, 5°, 5.1°, 5.2°, 5.3°, 5.4°, 5.5°, 5.6°, 5.7°, 5.8°, 5.9°, 6°, 6.1°, 6.2°, 6.3°, 6.4°, 6.5°, 6.6°, 6.7°, 6.8°, 6.9°, 7°, 7.1°, 7.2°, 7.3°, 7.4°, 7.5°, 7.6°, 7.7°, 7.8°, 7.9°, 8°, 8.1°, 8.2°, 8.3°, 8.4°, 8.5°, 8.6°, 8.7°, 8.8°, 8.9°, 9°, 9.1.°, 9.2°, 9.3°, 9.4°, 9.5°, 9.6°, 9.7°, 9.8°, 9.9°, 10°, or a number or a range between any two of these values. In some embodiments, the angle of the slope of the other of the two goniometers can be, be about, be at least, be at least about, be at most, or be at most about, −1°, −1.1°, −1.2°, −1.3°, −1.4°, −1.5°, −1.6°, −1.7°, −1.8°, −1.9°, −2°, −2.1°, −2.2°, −2.3°, −2.4°, −2.5°, −2.6°, −2.7°, −2.8°, −2.9°, −3.0°, −3.1°, −3.2°, −3.3°, −3.4°, −3.5°, −3.6°, −3.7°, −3.8°, −3.9°, −4°, −4.1°, −4.2°, −4.3°, −4.4°, −4.5°, −4.6°, −4.7°, −4.8°, −4.9°, −5°, −5.1°, −5.2°, −5.3°, −5.4°, −5.5°, −5.6°, −5.7°, −5.8°, −5.9°, −6°, −6.1°, −6.2°, −6.3°, −6.4°, −6.5°, −6.6°, −6.7°, −6.8°, −6.9°, −7°, −7.1°, −7.2°, −7.3°, −7.4°, −7.5°, −7.6°, −7.7°, −7.8°, −7.9°, −8°, −8.1°, −8.2°, −8.3°, −8.4°, −8.5°, −8.6°, −8.7°, −8.8°, −8.9°, −9°, −9.1.°, −9.2°, −9.3°, −9.4°, −9.5°, −9.6°, −9.7°, −9.8°, −9.9°, −10°, or a number or a range between any two of these values. In some embodiments, the slopes of the two goniometers have different absolute angles. In some embodiments, the slopes of the goniometers have an identical absolute angle. In some embodiments, the absolute angle of the slope of one or each of the two goniometers is about 3.6° (see FIG. 5 for an illustration). In some embodiments, the absolute angle of the slope of one or each of the two goniometers can be, be about, be at least, be at least about, be at most, or be at most about, 1°, 1.1°, 1.2°, 1.3°, 1.4°, 1.5°, 1.6°, 1.7°, 1.8°, 1.9°, 2°, 2.1°, 2.2°, 2.3°, 2.4°, 2.5°, 2.6°, 2.7°, 2.8°, 2.9°, 3.0°, 3.1°, 3.2°, 3.3°, 3.4°, 3.5°, 3.6°, 3.7°, 3.8°, 3.9°, 4°, 4.1°, 4.2°, 4.3°, 4.4°, 4.5°, 4.6°, 4.7°, 4.8°, 4.9°, 5°, 5.1°, 5.2°, 5.3°, 5.4°, 5.5°, 5.6°, 5.7°, 5.8°, 5.9°, 6°, 6.1°, 6.2°, 6.3°, 6.4°, 6.5°, 6.6°, 6.7°, 6.8°, 6.9°, 7°, 7.1°, 7.2°, 7.3°, 7.4°, 7.5°, 7.6°, 7.7°, 7.8°, 7.9°, 8°, 8.1°, 8.2°, 8.3°, 8.4°, 8.5°, 8.6°, 8.7°, 8.8°, 8.9°, 9°, 9.1.°, 9.2°, 9.3°, 9.4°, 9.5°, 9.6°, 9.7°, 9.8°, 9.9°, 10°, or a number or a range between any two of these values.

In some embodiments, one or each of the two goniometers is at or adjacent to a side surface (e.g., a vertical surface relative to the platform or the x-y motion stage) of the TnT motion platform. The two goniometers can be at or adjacent to the same side surface or different side surfaces of the second motion platform. In some embodiments, one or each of the two goniometers comprises a journal and a slanted pin. A material of a component herein (e.g., a journal, a pin, a carriage, or a rail) can comprise bronze, aluminum, zinc, copper, titanium, tin, beryllium, bismuth, chromium, cobalt, gallium, indium, iron, manganese, nickel, rhodium, or a combination thereof. A material of the component can comprise a steel, such as cold rolled steel, stainless steel and steel surface-treated steel. A steel can comprise a steel can be crucible steel, carbon steel, spring steel, alloy steel, maraging steel, stainless steel, high-speed steel, weathering steel, tool steel, or a combination thereof. In some embodiments, one or each of the two goniometers comprises a magnet. The magnet can retain contact between the journal and the slanted pin.

In some embodiments, the bearing can be linear bearing (e.g., a slanted linear bearing). The bearing can comprise a carriage and a rail (e.g., a slanted rail). In some embodiments, the bearing motion angle is about 3.4° (see FIGS. 6-7 for an illustration). In some embodiments, the bearing motion angle is, is about, is at least, is at least about, is at most, or is at most about, 1°, 1.1°, 1.2°, 1.3°, 1.4°, 1.5°, 1.6°, 1.7°, 1.8°, 1.9°, 2°, 2.1°, 2.2°, 2.3°, 2.4°, 2.5°, 2.6°, 2.7°, 2.8°, 2.9°, 3.0°, 3.1°, 3.2°, 3.3°, 3.4°, 3.5°, 3.6°, 3.7°, 3.8°, 3.9°, 4°, 4.1°, 4.2°, 4.3°, 4.4°, 4.5°, 4.6°, 4.7°, 4.8°, 4.9°, 5°, 5.1°, 5.2°, 5.3°, 5.4°, 5.5°, 5.6°, 5.7°, 5.8°, 5.9°, 6°, 6.1°, 6.2°, 6.3°, 6.4°, 6.5°, 6.6°, 6.7°, 6.8°, 6.9°, 7°, 7.1°, 7.2°, 7.3°, 7.4°, 7.5°, 7.6°, 7.7°, 7.8°, 7.9°, 8°, 8.1°, 8.2°, 8.3°, 8.4°, 8.5°, 8.6°, 8.7°, 8.8°, 8.9°, 9°, 9.1.°, 9.2°, 9.3°, 9.4°, 9.5°, 9.6°, 9.7°, 9.8°, 9.9°, 10°, or a number or a range between any two of these values. In some embodiments, the bearing motion angle is, is about, is at least, is at least about, is at most, or is at most about, −1°, −1.1°, −1.2°, −1.3°, −1.4°, −1.5°, −1.6°, −1.7°, −1.8°, −1.9°, −2°, −2.1°, −2.2°, −2.3°, −2.4°, −2.5°, −2.6°, −2.7°, −2.8°, −2.9°, −3.0°, −3.1°, −3.2°, −3.3°, −3.4°, −3.5°, −3.6°, −3.7°, −3.8°, −3.9°, −4°, −4.1°, −4.2°, −4.3°, −4.4°, −4.5°, −4.6°, −4.7°, −4.8°, −4.9°, −5°, −5.1°, −5.2°, −5.3°, −5.4°, −5.5°, −5.6°, −5.7°, −5.8°, −5.9°, −6°, −6.1°, −6.2°, −6.3°, −6.4°, −6.5°, −6.6°, −6.7°, −6.8°, −6.9°, −7°, −7.1°, −7.2°, −7.3°, −7.4°, −7.5°, −7.6°, −7.7°, −7.8°, −7.9°, −8°, −8.1°, −8.2°, −8.3°, −8.4°, −8.5°, −8.6°, −8.7°, −8.8°, −8.9°, −9°, −9.1.°, −9.2°, −9.3°, −9.4°, −9.5°, −9.6°, −9.7°, −9.8°, −9.9°, −10°, or a number or a range between any two of these values. In some embodiments, the absolute value of the bearing motion angle is, is about, is at least, is at least about, is at most, or is at most about, 1°, 1.1°, 1.2°, 1.3°, 1.4°, 1.5°, 1.6°, 1.7°, 1.8°, 1.9°, 2°, 2.1°, 2.2°, 2.3°, 2.4°, 2.5°, 2.6°, 2.7°, 2.8°, 2.9°, 3.0°, 3.1°, 3.2°, 3.3°, 3.4°, 3.5°, 3.6°, 3.7°, 3.8°, 3.9°, 4°, 4.1°, 4.2°, 4.3°, 4.4°, 4.5°, 4.6°, 4.7°, 4.8°, 4.9°, 5°, 5.1°, 5.2°, 5.3°, 5.4°, 5.5°, 5.6°, 5.7°, 5.8°, 5.9°, 6°, 6.1°, 6.2°, 6.3°, 6.4°, 6.5°, 6.6°, 6.7°, 6.8°, 6.9°, 7°, 7.1°, 7.2°, 7.3°, 7.4°, 7.5°, 7.6°, 7.7°, 7.8°, 7.9°, 8°, 8.1°, 8.2°, 8.3°, 8.4°, 8.5°, 8.6°, 8.7°, 8.8°, 8.9°, 9°, 9.1.°, 9.2°, 9.3°, 9.4°, 9.5°, 9.6°, 9.7°, 9.8°, 9.9°, 10°, or a number or a range between any two of these values.

In some embodiments, the bearing is at or adjacent a (or a second) side surface (e.g., a vertical surface relative to the platform or the x-y motion stage) of the second motion platform. In some embodiments, the second motion stage (or the bearing) can comprise a bearing in contact with a bearing rail. In some embodiments, the second motion stage (or the bearing) can comprise a radial bearing in contact with a radial bearing rail. The radial bearing rail can be co-planar with the x-axis. In some embodiments, the second motion stage comprises at least one magnet (e.g., 2, or 3, 4, 5, or more, magnets) which retains contact between the radial bearing and the radial bearing rail. In some embodiments, the radial bearing is at or adjacent to a side surface (or the second side surface that is different from the surface the goniometer is adjacent to). In some embodiments, the second motion stage comprises 8 side surfaces. In some embodiments, the second motion stage comprises 3, 4, 5, 6, 7, 8, 9, 10, 11, 12, 13, 14, 15, or a number or a range between any two of these values, side surfaces.

In some embodiments, when the first-axis adjustment engagement component is engaged with the first-axis complementary adjustment engagement component, the second-axis adjustment engagement component is not engaged with the second-axis complementary adjustment engagement component. When the second-axis adjustment engagement component is engaged with the second-axis complementary adjustment engagement component, the first-axis adjustment engagement component may not be engaged with the first-axis complementary adjustment engagement component. In some embodiments, when the first-axis adjustment engagement component is engaged with the first-axis complementary adjustment engagement component, a movement of the x-y motion stage along the one axis (e.g., x-axis) results in a movement of the second motion stage along the one or more (e.g., 2) tip-axis goniometers. This can result in a change in the first axis (e.g., the tip) of the TnT motion stage. In some embodiments, when the second-axis adjustment engagement component is engaged with the second-axis complementary adjustment engagement component, a movement of the x-y motion stage along the one axis (e.g., x-axis) results in a movement of the second motion stage along the second-axis bearing (e.g., second-axis slanted linear bearing). This can result in a change in the second-axis (e.g., the tilt) of the TnT motion stage.

In some embodiments, when the second motion stage is moved along one axis (e.g., the y-axis) to the edge of its travel in one direction of the axis, the first-axis adjustment engagement component engages with the first-axis complementary adjustment engagement component. When the second motion stage is moved along the axis (e.g., the y-axis) to the edge of its travel in the other direction of the axis, the second-axis adjustment engagement component can engage with the second-axis complementary adjustment engagement component.

In some embodiments, the ringdown time (e.g., of the motion platform or the x-y motion stage disclosed herein) is, is about, is at least, is at least about, is at most, or is at most about, 5 milliseconds (ms), 6 ms, 7 ms, 8 ms, 9 ms, 10 ms, 11 ms, 12 ms, 13 ms, 14 ms, 15 ms, 16 ms, 17 ms, 18 ms, 19 ms, 20 ms, 21 ms, 22 ms, 23 ms, 24 m, 25 ms, 26 ms, 27 ms, 28 ms, 29 ms, 30 ms, 35, ms, 40 ms, 45 ms, 50 ms, 55 ms, 60 ms, 65 ms, 70 ms, 75 ms, 80 ms, 85 ms, 90 ms, or a number or a range between any two of these values. In some embodiments, the motion time (e.g., of the motion platform or the x-y motion stage disclosed herein) is, is about, is at least, is at least about, is at most, or is at most about, 70 milliseconds (ms), 75 ms, 80 ms, 85 ms, 90 ms, 95 ms, 100 ms, 105 ms, 110 ms, 115 ms, 120 ms, 125 ms, 130 ms, 135 ms, 140 ms, 145 ms, 150 ms, 155 ms, 160 ms, 165 ms, 170 ms, 175 ms, 180 ms, or a number or a range between any two of these values. A design of the present disclosure can have a throughput improvement (relative to the throughput of a prior design) of, of about, of at least, of at least about, of at most, or of at most about, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, 300%, 310%, 320%, 330%, 340%, 350%, 360%, 370%, 380%, 390%, 400%, or a number or a range between any two of these values. In some embodiments, the presently disclosed mechanism's net weight to achieve the TnT functionality can be, be about, be at least, be at least about, be at most, or be at most about, 100 grams (g), 110 g, 120 g, 130 g, 140 g, 150 g, 160 g, 170 g, 180 g, 190 g, 200 g, 225 g, 250 g, 275 g, 300 g, 325 g, 350 g, 375 g, 400 g, 425 g, 450 g, 475 g, 500 g, or a number or a range between any two of these values.

### Exemplary Instruments

Disclosed herein include embodiments of an instrument. In some embodiments, the instrument can comprise: a sensor (e.g., below or above the motion platform). The instrument can comprise: optics (e.g., below or above the motion platform). The instrument can comprise: a motion platform disclosed herein. The instrument can comprise a fluorescent imaging system, such as an optical genome mapping (OGM) system. In some embodiments, the motion platform is suspended within the imaging system.

### Exemplary Motion Platform Uses

Disclosed herein include embodiments of a method of positioning a sample (e.g., adjusting the tip-axis and the tilt axis of the sample or TnT motion stage). In some embodiments, a method of positioning a sample can comprise: providing a sample. The sample can be in a sample chip or cartridge. The method can comprise: placing the sample, or the sample chip or cartridge, on (or onto or into) a sample carrier of a TnT motion stage of a motion platform of the present disclosure. The method can comprise: engaging the tip-axis adjustment paw (or tip adjustment engagement component) with the tip-axis adjustment notch (or complementary tip adjustment engagement component). The method can comprise: moving the x-y motion stage along one axis (e.g., the y-axis) of the x-axis and the y-axis. This can result in changing the tip of the TnT motion stage. The method can include: engaging the tilt-axis adjustment paw (or tilt adjustment engagement component) with the tilt-axis adjustment notch (or complementary tilt adjustment engagement component). The method can include: moving the x-y motion stage along the one axis (e.g., the y-axis) of the x-axis and the y-axis. This can result in changing the tilt of the TnT motion stage. Prior to engaging the tilt-axis adjustment paw with the tilt-axis adjustment notch, the method can include: disengaging the tip-axis adjustment paw with the tip-axis adjustment notch.

In some embodiments, engaging the tip-axis adjustment paw with the tip-axis adjustment notch and moving the x-y motion stage along the one axis of the x-axis and the y-axis occurs before engaging the tilt-axis adjustment paw with the tilt-axis adjustment notch and moving the x-y motion stage along the one axis of the x-axis and the y-axis, thereby changing the tilt of the TnT motion stage. Prior to engaging the tilt-axis adjustment paw with the tilt-axis adjustment notch, the method can include: disengaging the tip-axis adjustment paw with the tip-axis adjustment notch. In some embodiments, engaging the tip-axis adjustment paw with the tip-axis adjustment notch and moving the x-y motion stage along the one axis of the x-axis and the y-axis occurs after engaging the tilt-axis adjustment paw with the tilt-axis adjustment notch and moving the x-y motion stage along the one axis of the x-axis and the y-axis, thereby changing the tilt of the TnT motion stage. Prior to engaging the tip-axis adjustment paw with the tip-axis adjustment notch, the method can include: disengaging the tilt-axis adjustment paw with the tilt-axis adjustment notch. In some embodiments, the method comprises: changing the x-y position of the motion stage. Changing the x-y position of the motion stage can occur before or after changing the tip of the TnT motion stage and/or the tilt of the TnT motion stage.

In some embodiments, a method of positioning a sample can comprise: providing a sample. The method can comprise: placing the sample, or a sample chip or cartridge comprising the sample, on (or onto or into) a sample carrier of a TnT motion stage of a motion platform of the present disclosure. The method can include: determining a tip-tilt adjustment needed for the sample. The method can include: engaging a tip-axis adjustment paw (or tip adjustment engagement component) on the base of the motion platform with a tip-axis adjustment notch (or complementary tip adjustment engagement component) of the TnT motion stage. The method can include: moving an x-y motion stage of the motion platform along one axis of the x-axis and the y-axis, thereby changing the tip of the TnT motion stage, based on the tip-tilt adjustment needed. The method can include engaging a tilt-axis adjustment paw (or tilt adjustment engagement component) on the base of the motion platform with a tilt-axis adjustment notch (or complementary tilt adjustment engagement component) of the TnT motion stage. The method can include: moving the x-y motion stage along the one axis of the x-axis and the y-axis, thereby changing the tilt of the TnT motion stage, based on the tip-tilt adjustment needed.

In some embodiments, a method of positioning a sample can comprise: providing a sample. The method can comprise: placing the sample, or a sample chip or cartridge comprising the sample, on (or onto or into) a sample carrier of a TnT motion stage of a motion platform of the present disclosure. The method can comprise a iterative (or stepwise) process. The iterative process can comprise: determining a tip-tilt adjustment needed for the sample. The iterative process can include: engaging a tip-axis adjustment paw (or tip adjustment engagement component) on the base of the motion platform with a tip-axis adjustment notch (or complementary tip adjustment engagement component) of the TnT motion stage. The iterative process can include: moving an x-y motion stage of the motion platform along one axis of the x-axis and the y-axis, thereby changing the tip of the TnT motion stage, based on the tip-tilt adjustment needed. The iterative process can include: engaging a tilt-axis adjustment paw (or tilt adjustment engagement component) on the base of the motion platform with a tilt-axis adjustment notch (or complementary tilt adjustment engagement component) of the TnT motion stage. The iterative process can include: moving the x-y motion stage along the one axis of the x-axis and the y-axis, thereby changing the tilt of the TnT motion stage, based on the tip-tilt adjustment needed.

In some embodiments, the iterative process comprises: determining a chip gradient. The iterative process can comprise: engaging a tip-axis adjustment paw on the base of the motion platform with a tip-axis adjustment notch of the TnT motion stage. The iterative process can comprise: moving an x-y motion stage of the motion platform along one axis of the x-axis and the y-axis, thereby changing the tip of the TnT motion stage, based on the chip gradient. The iterative process can comprise: engaging a tilt-axis adjustment paw on the base of the motion platform with a tilt-axis adjustment notch of the TnT motion stage. The iterative process can comprise: moving the x-y motion stage along the one axis of the x-axis and the y-axis, thereby changing the tilt of the TnT motion stage, based on the chip gradient adjustment needed. The iterative process can comprise: determining a FOV gradient. The iterative process can comprise: engaging a tip-axis adjustment paw on the base of the motion platform with a tip-axis adjustment notch of the TnT motion stage. The iterative process can comprise: moving an x-y motion stage of the motion platform along one axis of the x-axis and the y-axis, thereby changing the tip of the TnT motion stage, based on the FOV gradient. The iterative process can comprise: engaging a tilt-axis adjustment paw on the base of the motion platform with a tilt-axis adjustment notch of the TnT motion stage. The iterative process can comprise: moving the x-y motion stage along the one axis of the x-axis and the y-axis, thereby changing the tilt of the TnT motion stage based on the FOV gradient adjustment needed.

In some embodiments, a method of positioning a sample comprises: (a) providing a sample. The sample can be in a sample chip or cartridge. The method can comprise: (b) placing the sample, or the sample chip or cartridge, on (or onto or into) a sample carrier of a tip and tilt (TnT) motion stage of a motion platform of the present disclosure. The TnT motion stage can be on an x-y motion stage of the motion platform. The x-y motion stage can be on a base of the motion platform. The method can comprise: (c1) determining a chip gradient of the sample. The method can comprise: (d1) performing one or more steps of the following based on the chip gradient in step (d1). The method can comprise: engaging a tip-axis adjustment paw (or tip adjustment engagement component) on the base of the motion platform with a tip-axis adjustment notch (or complementary tip adjustment engagement component) of the TnT motion stage. The method can comprise: moving an x-y motion stage of the motion platform along one axis of the x-axis and the y-axis, thereby changing the tip of the TnT motion stage. The method can comprise: engaging a tilt-axis adjustment paw (or tilt adjustment engagement component) on the base of the motion platform with a tilt-axis adjustment notch (or complementary tilt adjustment engagement component) of the TnT motion stage. The method can comprise: moving the x-y motion stage along the one axis of the x-axis and the y-axis, thereby changing the tilt of the TnT motion stage. In some embodiments, the method can comprise: (c2) determining a field of view (FOV) gradient. The method can comprise: (d2) performing one or more steps of (d1) based on the FOV gradient.

In some embodiments, a method of positioning a sample comprises: providing a sample. The sample can be in a sample chip or cartridge. The method can include: placing the sample, or the sample chip or cartridge) on (or onto or into) a sample carrier of a tip and tilt (TnT) motion stage of a motion platform of the present disclosure. The TnT motion stage can be on an x-y motion stage of the motion platform. The x-y motion stage can be on a base of the motion platform. The method can include: determining a chip gradient of the sample. The method can include: engaging a tip-axis adjustment paw (or tip adjustment engagement component) on the base of the motion platform with a tip-axis adjustment notch (or complementary tip adjustment engagement component) of the TnT motion stage and moving an x-y motion stage of the motion platform along one axis of the x-axis and the y-axis, thereby changing the tip of the TnT motion stage, based on the chip gradient. The method can include: engaging a tilt-axis adjustment paw (or tilt adjustment engagement component) on the base of the motion platform with a tilt-axis adjustment notch (or complementary tilt adjustment engagement component) of the TnT motion stage and moving the x-y motion stage along the one axis of the x-axis and the y-axis, thereby changing the tilt of the TnT motion stage, based on the chip gradient. The method can include: determining a field of view (FOV) gradient. The method can include: engaging the tip-axis adjustment paw with the tip-axis adjustment notch and moving an x-y motion stage of the motion platform along the one axis of the x-axis and the y-axis, thereby changing the tilt of the TnT motion stage, based on the FOV gradient. The method can include: engaging the tilt-axis adjustment paw with the tilt-axis adjustment notch and moving the x-y motion stage along the one axis of the x-axis and the y-axis, thereby changing the tilt of the TnT motion stage, based on the FOV gradient.

Disclosed herein include methods of imaging a sample. In some embodiments, a method of imaging a sample comprising: positioning (e.g., adjusting the tip-axis and/or tilt-axis) a sample as described herein. The sample can be on (or in) a sample carrier of a TnT motion stage of a motion platform of the present disclosure. Positioning the sample can include adjusting the tip-axis and/or tilt-axis of the TnT motion stage as described herein. The method can include: rastering, using the x-y motion stage, to different positions along the x-axis and/or the y-axis. The number of positions can be different in different embodiments, such as 2500, 5000, 7500, 10000, 25000, 50000, 75000, 100000, or a number or a range between any two of these values. The number of images captured can be different in different embodiments, such as 2500, 5000, 7500, 10000, 25000, 50000, 75000, 100000, or a number or a range between any two of these values. The method can include capturing images of the sample at the different positions. Attenuation of resonance (e.g., resonance of the motion platform or components thereof, such as the x-y motion stage and/or the TnT motion stage) can occur first prior to imaging. Attenuation of resonance can occur when the resonance is, for example, less than 20 nm, 25 nm 30 nm, 35 nm, 40 nm, 45 nm, 50 nm or more or less. In some embodiments, the tip-axis and/or tilt-axis of the sample (or the TnT motion stage) can be adjusted after a number of images of the sample are captured at different positions. The number of images captured prior to tip axis and/or tilt-axis being adjusted again can be different in different embodiments, such as 100, 250, 500, 750, 1000, 2500, 5000, 7500, 10000, 25000, 50000, 75000, 100000, or a number or a range between any two of these values. In some embodiments, the tip-axis and/or tilt-axis of the sample (or the TnT motion stage) may not need to be adjusted.

In some embodiments, the sample comprises an optical genome mapping (OGM) sample. In some embodiments, the sample comprises nucleic acids. The nucleic acids can comprise deoxyribonucleic acid (DNA). The nucleic acids can comprise the nucleic acids comprise genomic DNA. The nucleic acids can comprise fragmented genomic DNA. The nucleic acids can comprise ribonucleic acids (RNA). The nucleic acids can comprise DNA derived (e.g., reverse transcribed) from DNA or RNA. In some embodiments, the sample comprises labeled nucleic acids, optionally wherein the sample comprises fluorescently labeled nucleic acids.

### Exemplary Tip and Tilt Motion Stage Control

### 1. Introduction

In a true goniometer, an object can be rotated to an exact angular position with respect to an origin. In the novel design described herein, the geometry is more complicated as described herein such that the term “gonio” may not mean rotating an object to an exact angular position.

The gonio stage (also referred to herein as a tip and tilt (TnT) motion stage) can be used to apply a gradient to the currently loaded chip, to level the currently loaded chip with the imaging focal plane so that molecules and labels stay in focus. For the Y (tilt axis) there is a rotation about a center, so this Y axis more closely resembles a goniometer. For the X (tip axis), a sliding motion on opposing ramps imparts a slope, rather than a rotation. The stage design described herein has another major difference from previous designs which affects all aspects of the adjustment determinations and control of the stage. For the stage design, the tip tilt stage is on top of the x, y stage, while for previous designs the x, y stage is on top of the tip tilt stage.

### 2a. Gradient Application and Definitions

The FOV gradient in the TnT motion stage described herein is defined as the slope between the stage plane of motion and the imaging focal plane, represented by QF.

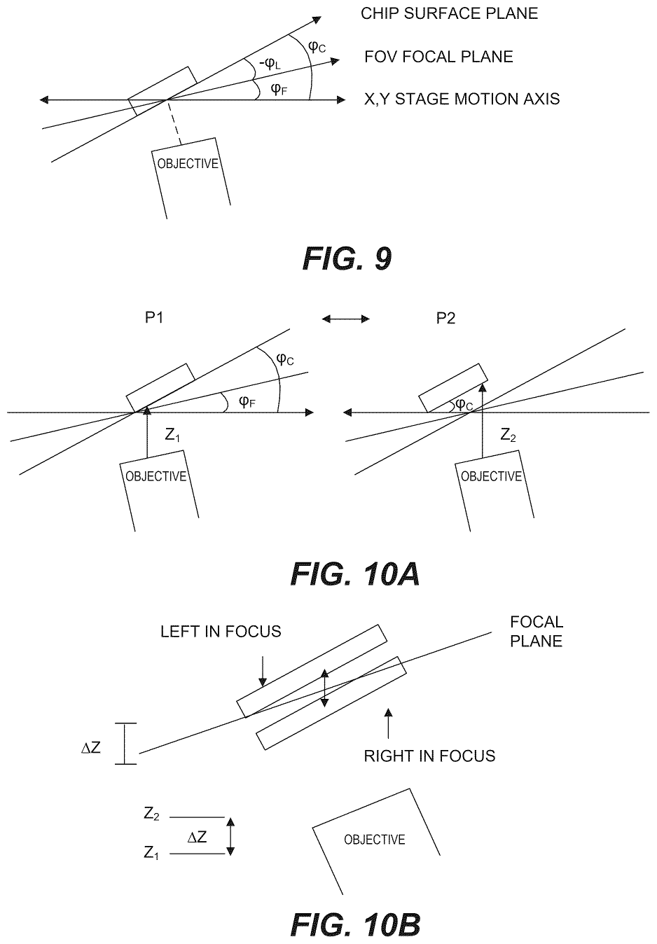

The chip (which can comprise a labeled sample, such as a OGM sample) gradient in the TnT motion stage described herein is defined as the slope between the current chip and the stage plane of motion, represented by pc. FIG. 9. Exemplary gradient planes and angles definitions.

A key difference between the stage and chip gradient is that in order to apply these, the negative of the chip gradient is applied to “level” the chip. While for the FOV gradient, the positive of the gradient is applied to move the chip to the nominal focal plane. These sign differences lead to confusion at times.

Since the FOV gradient contribution is positive and the chip gradient contribution is negative, to level the chip to the focal plane, the correction to apply will be called the leveling gradient QL and is defined thehe difference between the FOV gradient and chip gradient.

$${φ}_{L} -= {φ}_{F} - {φ}_{C} \qquad Eq ( 1 )$$

Upon starting a new chip inspection, the chip is leveled. An instrument containing the motion platform (or a component thereof, such as the TnT motion stage) can be equipped with a laser proximeter which measures the distance of the chip surface in the z axes away from the objective. This proximeter can be referred to herein as the focuser. The position of the chip in several corners can be measured using an X, Y stage shift and the focuser during chip alignment, and the chip gradient, or φ_{C} is measured. This is because the chip still moves about the stage original plane unlike previous implementations, where the stage plane shifts upon application of the stage gradient. The plane of motion of the chip never shifts in some embodiments. FIG. 10A. Exemplary leveling measurement during alignment measures chip gradient qc.

When a gradient is measured using an image stack in the Z direction, what is measured is the distance between the chip and the focal plane, which then is the leveling gradient φ_{L} (see the definition herein). FIG. 10B. Exemplary image Z stack measures the difference between the chip plane and the FOV focal plane, φ_{L}. An image stack can comprise a plurality of images, such as 2, 3, 4, 5, 10, 15, 20, 30, 40, 50, or more or fewer, images. The gradient which is applied scan time can be the leveling gradient φL. This can be visualized by rotating the chip in FIG. 9 by φL in the negative (clockwise direction), which levels it to the objective plane of focus.

Once the FOV gradient is established, then during the first phase of chip alignment, the chip is not yet leveled and the leveling gradient is not known. The tip tilt gradient can be set to the FOV gradient because the chip gradient is assumed as zero, thus using equation 1 above. This would shift the nominal “perfect” chip into focus. After alignment levels the chip, this process can now calculate the chip gradient, as explained above. From the chip gradient, the leveling gradient can be calculated using the premeasured FOV gradient, again using equation 1. This calculated leveling gradient φL is applied to the stage.

### 2b. Exemplary Gradient Setup

An exemplary method of FOV gradient setup for a design disclosed herein is as the follows.
1. Clear chip and FOV gradient to zero and apply.
2. Align chip to measure chip gradient.
3. At this point the FOV gradient is set to zero. Calculate φ_{C} and φ_{L}=−φc so the negative of φC is applied.
4. Run FOV gradient image stack measurement. This calculates the difference between the current chip position and the FOV focal plane. The difference is φL. This measurement is the negative of the FOV gradient (see FIG. 9 and equation (1)). The negative of this measured gradient is saved as the pending FOV gradient and leveling gradient is recalculated and displayed as pending as well.
5. Apply and save the new FOV gradient.
6. Run the FOV gradient check again and the change in FOV gradient should be small.

### 3. Gonio Axes Geometry and Gradient Calculations

a. General/Terminology

The application of the X axis (tip) portion of the gradient can be performed by shifting the X position of a sliding assembly which rides on sloped rails in X. This also confers an X axis shift of the chip position to be image. The Y portion of the gradient can be applied via a rotation about these rails in the Y direction. The shift in Y is much smaller than the shift in X, but still non-zero for the rotation around these rails and the standoff of the chip surface above these rails. To apply a gradient, transforms such as mathematical transforms can be used to calculate or determine, for the desired X, Y gradient, an output gonio X and Y coordinate which imparts such a gradient. These transforms can be non-trivial due to the design because the X axis is not a true goniometer (a true goniometer would be purely rotational).

The gradient discussed here is a true 2D x, y gradient, which is the dimensionless “slope” in the X and Y directions on the plate. This is not the same as the angle, but for small angles these are close (small angle approximations). When trigonometric computations are performed, angle (in radians) can be used. When other computations such as vector computations are used, slope or gradient can be used. It will be clear by naming conventions when each is being referenced (e.g., θ, φ for angle, ∇ for gradient, etc.).

b. Hardware Configuration Parameters.

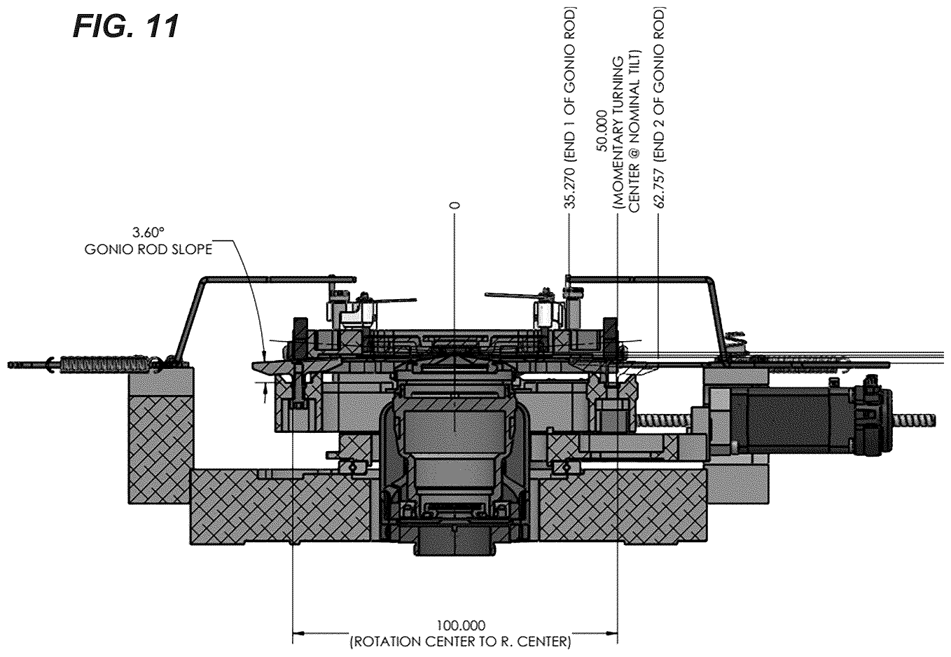

The tip tilt stage has ideal design parameters that can be used to calculate (or determine) the coordinate transformations used internally. These parameters are specified as follows (see FIG. 11).

The chip center position when mounted in the caddy holder (or sample carrier) may not be at center.

The X plate diameter is from rail slider to rail.

The Y plate diameter is 2*the radius from Y bearing contact point to the Y at the X.

The X rail ramp is the angle in degrees.

The Y rail ramp is the angle in degrees.

The standoff is the distance from the contact point of the X rail centers beneath the sliders up to the imaging surface of the chip.

The Y axis bearing position is the distance along the X axis off-center of Y rod/bearing.

The X and Y stage travel range may not be used internally in the calculations, but may need to be applied to clamp the range applied by, for example, the higher level software.

c. Vector Calculations/Plate Vector Parametric Equations

Much of the calculations used to calculate the coordinate transforms can be accomplished through vector calcuations using parametric equations, in some embodiments. An example parametric line equation using an n dimensioned vector P, between two end points would be as below. In calculations for the X and the Y axis, this can be a 2D vector with either X or Y as the first dimension, and Z as the second dimension.

$$\vec{P} = {\vec{P}}_{0} + ( {\vec{P}}_{1} - {\vec{P}}_{0} ) t , 0 \leq t \leq 1$$

Plate vectors can be calculated along the stage constraints described herein. These vectors are along the surface of the theoretical plate but modified by the stage constraints. There is no physical plate at this location. For the X axis, the plate bottom can be considered the center of the rails where the bearing sliders rotate about. For the Y axis, the plate can be considered the extension from the x axis where the rail on the Y axis raises the theoretical plate. Above this theoretical plate, a standoff height above this plate defines the chip plane. See the drawings for the individual axes below for a more detailed illustration.

In some embodiments, the gonio X,Y are offsets from the ideal gonio stage center position with 0 gradient.

d. Planar coordinate reference positions.

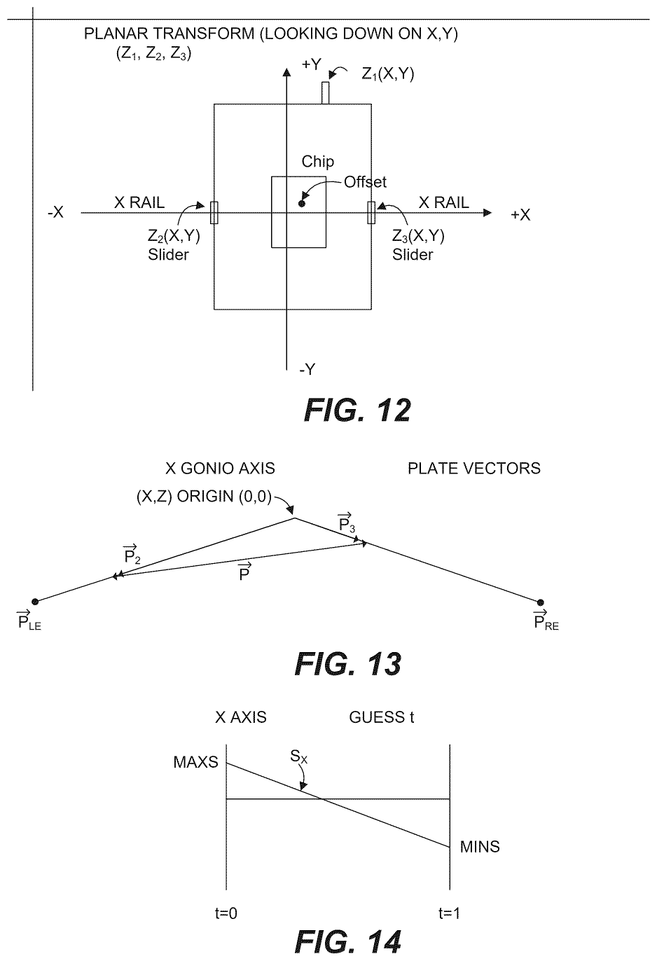

A “Planar Transform” can be calculated from the three contact positions of the gonio bundle, as shown in FIG. 12, Z1, Z2, Z3. Unlike previous stage implementations, in this planar transform, the x and y axis position of these three points may not be fixed, but shift in x with the application of the x gradient, since the sliders move along the rail in real space.

### 4. Gonio X-Axis

a. Internal X, Z Coordinate System

The origin of the gonio X axis coordinate system can be defined by a 0,0 point which is at the virtual apex (meeting point) of the x rails center, if the x rails continued to the middle. This arrangement can simplify the parametric equations for the X axis constraints. The end points \vec{P}_{Le} and \vec{P}_{Re} (Left End and Right End) can be the positions with the plate at a limit where the opposite end would be at the apex at the virtual origin. So the plate vectors at these end locations would be coincident with the rails at these end points. This may not be the true range, which is practically less, just the calcuation limits for the equations. FIG. 13. Exemplary internal X, Z coordinate system.

With this layout, the end point vectors can be calculated from the ramp slope.

$${X}_{L} = L cos ( φ )$$

$${Y}_{L} = L sin ( φ )$$

$${\vec{P}}_{Le} = [ \begin{matrix}- {X}_{L} \\ - {Y}_{L}\end{matrix} ]$$

$${\vec{P}}_{Re} = [ \begin{matrix}{X}_{L} \\ - {Y}_{L}\end{matrix} ]$$

b. Parametric Vector Equations

With this simplified coordinate system origin, the plate vector parametric equations can be simplified as:

$${\vec{P}}_{2} = {\vec{P}}_{Le} * ( 1 - t ) 0 <= t <= 1$$

$${\vec{P}}_{3} = {\vec{P}}_{Re} * t L = X dimension plate length$$

$$\vec{P} = {\vec{P}}_{3} - {\vec{P}}_{2}$$

Here, at t=0, plate is far left, max slope. At t=1, plate is far right, min slope.

c. Calculating Parametric t

The t parameter of the parametric equations can be used to calculate the gradient applied. With the end points specified, t goes from max slope at the far left theoretical ramp position at \vec{P}_{Le}, to the min slope position \vec{P}_{Re} as t transverses from 0 to 1. This allows calculating t as a function of x gradient (slope). FIG. 14. Exemplary parametric t calculation.

d. Z Height Correction for Plate Shortening at Ramp Constraints

The constraints of the plate vector calculated may not be precise. A further constraint can be that the plate length is constant. The actual plate length as calculated by this approximation can vary and a small correction my be used for precision of the true plate position.

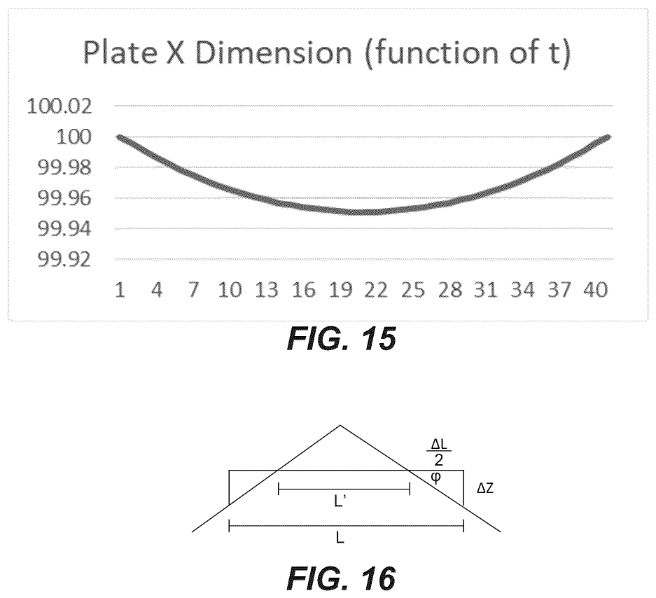

At the extremes of slope, the plate is full length in these constraints, but it shortens towards the middle (zero slope) (FIG. 15).

The effect of this shortening is that the actual plate can be longer, and thus the plate vector can lower in z in order to make contact with the rails. This correction can be calculated through geometry, approximately but accurate because the correction and plate angle can be very small.

The angle φ is the angle between the plate the rail, but can be approximated as just the rail angle because the left side and right side z shift will cancel and the plate can be constrained in the X position by the stage gradient. FIG. 16. Exemplary φ approximation. In FIG. 16:

$$Δ L = ( \vert \vec{P} \vert - L ) / 2$$

$$Δ Z ≅ Δ L tan ( φ )$$

e. Stage X Offset to Apply X Component of Gradient

One goal of the calculation is to determine the amount of x stage offset \vec{P}_{stagex} needed to apply a specified gradient. The amount of shift in the X axis and resulting z position can be calculated from the plate vectors. The shift in the plate position can be calculated using the nominal center vector \vec{P}_{c0} and the new shifted plate vector center \vec{P}_{c}. The total x, z shift vector is then:

$${\vec{P}}_{c 0} = ( {\vec{P}}_{Le} + {\vec{P}}_{Re} ) / 4$$

$$\vec{{P}_{c}} = ( {\vec{P}}_{2} + {\vec{P}}_{3} ) / 2$$

$$Shift vector {\vec{P}}_{stagex} = {\vec{P}}_{c} - {\vec{P}}_{c 0}$$

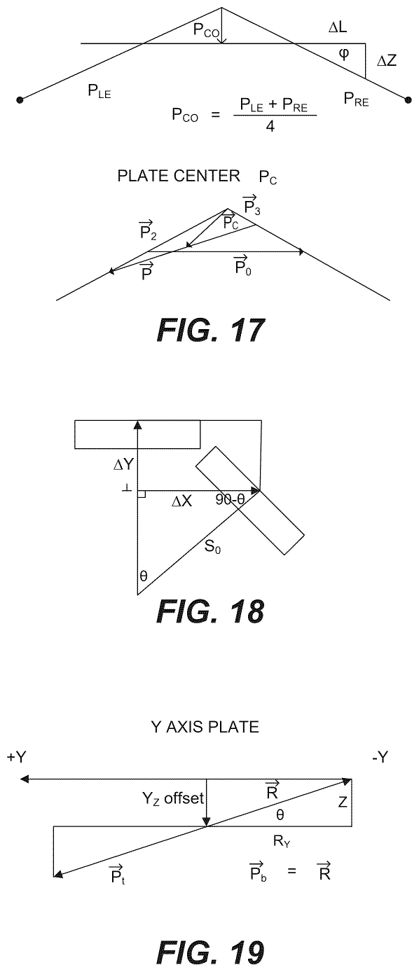

FIG. 17. Exemplary stage X offset to apply X component of gradient.

f. X,Z Correction for Translational and Rotational Shift.

The chip shift in imaging position can be calculated with translation shift and rotational shift terms.

The translational shift x, z component can be the same as the shift vector \vec{P}_{stagex}.

The rotational shift x, z component can be calculated by the standoff S₀ of the chip above the rotation axis. FIG. 18. Exemplary rotational shift x and z components. In FIG. 18,

$$Δ x = {S}_{0} sin ( θ )$$

$$Δ z = {S}_{0} - {S}_{0} cos ( θ )$$

$$Δ z = {S}_{0} ( 1 - cos ( θ ) )$$

$${\vec{P}}_{rotationalx} = [ \begin{matrix}Δ x \\ Δ z\end{matrix} ]$$

$$Total x , z chip shift = {\vec{P}}_{stag ex} + {\vec{P}}_{rotationalx}$$

### 5. Gonio Y-Axis

a. Internal Y, Z Coordinate System and Crosstalk Issues

The Y coordinate system follows the X coordinate system Z origin. This can require adding in a final offset to position intermediate Z calculations into this X axis system.

An important consequence of a design disclosed herein has the Y bearing position off center of the Y axis. This causes “crosstalk” in the axes such that when an X gradient is applied, the Y position can need to be shifted to maintain the Y gradient required. These calculations are shown below.

The amount of shift to correct the Y gradient can be calculated by using the X plate vectors, since it is a function of the current X slope, using the X position of the Y axis bearing. This correction can follow the slope of the X plane at the Y axis offset in X.

$$YZoffset = \vec{P} \cdot Y * ( \frac{YaxisX}{\vert \vec{P} \vert} )$$

b. Parametric Vector Equations

For the Y axis, the t parameter can be, for example, chosen as the Z offset from center at the Y bearing.

c. Plate Vector Calculations

The nominal Y plate radius R_{y}. As the Y is raised up or down, the bearing will slide slightly, increasing the radius vector \vec{R} length from center. The z offset for the specified gradient can be calculated as follows. A tangent calculates t, using the radius of the plate in Y.

FIG. 19. Exemplary plate vector calculations.

$$Δ Z = Ry tan ( θ )$$

The top vector \vec{P}ₜ and bottom vector \vec{P}_{b} in this internal computation can point from the center of rotation about the x axis but corrected by the YZOffset as mentioned above.

$${\vec{P}}_{b} = [ \begin{matrix}- {R}_{y} \\ YZOffset - Z\end{matrix} ] ,$$

$${\vec{P}}_{{t}^{=}} [ \begin{matrix}{R}_{y} \\ YZOffsef + Z\end{matrix} ]$$

d. Stage Y Offset to Apply Y Component of Gradient

The Y shift to apply the Y portion of the chip gradient is the z offset at the horizontal Y slider.

The X axis Z origin center (called Y_{L}, see the x axis discussion) can be subtracted to use the same Z reference position.

$$StageShiftY = {\vec{P}}_{t} \cdot {Y}_{L / 2} / {S}_{y}$$

e. X,Z Correction for Translational Chip Shift

For Y, the plate does not translate. It just rotates about the Y origin at the X rail center.

$${\vec{P}}_{translationaly} = 0$$

f. X,Z Correction for Rotational Chip Shift (from z Standoff Rotation)

Rotational shift x and z components:

$$Δ y = {S}_{0} sin ( θ )$$

$$Δ z = {S}_{0} - {S}_{0} cos ( θ )$$

$$Δ z = {S}_{0} ( 1 - cos ( θ ) )$$

$${\vec{P}}_{rotationaly} = [ \begin{matrix}Δ y \\ Δ z\end{matrix} ]$$

The same rotational correction can be used as in the X axis, by substituting the 0 in Y.

### 6. Final Outputs for an Input Desired Chip Gradient ∇Chip

a. Stage X and Stage Y to Apply Gradient

$${\vec{P}}_{stage} = [ \begin{matrix}{\vec{P}}_{stagex} X \\ StageShiftY\end{matrix} ]$$

b. Combined X,Y,Z Chip Shift Output.

The final X, Y,Z chip shift vector can be the sum of the individual X and Y axis shift terms.

This shift can be applied to the imaging (e.g., raster imaging) in the x and y axis, as well as the Z pifoc window.

$${\vec{P}}_{chipxyz} = {\vec{P}}_{translationalx} + {\vec{P}}_{rotationalx} + 0 + {\vec{P}}_{rot ationaly}$$

### 7. Measuring, Monitoring, and Calibrating Gradient Slopes

a. The Applied Stage Gradients are Measured and Monitored Using a Laser Proximeter/Focuser.

After chip leveling to the focal plane of the optics (for imaging a sample, such as a nucleic acid sample, e.g., a OGM sample), the error in such leveling can be measurable by taking z surface measurements of the chip in the corners (e.g., using the laser proximeter/focuser) and calculating the residual gradient error. This can be monitored during chip runs to measure accuracy and repeatability of the leveling operation.

b. Measured Errors in the Gradients Above can be Caused by Hardware Deviations from CAD Designs and are Corrected Via Gonio Ramp Slope Calibrations.

To impart a more accurate slope when leveling the chips, a gonio calibration can be applied to correct for hardware errors in the effective ramp slopes. This can be, for example, a linear calibration applied to the commanded gradient slope values. The relationship between the ramp slopes and applied slopes can be a non-linear function, and a solution can be an iterative method. To do this, a multiplier for both the X and Y gonio slopes can be calculated by applying commanded slopes and measuring actual slopes with the focuser as discussed in section a above.
//Sa Slope to Apply,—Sc Slope to Command Sr Slope Residual
//Sa=m Sc+b—Here m is the calibration linear coefficient
//Sc=(Sa−b)/m—Inverse to calculate slope to command

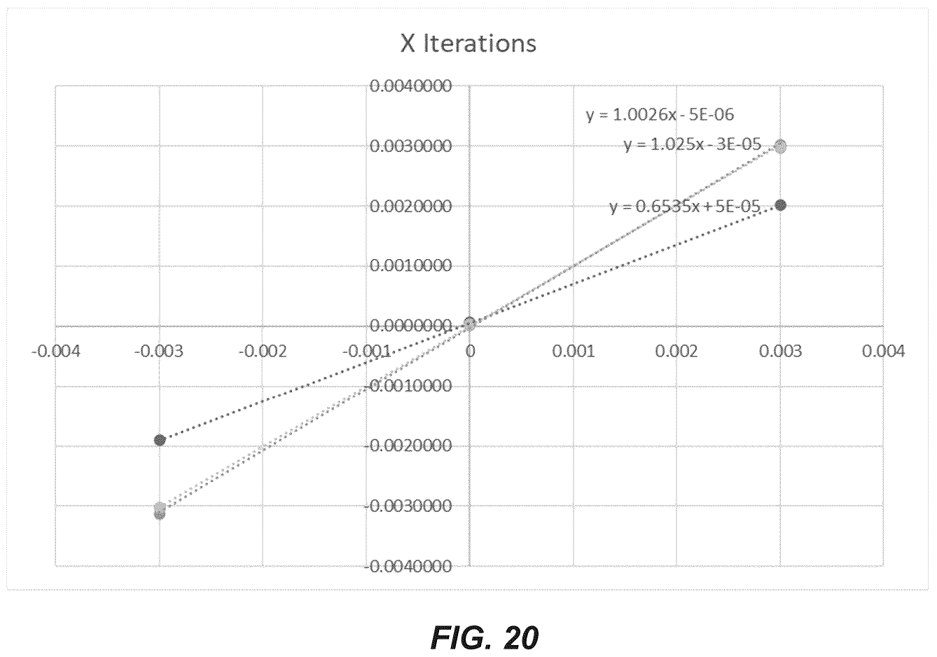

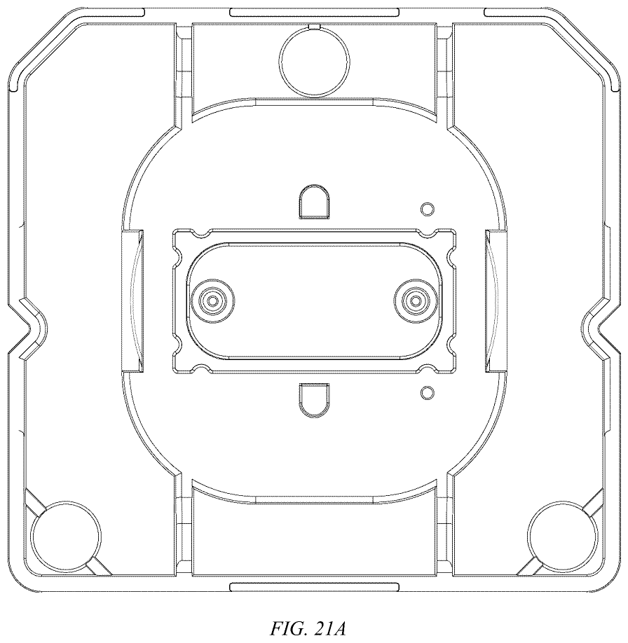

Using the measured residuals, linear regressions of commanded vs. actual gradient slopes can be used to calculate the gradient error. This can be done via an iterative approach, adjusting the calibration multiplier for both the x and y ramp slopes, and reapplying until the commanded vs. actual converges on the desired slope of 1.0 where commanded equals actual. At each iteration, the current ramp slope corrections, Mx and My, can be multiplied with the slope of the regression, as in the iterations plotted in FIG. 20, for a new Mx′, My′.

FIG. 20. Exemplary calibrating gonio slopes. Residuals added until desired slope of 1 achieved.

### Tip and Tilt Motion Stage Control Embodiments

Disclosed herein include embodiments of a method of positioning (or leveling or moving) a sample (e.g., adjusting the tip-axis and the tilt axis of the sample or TnT motion stage). A sample can be provided. The sample can be in a sample chip or cartridge. In some embodiments, a method of positioning a sample can comprise: providing a sample. The method can comprise: placing the sample, or the sample chip or cartridge, on (or onto or into) a sample carrier of a TnT motion stage of a motion platform of the present disclosure. The TnT motion stage can be on an x-y motion stage of the motion platform. The x-y motion stage can be on a base of the motion platform The method can include: determining a tip-tilt adjustment needed for the sample. The method can include: engaging a tip-axis adjustment paw (or tip adjustment engagement component) on the base of the motion platform with a tip-axis adjustment notch (or complementary tip adjustment engagement component) of the TnT motion stage. The method can include: moving an x-y motion stage of the motion platform along one axis of the x-axis and the y-axis, thereby changing the tip of the TnT motion stage, based on the tip-tilt adjustment needed. The method can include engaging a tilt-axis adjustment paw (or tilt adjustment engagement component) on the base of the motion platform with a tilt-axis adjustment notch (or complementary tilt adjustment engagement component) of the TnT motion stage. The method can include: moving the x-y motion stage along the one axis of the x-axis and the y-axis, thereby changing the tilt of the TnT motion stage, based on the tip-tilt adjustment needed.

In some embodiments, a method of positioning a sample comprises: providing a sample. The sample can be in a sample chip or cartridge. The method can comprise: placing the sample, or the sample chip or cartridge, on (or onto or into) a sample carrier of a tip and tilt (TnT) motion stage of a motion platform of the present disclosure. The TnT motion stage can be on an x-y motion stage of the motion platform. The x-y motion stage can be on a base of the motion platform. The method can comprise, iteratively, determining a tip-tilt adjustment needed for the sample. The iterative process can include: engaging a tip-axis adjustment paw (or tip adjustment engagement component) on the base of the motion platform with a tip-axis adjustment notch (or complementary tip adjustment engagement component) of the TnT motion stage. The iterative process can include: moving an x-y motion stage of the motion platform along one axis of the x-axis and the y-axis, thereby changing the tip of the TnT motion stage, based on the tip-tilt adjustment needed. The iterative process can include: engaging a tilt-axis adjustment paw (or tilt adjustment engagement component) on the base of the motion platform with a tilt-axis adjustment notch (or complementary tilt adjustment engagement component) of the TnT motion stage. The iterative process can include: moving the x-y motion stage along the one axis of the x-axis and the y-axis, thereby changing the tilt of the TnT motion stage, based on the tip-tilt adjustment needed.

In some embodiments, the iterative process comprises: determining a chip gradient. The iterative process can comprise: engaging a tip-axis adjustment paw on the base of the motion platform with a tip-axis adjustment notch of the TnT motion stage. The iterative process can comprise: moving an x-y motion stage of the motion platform along one axis of the x-axis and the y-axis, thereby changing the tip of the TnT motion stage, based on the chip gradient. The iterative process can comprise: engaging a tilt-axis adjustment paw on the base of the motion platform with a tilt-axis adjustment notch of the TnT motion stage. The iterative process can comprise: moving the x-y motion stage along the one axis of the x-axis and the y-axis, thereby changing the tilt of the TnT motion stage, based on the chip gradient adjustment needed. The iterative process can comprise: determining a FOV gradient. The iterative process can comprise: engaging a tip-axis adjustment paw on the base of the motion platform with a tip-axis adjustment notch of the TnT motion stage. The iterative process can comprise: moving an x-y motion stage of the motion platform along one axis of the x-axis and the y-axis, thereby changing the tip of the TnT motion stage, based on the FOV gradient. The iterative process can comprise: engaging a tilt-axis adjustment paw on the base of the motion platform with a tilt-axis adjustment notch of the TnT motion stage. The iterative process can comprise: moving the x-y motion stage along the one axis of the x-axis and the y-axis, thereby changing the tilt of the TnT motion stage based on the FOV gradient adjustment needed.

In some embodiments, a method of positioning a sample comprises: (a) providing a sample. The sample can be in a sample chip or cartridge. The method can comprise: (b) placing the sample, or the sample chip or cartridge, on (or onto or into) a sample carrier of a tip and tilt (TnT) motion stage of a motion platform of the present disclosure. The TnT motion stage can be on an x-y motion stage of the motion platform. The x-y motion stage can be on a base of the motion platform. The method can comprise: (c1) determining a chip gradient of the sample. The method can comprise: (d1) performing one or more steps of the following based on the chip gradient in step (d1). The method can comprise: engaging a tip-axis adjustment paw (or tip adjustment engagement component) on the base of the motion platform with a tip-axis adjustment notch (or complementary tip adjustment engagement component) of the TnT motion stage. The method can comprise: moving an x-y motion stage of the motion platform along one axis of the x-axis and the y-axis, thereby changing the tip of the TnT motion stage. The method can comprise: engaging a tilt-axis adjustment paw (or tilt adjustment engagement component) on the base of the motion platform with a tilt-axis adjustment notch (or complementary tilt adjustment engagement component) of the TnT motion stage. The method can comprise: moving the x-y motion stage along the one axis of the x-axis and the y-axis, thereby changing the tilt of the TnT motion stage. In some embodiments, the method can comprise: (c2) determining a field of view (FOV) gradient. The method can comprise: (d2) performing one or more steps of (d1) based on the FOV gradient.

In some embodiments, a method of positioning a sample comprises: providing a sample. The sample can be in a sample chip or cartridge. The method can include: placing the sample, or the sample chip or cartridge) on (or onto or into) a sample carrier of a tip and tilt (TnT) motion stage of a motion platform of the present disclosure. The TnT motion stage can be on an x-y motion stage of the motion platform. The x-y motion stage can be on a base of the motion platform. The method can include: determining a chip gradient of the sample. The method can include: engaging a tip-axis adjustment paw (or tip adjustment engagement component) on the base of the motion platform with a tip-axis adjustment notch (or complementary tip adjustment engagement component) of the TnT motion stage and moving an x-y motion stage of the motion platform along one axis of the x-axis and the y-axis, thereby changing the tip of the TnT motion stage, based on the chip gradient. The method can include: engaging a tilt-axis adjustment paw (or tilt adjustment engagement component) on the base of the motion platform with a tilt-axis adjustment notch (or complementary tilt adjustment engagement component) of the TnT motion stage and moving the x-y motion stage along the one axis of the x-axis and the y-axis, thereby changing the tilt of the TnT motion stage, based on the chip gradient. The method can include: determining a field of view (FOV) gradient. The method can include: engaging the tip-axis adjustment paw with the tip-axis adjustment notch and moving an x-y motion stage of the motion platform along the one axis of the x-axis and the y-axis, thereby changing the tilt of the TnT motion stage, based on the FOV gradient. The method can include: engaging the tilt-axis adjustment paw with the tilt-axis adjustment notch and moving the x-y motion stage along the one axis of the x-axis and the y-axis, thereby changing the tilt of the TnT motion stage, based on the FOV gradient.

In some embodiments, a method of positioning a sample can comprise: providing a sample. The method can comprise: placing the sample, or the sample chip or cartridge, on (or onto or into) a sample carrier of a TnT motion stage of a motion platform of the present disclosure. The method can comprise: determining a tip adjustment needed. The method can comprise: determining a tilt adjustment needed. In some embodiments, the method comprises: determining a tip adjustment needed, a tilt adjustment needed, or a combination thereof. The method can comprise: engaging the tip-axis adjustment paw (or tip adjustment engagement component) with the tip-axis adjustment notch (or complementary tip adjustment engagement component). The method can comprise: moving the x-y motion stage along one axis (e.g., the y-axis) of the x-axis and the y-axis based on the tip adjustment needed. This can result in changing the tip of the TnT motion stage. The method can include: engaging the tilt-axis adjustment paw (or tilt adjustment engagement component) with the tilt-axis adjustment notch (or tilt complementary adjustment engagement component). The method can include: moving the x-y motion stage along the one axis (e.g., the y-axis) of the x-axis and the y-axis based on the tilt adjustment needed. This can result in changing the tilt of the TnT motion stage. Prior to engaging the tilt-axis adjustment paw with the tilt-axis adjustment notch, the method can include: disengaging the tip-axis adjustment paw with the tip-axis adjustment notch

In some embodiments, engaging the tip-axis adjustment paw with the tip-axis adjustment notch and moving the x-y motion stage along the one axis of the x-axis and the y-axis occurs before engaging the tilt-axis adjustment paw with the tilt-axis adjustment notch and moving the x-y motion stage along the one axis of the x-axis and the y-axis, thereby changing the tilt of the TnT motion stage. Prior to engaging the tilt-axis adjustment paw with the tilt-axis adjustment notch, the method can include: disengaging the tip-axis adjustment paw with the tip-axis adjustment notch. In some embodiments, engaging the tip-axis adjustment paw with the tip-axis adjustment notch and moving the x-y motion stage along the one axis of the x-axis and the y-axis occurs after engaging the tilt-axis adjustment paw with the tilt-axis adjustment notch and moving the x-y motion stage along the one axis of the x-axis and the y-axis, thereby changing the tilt of the TnT motion stage. Prior to engaging the tip-axis adjustment paw with the tip-axis adjustment notch, the method can include: disengaging the tilt-axis adjustment paw with the tilt-axis adjustment notch.

In some embodiments, the first-axis comprises the tip-axis. In some embodiments, the first-axis comprises the tilt-axis. In some embodiments, the method further comprises: determining a second-axis adjustment needed. The method can comprise: engaging the second-axis adjustment engagement component with the second-axis complementary adjustment engagement component. The method can comprise: moving the x-y motion stage along the one axis of the x-axis and the y-axis, thereby changing the second-axis of the motion stage, based on the first-axis adjustment needed. In some embodiments, the second-axis comprises the tip-axis. In some embodiments, the second-axis comprises the tilt-axis.

In some embodiments, the tip-tilt adjustment comprises a chip gradient (e.g., φ_{C}), a leveling gradient (e.g., φ_{L}), and/or a field of view (FOV) gradient (e.g., φ_{F}). In some embodiments, the tip-tilt adjustment comprises (i) a stage X offset or a X component of gradient and/or (ii) a stage Y offset or a Y component of gradient. The tip-tilt adjustment can comprise a tip adjustment and a tilt adjustment. The tip-adjustment can comprise a stage X offset (e.g., \vec{P}_{stagex}X) or a X component of gradient. The tilt-adjustment can comprise a stage Y offset (e. g., StageShiftY) or a Y component of gradient. In some embodiments, determining the tip-tilt adjustment comprises: determining a X, Y,Z shift vector (e.g., \vec{P}_{chipxyz}=\vec{P}ₜᵣₐₙₛₗₐₜᵢₒₙₐₗₓ+\vec{P}ᵣₒₜₐₜᵢₒₙₐₗₓ+0+\vec{P}_{rotationaly}

In some embodiments, the method comprises: changing the x-y position of the motion stage. Changing the x-y position of the motion stage can occur before changing the tip of the TnT motion stage and/or the tilt of the TnT motion stage. Changing the x-y position of the motion stage can occur after changing the tip of the TnT motion stage and/or the tilt of the TnT motion stage.

In some embodiments, the sample is in a sample chip or cartridge. In some embodiments, placing the sample on the sample carrier can comprise placing the sample chip or cartridge on the sample carrier.

In some embodiments, a method of positioning (or leveling or moving) a sample comprises: providing a sample. The sample can be in a sample chip or cartridge. The method can include: placing the sample, or the sample chip or cartridge, on (or onto or into) a sample carrier of a tip motion stage of a motion platform. The method can include: determining a tip adjustment needed. The method can include: engaging the tip-axis adjustment engagement component with the tip-axis complementary adjustment engagement component. The method can include: moving the x-y motion stage along one axis of the x-axis and the y-axis based on the tip adjustment needed. This can result in changing the tip of the tip motion stage.

In some embodiments, a method of positioning (or leveling or moving) a sample comprises: providing a sample. The sample can be in a sample chip or cartridge. The method can include: placing the sample, or the sample chip or cartridge, on (or onto or into) a sample carrier of a tilt motion stage of a motion platform. The method can include: determining a tilt adjustment needed. The method can include: engaging the tilt-axis adjustment engagement component with the tilt-axis complementary adjustment engagement component. The method can include: moving the x-y motion stage along one axis of the x-axis and the y-axis based on the tilt adjustment needed. This can result in changing the tilt of the tilt motion stage.

In some embodiments, a method of positioning (or leveling or moving) a sample comprises: providing a sample. The sample can be in a sample chip or cartridge. The method can include: placing the sample, or the sample chip or cartridge, on (or onto or into) a sample carrier of a motion stage of a motion platform. The method can include: determining a first-axis adjustment needed. The method can include: engaging the first-axis adjustment engagement component with the first-axis complementary adjustment engagement component. The method can include: moving the x-y motion stage along one axis of the x-axis and the y-axis based on the first-axis adjustment needed. This can result in changing the first-axis of the motion stage.

Disclosed herein include methods of imaging a sample. In some embodiments, a method of imaging a sample comprising: positioning (e.g., adjusting the tip-axis and/or tilt-axis) a sample as described herein. The sample can be on (or in) a sample carrier of a TnT motion stage of a motion platform of the present disclosure. Positioning the sample can include adjusting the tip-axis and/or tilt-axis of the TnT motion stage as described herein. The method can include: rastering, using the x-y motion stage, to different positions along the x-axis and/or the y-axis. The method can include capturing images of the sample at the different positions. In some embodiments, the tip-axis and/or tilt-axis of the sample (or the TnT motion stage) can be adjusted after a number of images of the sample are captured at different positions. In some embodiments, the tip-axis and/or tilt-axis of the sample (or the TnT motion stage) may not need to be adjusted.

In some embodiments, the sample comprises an optical genome mapping (OGM) sample. In some embodiments, the sample comprises nucleic acids. The nucleic acids can comprise deoxyribonucleic acid (DNA). The nucleic acids can comprise the nucleic acids comprise genomic DNA. The nucleic acids can comprise fragmented genomic DNA. The nucleic acids can comprise ribonucleic acids (RNA). The nucleic acids can comprise DNA derived (e.g., reverse transcribed) from DNA or RNA. In some embodiments, the sample comprises labeled nucleic acids, optionally wherein the sample comprises fluorescently labeled nucleic acids.

### Exemplary Cartridges

Disclosed herein include, for example, components (e.g., the consumable components) of an optical genome mapping system (including but not limited to Saphyr™ and Marvel systems for optical genome mapping system by Bionano Genomics, Inc.). In some embodiments using an OGM system for analysis, a biological sample is loaded into a fluidic device, e.g., a container or a microfluidic cartridge having a fluidic chamber or a more complex fluidic network, and then at least a portion of the fluidic device is imaged by an imaging system to detect one or more analytes in the biological sample. The analytes can comprise nucleic acids, for example DNA (including but not limited to high molecular weight genomic DNA (gDNA)). In some embodiments, genome mapping in fluidic nanochannels is applied to interrogate genome structural variation (SV) in megabase length DNA molecules outside the detection range of next generation sequencing (NGS). These genome mapping in fluidic channel technologies, such as nick label repair stain chemistry (NLRS) or directly labeled (non-damaging) using the direct label and stain chemistry (DLS) (both from Bionano Genomics, San Diego, CA), are able to generate structurally accurate genome assemblies for large and complex plant and animal genomes.

Disclosed herein includes components, e.g., a cartridge, of the OGM systems. The cartridge can be configured, in some embodiments, host a liquid sample, for example in one or more flow cells in the cartridge. In some embodiments, the cartridge comprises a hermetic seal capable of preventing evaporation of the liquid sample contained in the cartridge. In some embodiments, the hermetic seal is formed by contacting one or more parts of the cartridge with one or more components of the OGM system to prevent evaporation of the liquid sample contained in the cartridge. In some embodiments, the hermetic seal contacts with the cartridge to prevent evaporation of the liquid sample.

The type or source of the liquid sample can vary. For example, the liquid sample can comprise a biological sample (e.g., a process biological sample). The biological sample can comprise one or more analytes (e.g., nucleic acid). In some embodiments, the liquid sample comprises DNA, for example high molecular weight DNA or ultrahigh molecular weight DNA. In some embodiments, the liquid sample comprises genomic DNA (gDNA), mitochondria DNA, or a combination thereof. The size of the DNA (e.g., gDNA) can vary, for example, at least or at least about, 100 kb, 200 kb, 500 kb, 1 Mb, 1.5 Mb, or 2 Mb in length. The DNA can be isolated from various of organisms, including but not limited to, animals (e.g., a mammal, or a human) and plants (e.g., corn, rice, potato).

The cartridge can be made of various materials, for example polymers. In some embodiments, the cartridge is plastic.

It is advantageous for the OGM system to be able to keep the liquid sample unchanged or with minimal changes (including minimizing or preventing the liquid sample from evaporation) for a long period of time. The OGM components described herein can, for example, result in the prevention of evaporation for at least, or at least about, 100 hours, 200 hours, 300 hours, 400 hours, 500 hours, 600 hours, or more. The evaporation rate of the liquid sample contained in the OGM cartridge described herein can be, for example, no more than 10%, no more than 20%, no more than 30%, no more than 40%, no more than 50%, no more than 60%, no more than 70%, or no more than 80% of the liquid content of the liquid sample, for 100 hours, 150 hours, 200 hours, 250 hours, 300 hours, 350 hours, 400 hours, 450 hours, 500 hours, 550 hours, 600 hours, or a number or a range between any two of these values.

In some embodiments, the cartridge comprises one or more flow cells and/or one or more electrodes (e.g., hollow electrodes). The one or more flow cells can, for example, be fluidically connected with each other, or each of the one or more flow cells is fluidically connected with at least one of the other flow cells. In some embodiments, at least one of the one or more flow cells is not fluidically connected with any of the other flow cells. In some embodiments, the one or more electrodes (e.g., hollow electrodes) are configured to be fluidically connected with at least one of the flow cells. The electrodes (e.g., hollow electrodes) can be configured to prevent evaporation and/or allow the liquid sample to be loaded into the flow cell. For example, at least one of the one or more electrodes (e.g., hollow electrodes) is configured as a loading port for the liquid sample.

How the one or more electrodes (e.g., hollow electrodes) are positioned in the cartridge can vary. For example, the electrodes (e.g., hollow electrodes) can be insert molded with an injection moldable material. In some embodiments, the one or more electrodes (e.g., hollow electrodes) are sealed off with a thermoplastic elastomer material (TPE). The seal off can prevent evaporation. In some embodiments, the hermetic seal is formed by contacting the cartridge, insert molding of electrodes and a TPE seal. The TPE seal can be, for example, an overmolding seal.

As described herein and illustrated in the accompanying drawings, non-exemplary components for an OGM system can include:
1. Cartridge—e.g., one piece
   a. BOM
      i. Polycarbonate
      ii. Silicon die (Flow Cell)
      iii. Overmolded Versaflex
      iv. Pre-formed wire leads
   b. Hermetic seal
      i. Versaflex seal for evaporation prevention
      ii. Silicon die and adhesive
   c. The use of titanium electrodes
      i. Deep drawn
      ii. Titanium wires (not suitable for automated manufacturing)
      iii. Micromachined hollow electrodes
   d. Pipette with and without guide funnels
      i. Sample loading options
   e. Twist motion lid
      i. In some embodiments, it is configured to allow for at least, or at least about, 140 hours of reliable operation
      ii. Reusable option
   f. Formed wire leads. In some embodiments, the formed wire leads are not suitable for automated assembly. In some embodiments, the wire leads are configured for automated assembly.
2. Flow Cell
   a. Footprint: in some embodiments, the flow cell (e.g., Alpha 7) is about 40% smaller than currently available flow cell (e.g., Alpha 5) used in an OGM system.
   b. Loading index: in some embodiment, it can be advantageous to require 2500 Gbp for the loading index.

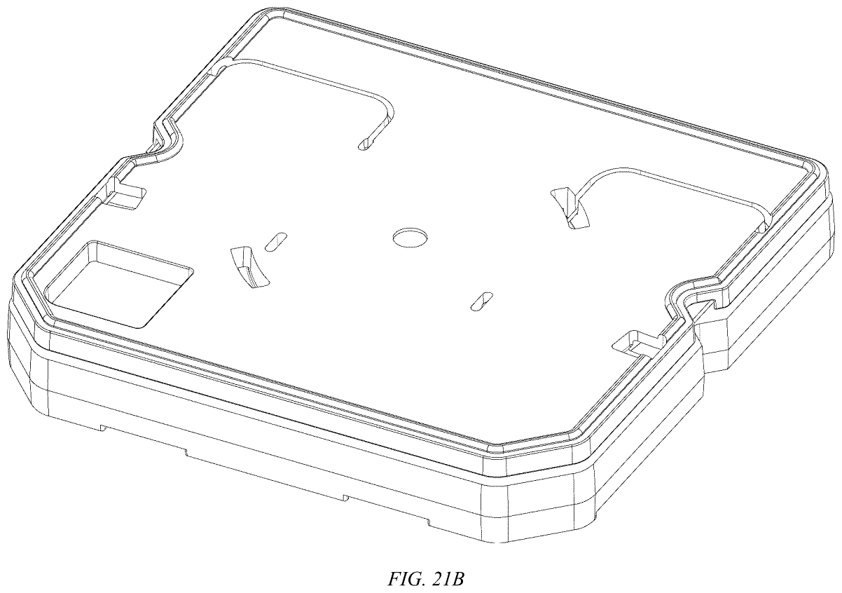

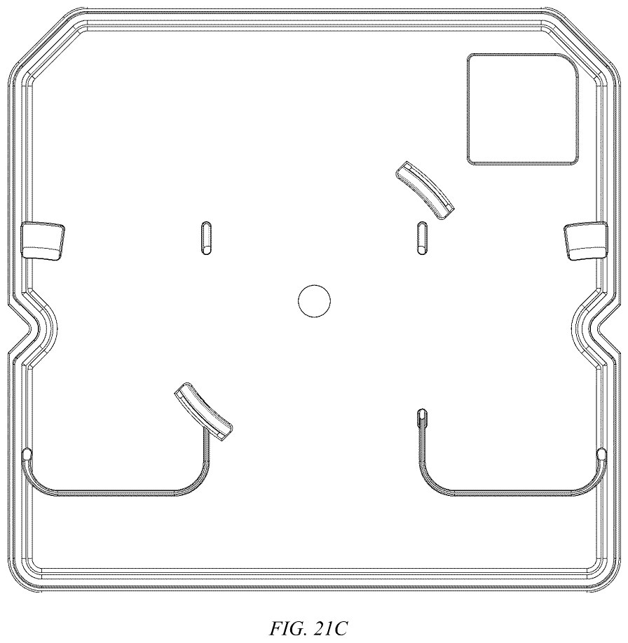

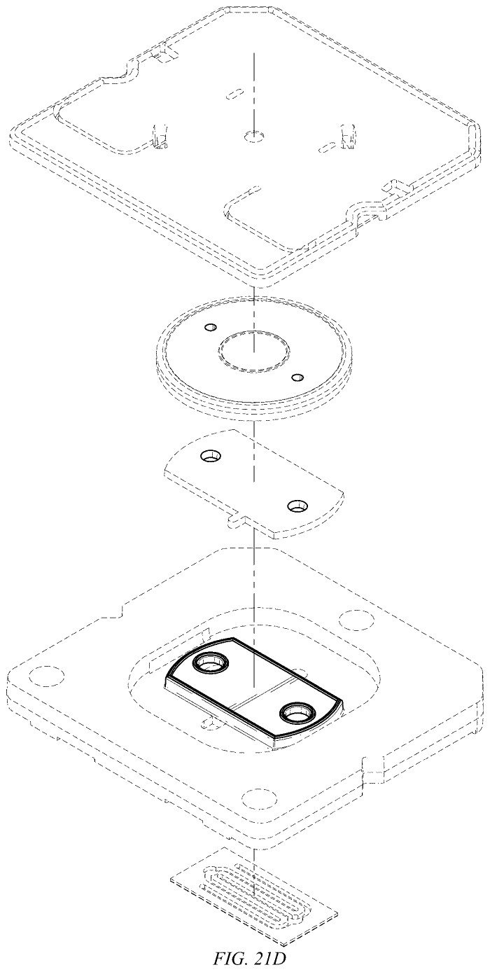

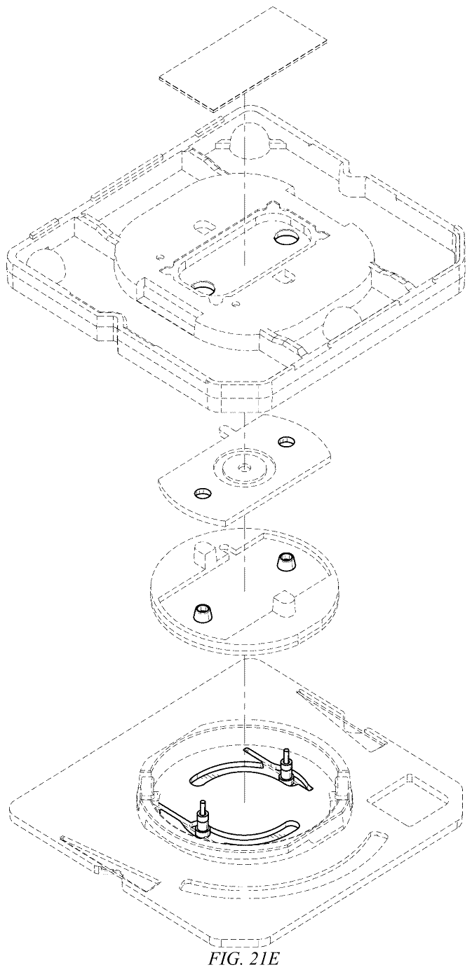

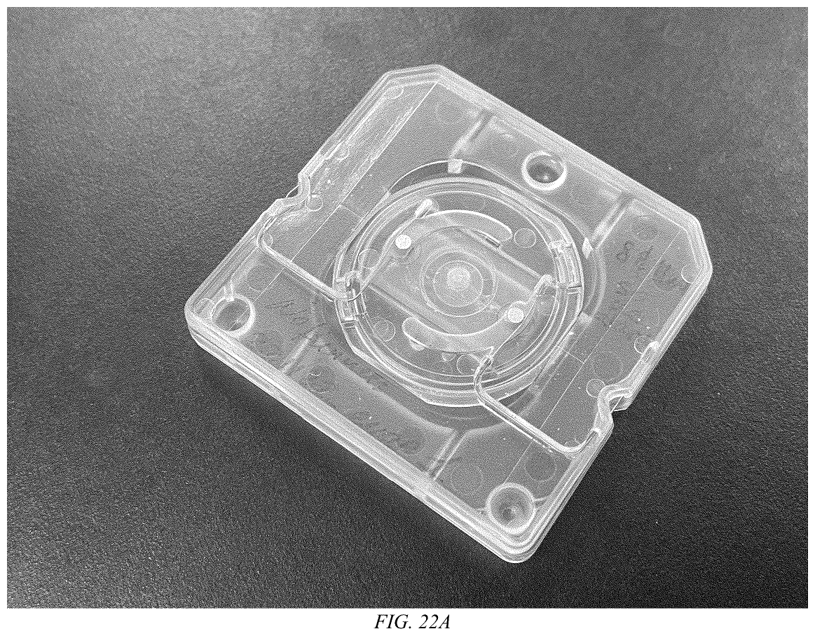

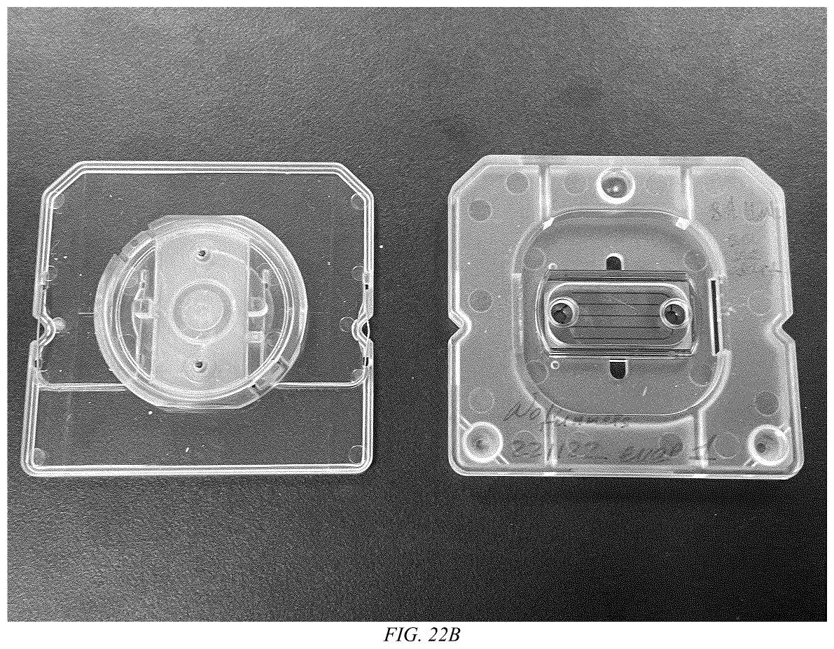

FIGS. 21A-21E depict views of a non-limiting embodiment of a cartridge for microscopy, such as fluorescent microscopy (e.g., OGM). The cartridge shown is a multibody part cartridge. A bottom cover when attached to the cartridge can form a flow cell. The top surface of the bottom cover can include one or more flow channels. In the embodiment depicted, the electrodes can be solid electrodes (also referred to herein as pins). The cartridge can include a seal, which can have an overmolded TPE material, such as an overmolded Versaflex seal (the middle pieces in FIGS. 21D and 21E).

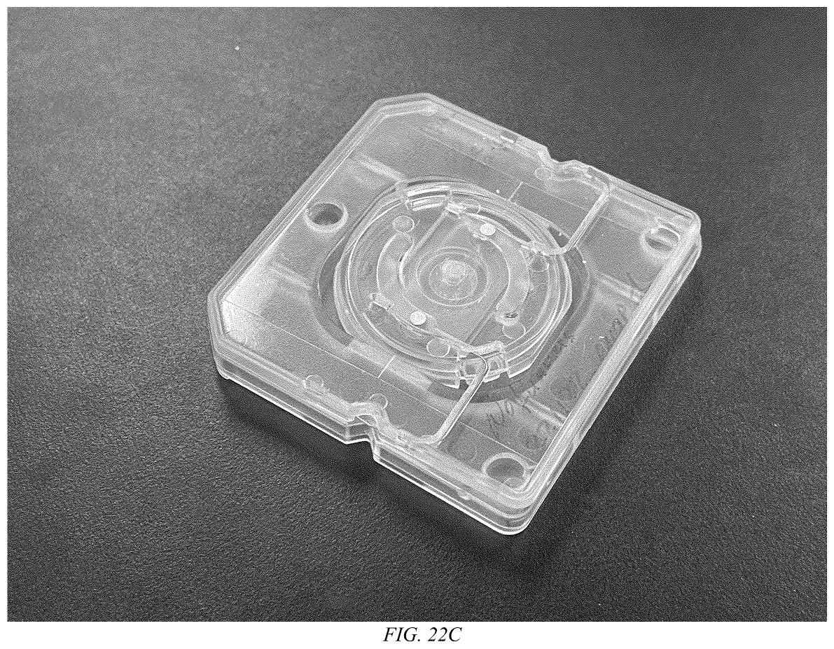

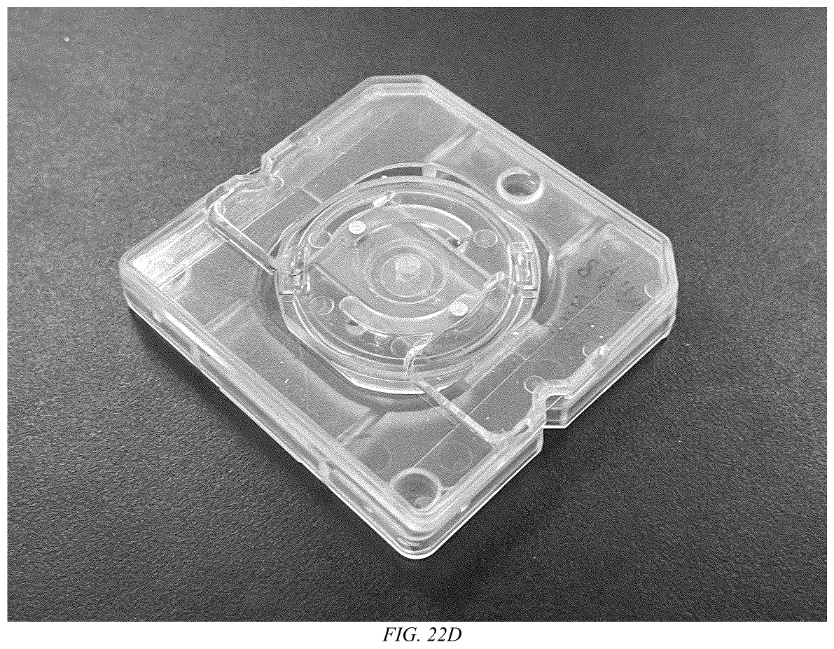

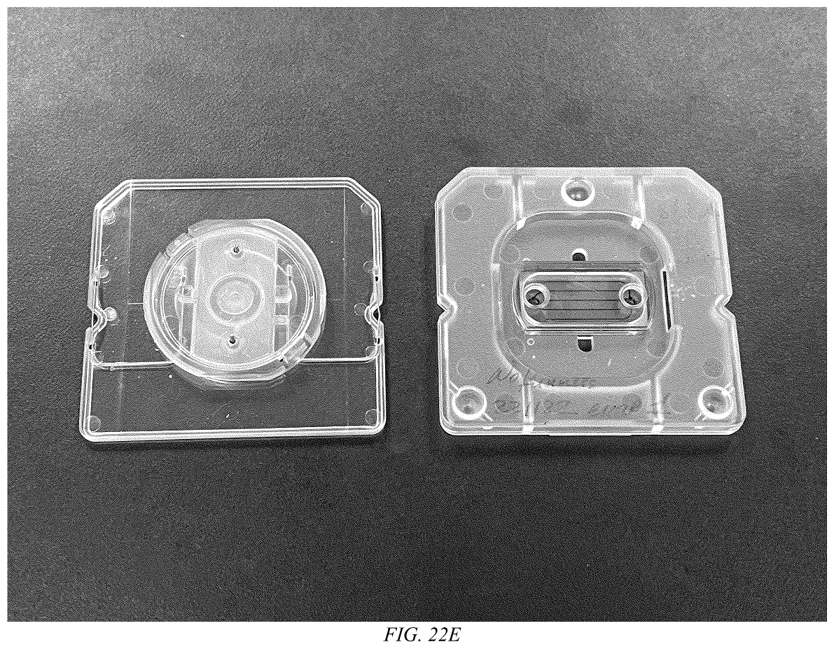

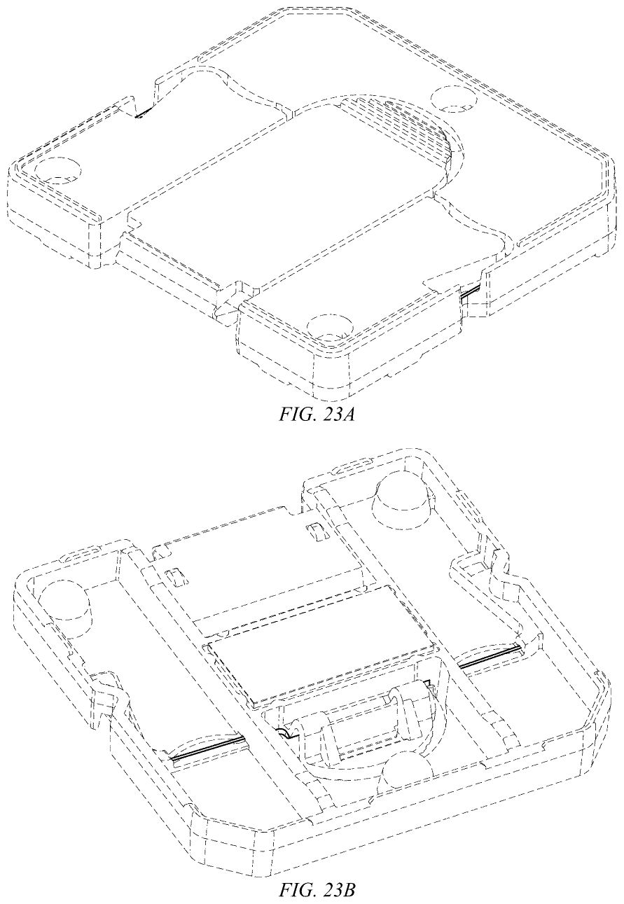

FIGS. 22A-22E depict various views of a non-limiting embodiment of a cartridge described herein (such as the embodiment depicted in FIGS. 21A-21D). A cartridge disclosed herein can be used for microscopy, such as fluorescent microscopy (e.g., OGM).

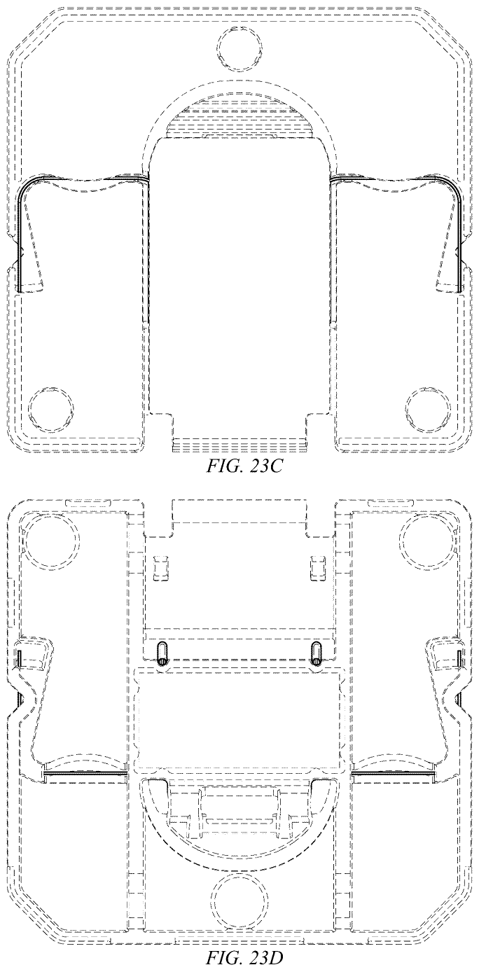

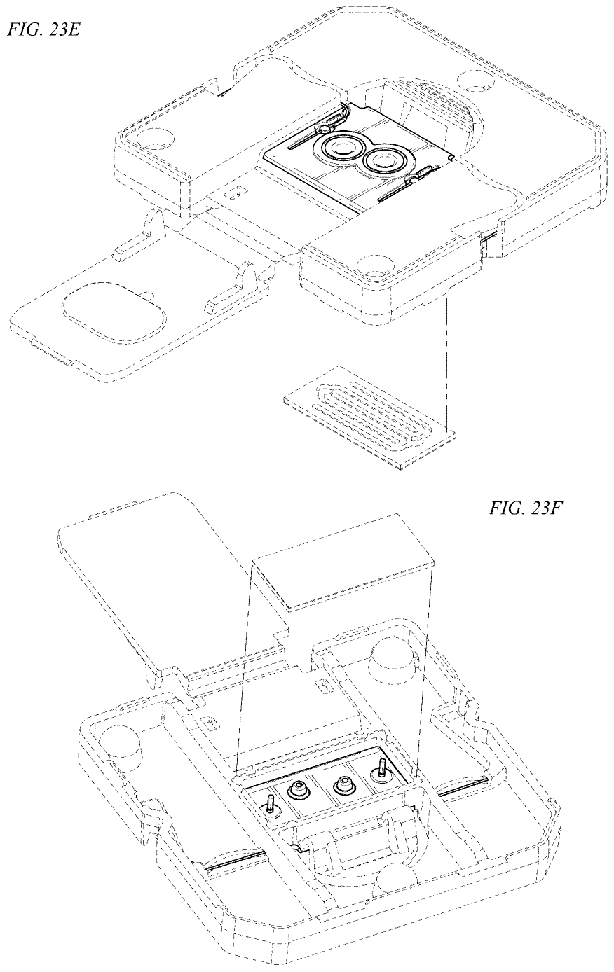

FIGS. 23A-23F show views of a non-limiting embodiment of a cartridge for microscopy, such as fluorescent microscopy (e.g., OGM). In the embodiment depicted, the electrodes can be solid electrodes (also referred to herein as pins). In the embodiment shown, wires (solid lines in FIGS. 23A-23D) can be used for electrical connectivity to an instrument, such as an OGM instrument. In the embodiment depicted, the cartridge can include a seal, which can have an overmolded TPE material, such as an overmolded Versaflex seal (which can have an oral shape as shown in FIG. 23E).

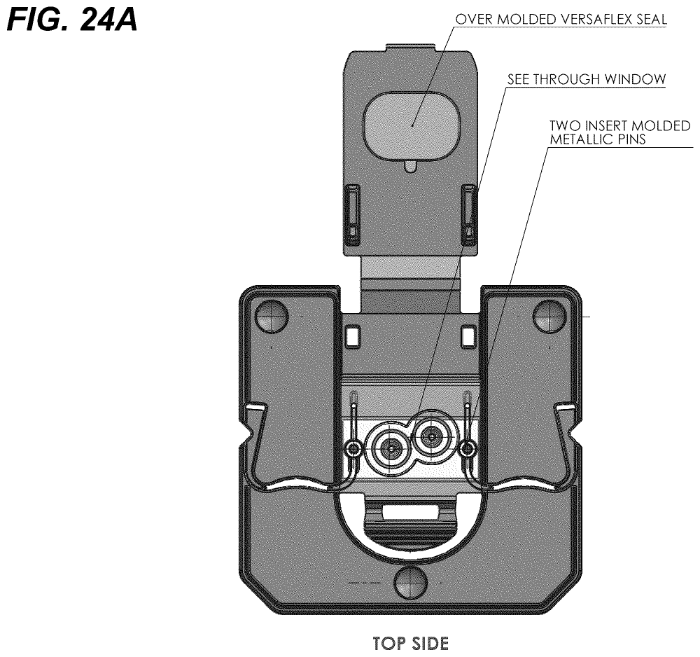

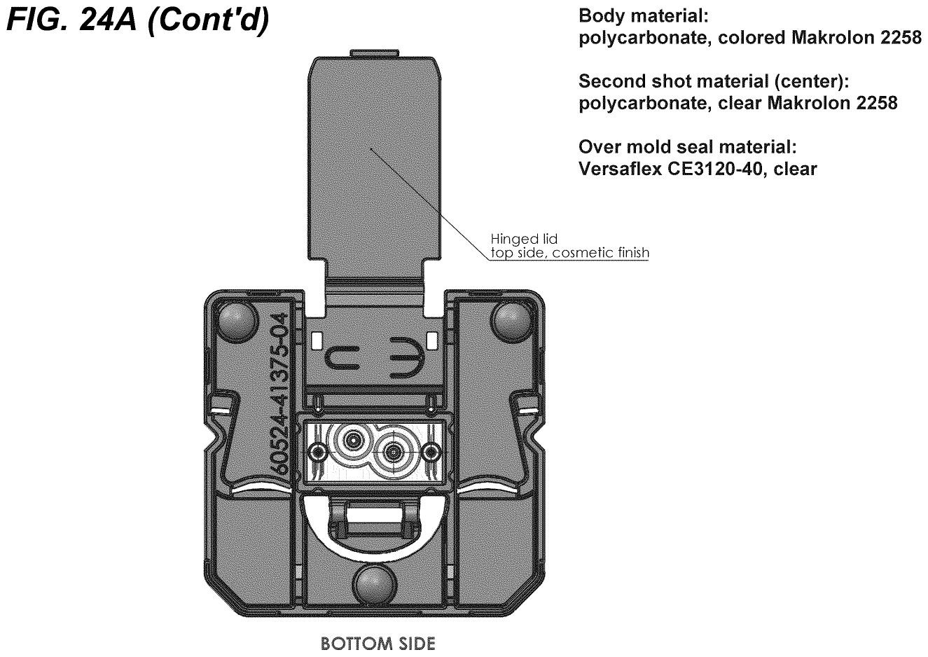

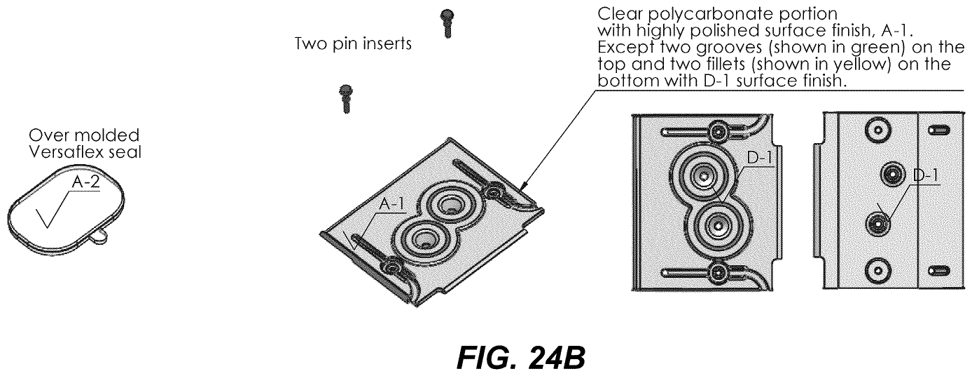

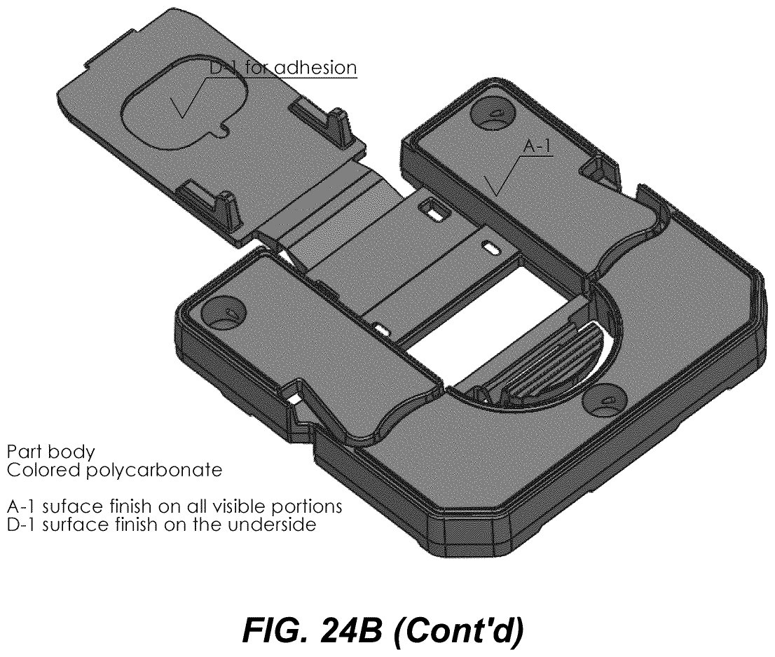

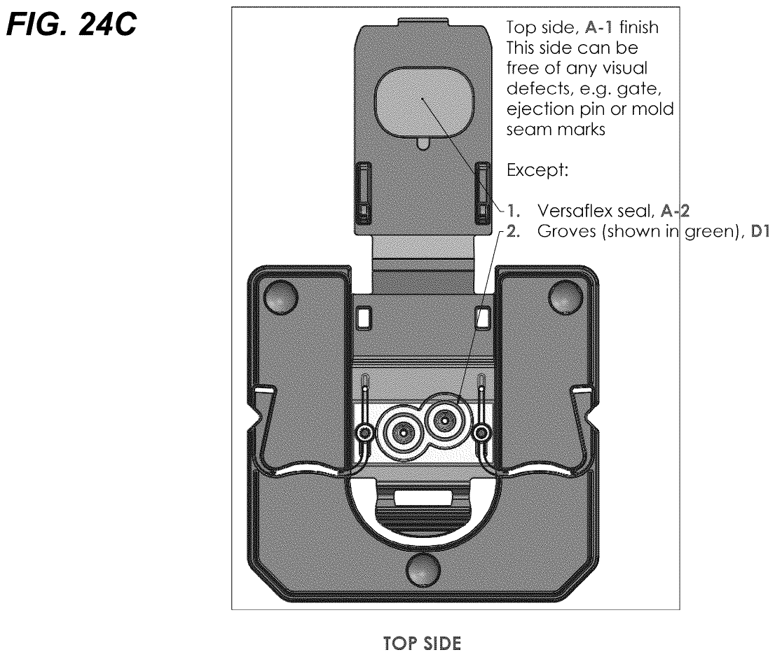

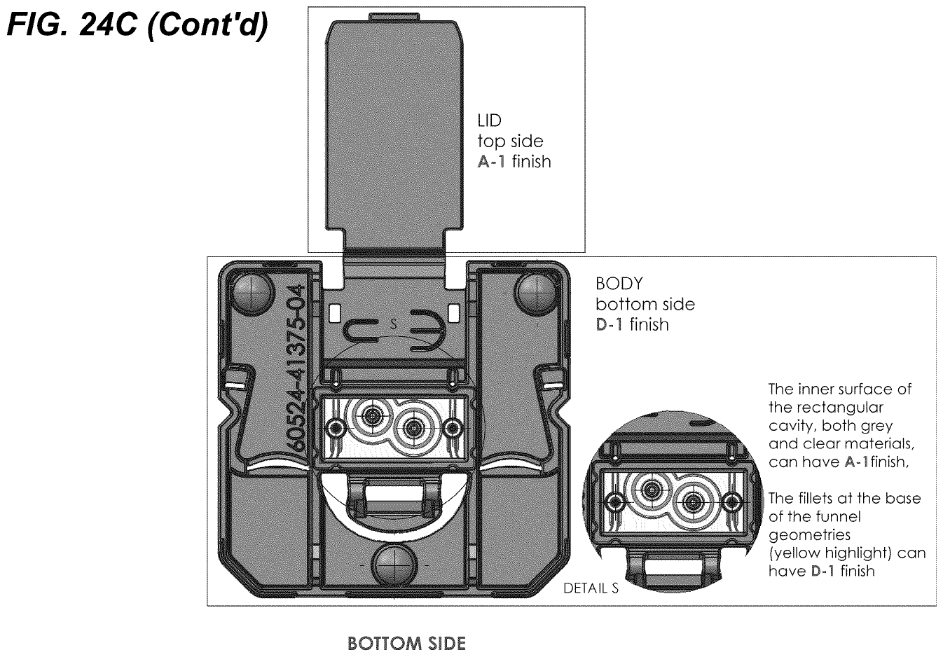

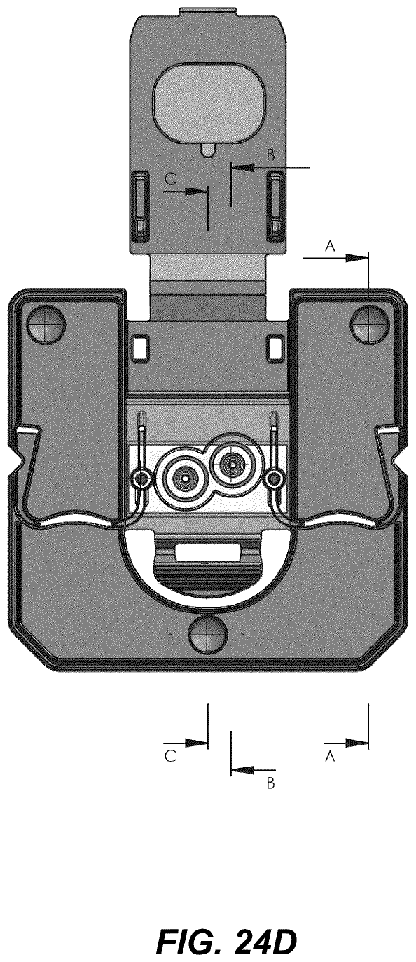

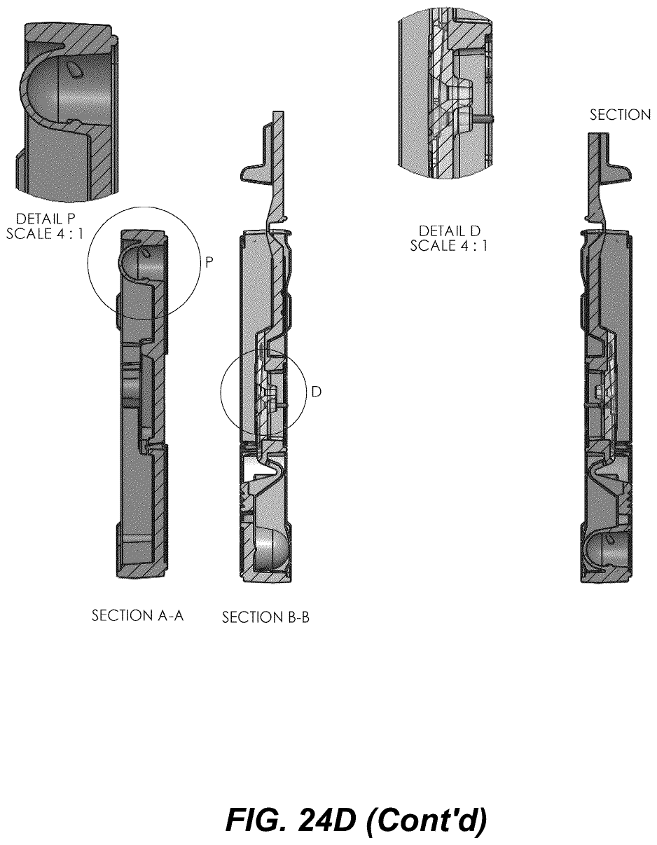

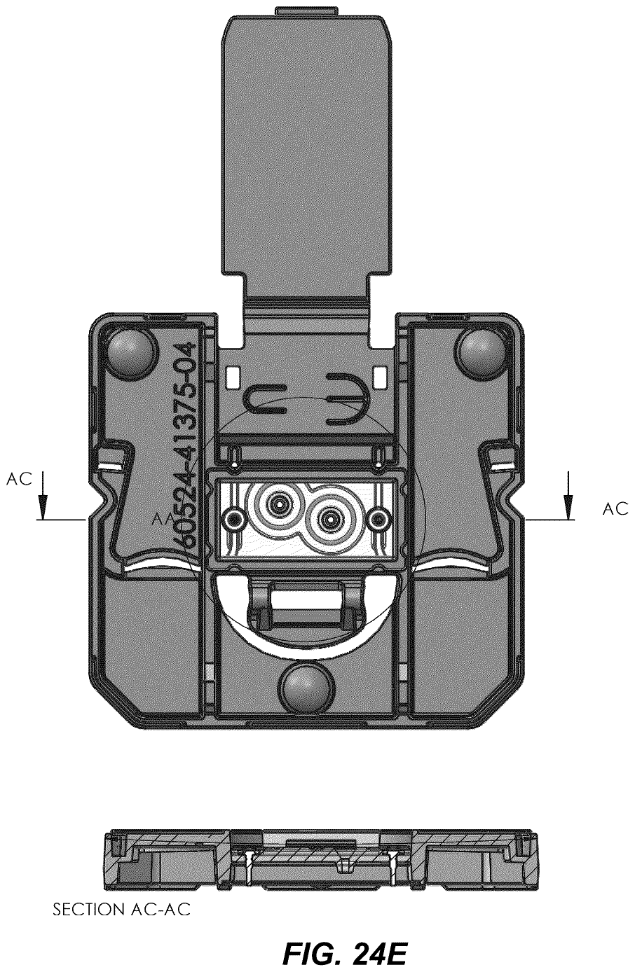

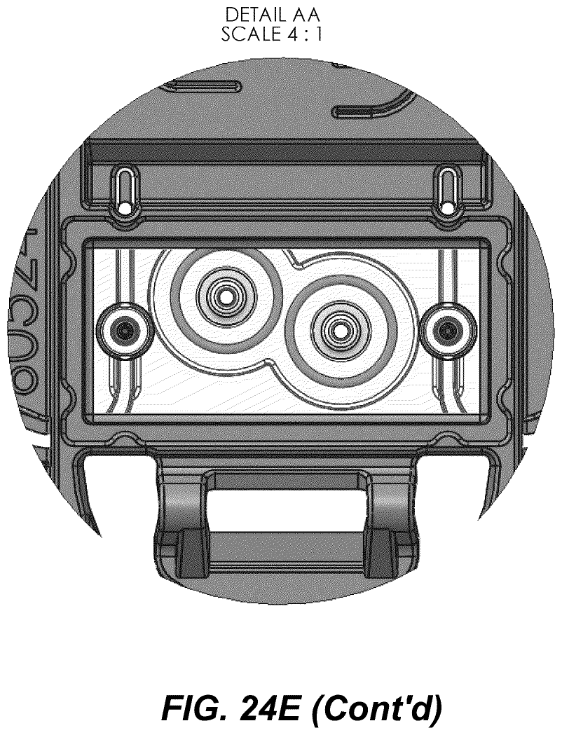

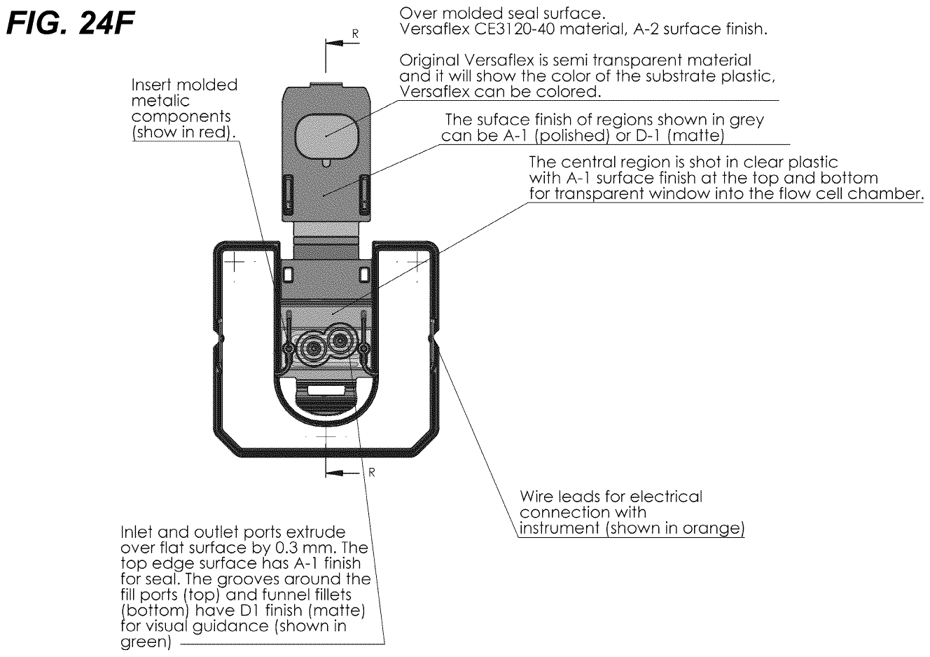

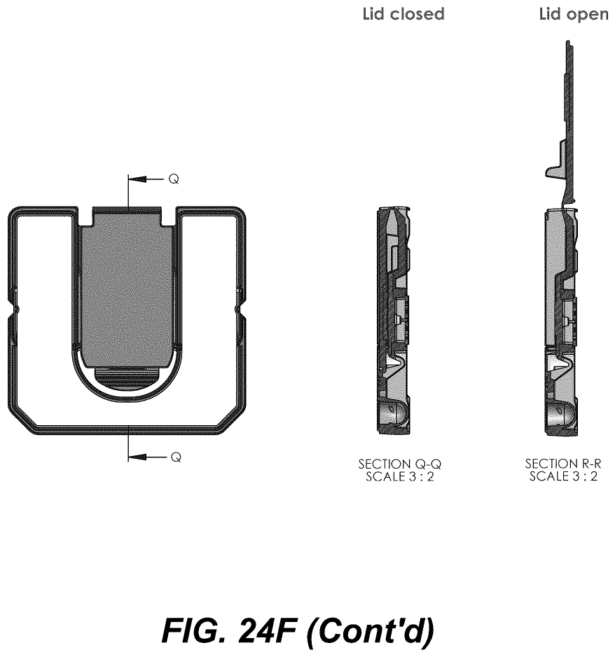

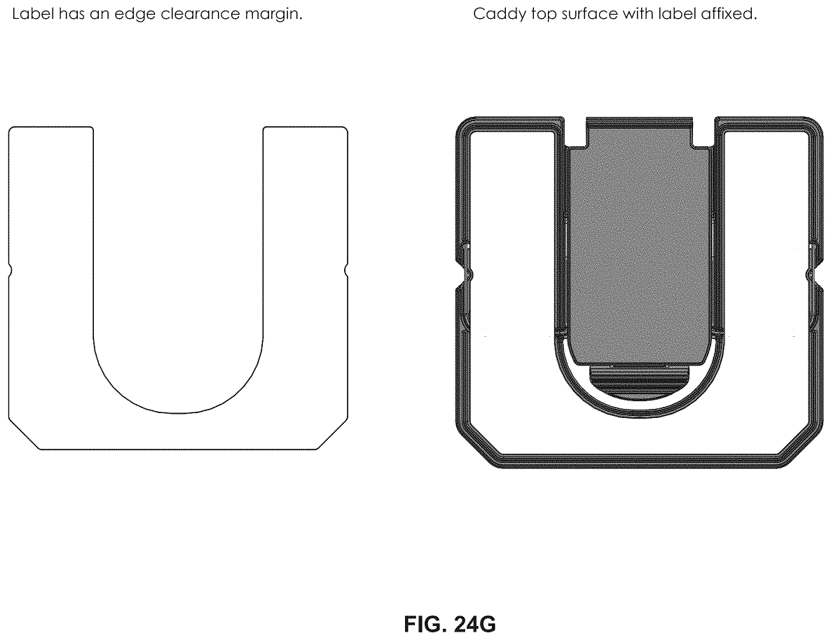

FIGS. 24A-24G illustrate non-limiting exemplary embodiments of a cartridge described herein (e.g., the embodiment of the cartridge depicted in FIGS. 23A-23F) and components of the cartridge.

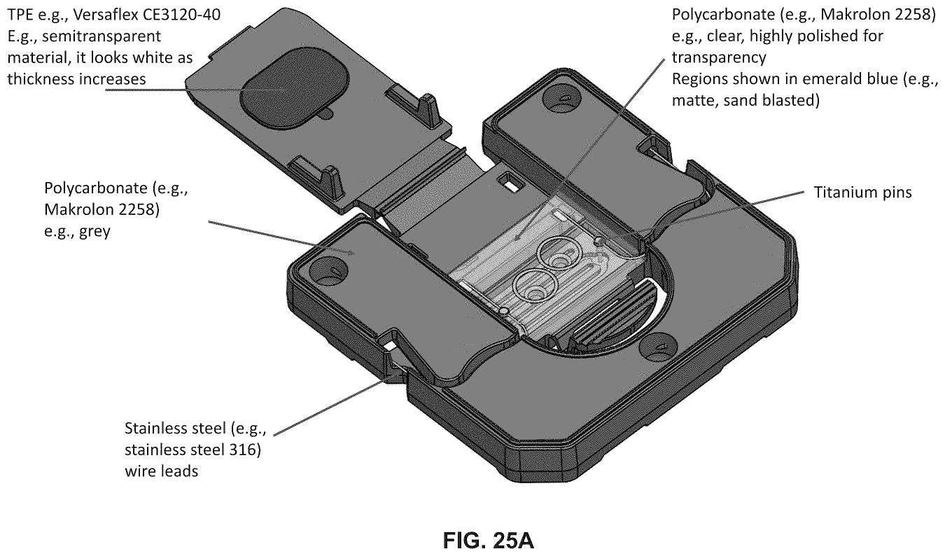

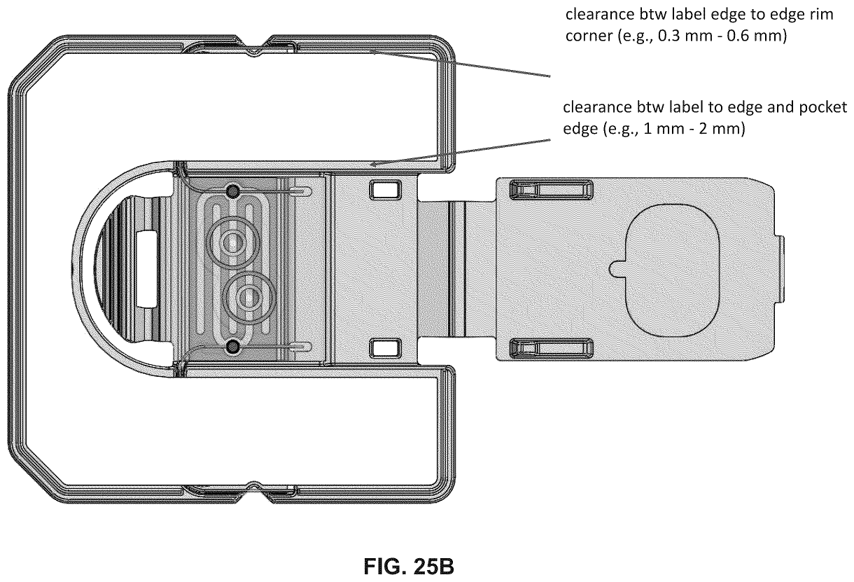

FIGS. 25A-25B depict a non-limiting embodiment of a cartridge described herein (e.g., the embodiments of the cartridge depicted in FIGS. 23A-23F and/or FIGS. 24A-24G): top isomeric view and open configuration without a label (FIG. 25A) and top view and open configuration with a label (FIG. 25B).

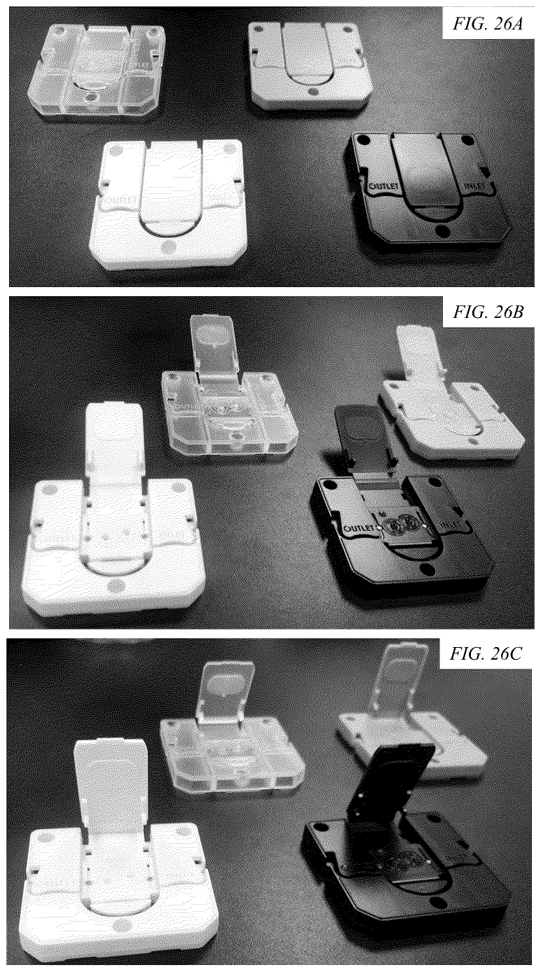

FIGS. 26A-26C depict a non-limiting embodiment of a cartridge described herein (e.g., the embodiments of the cartridge depicted in FIGS. 23A-23F, FIG. 24A-24G, and/or FIGS. 25A-25B): a close configuration (FIG. 26A) and closed configurations (FIGS. 26B-26C).

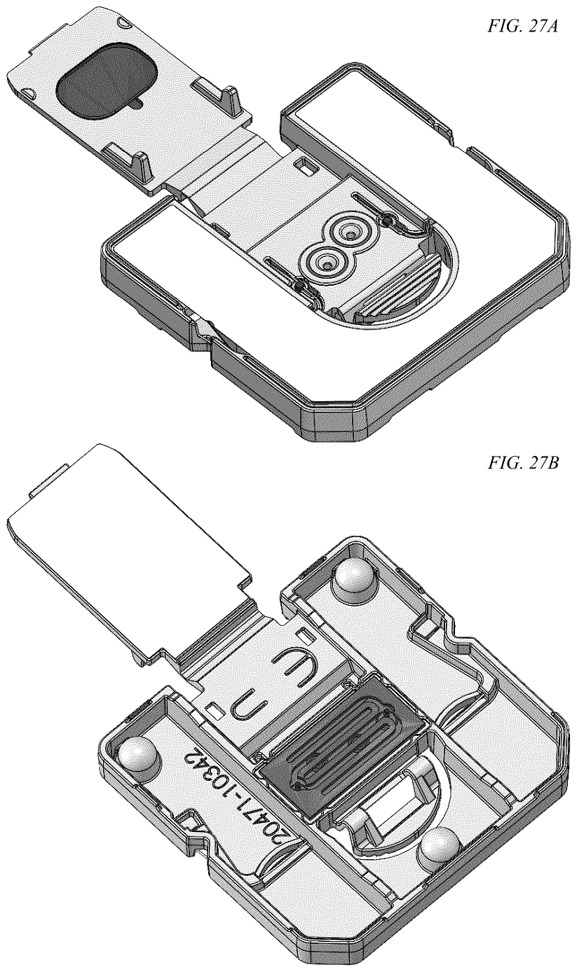

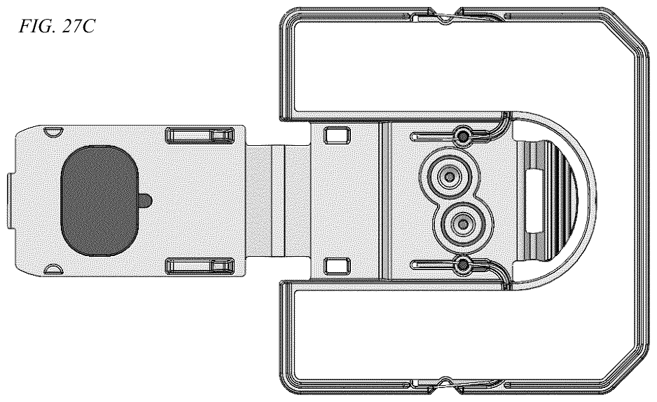

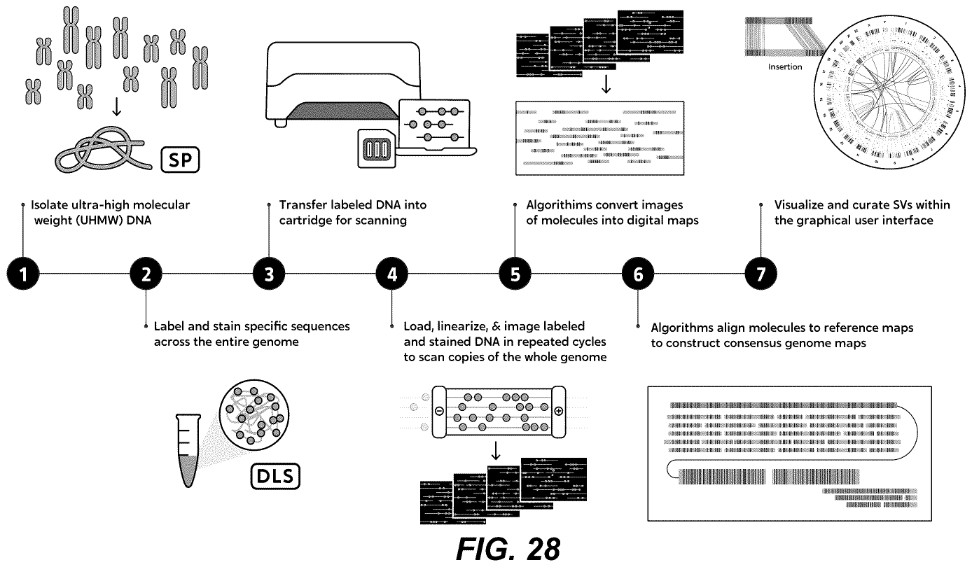

FIGS. 27A-27C depict a non-limiting embodiment of a cartridge described herein. Relative to the embodiments of the cartridge depicted in FIGS. 23A-23F, FIGS. 24A-24G, FIGS. 25A-25B, and/or FIGS. 26A-26C, the cartridge shown in FIGS. 27A-27C can include two extrusions (e.g., half-moon shaped extrusions). The two extrusions can be in contact with the wires and/or maintain the wires in contact with the base when the cartridge is in a closed configuration. A flow cell orientation key is shown in FIG. 27B.

### Cartridge Embodiments

Disclosed herein include cartridges, such as cartridges for microscopy, such as fluorescent microscopy (e.g., optical genome mapping). In some embodiments, a cartridge comprises a hermetic seal capable of preventing (or minimizing) evaporation of a liquid sample. In some embodiments, the prevention of evaporation can be at least or at least about 24 hours, 48 hours, 72 hours, 100 hours, 125 hours, 150 hours, 175 hours, 200 hours, 250 hours, 300 hours, 350 hours, 400 hours, 450 hours, 500 hours, 600 hours, 700 hours, 800 hours, 900 hours, 1000 hours, or more.

In some embodiments, the liquid sample comprises a biological sample. In some embodiments, the biological sample comprises one or more analytes. The analytes can comprise nucleic acid. The nucleic acid can be DNA. In some embodiments, the DNA is high molecular weight DNA, such as DNA that is at least 1 Mb, 1.25 Mb, 1.5 Mb, 1.75 Mb, or 2 Mb in length.

In some embodiments, the cartridge (or one or more components thereof, such as the base and the lid of the cartridge) comprises a polymer, a polycarbonate, a plastic, or a combination thereof. In some embodiments, the cartridge comprises a flow cell and one or more electrodes fluidically connected with the flow cell. For example, (a part of) an electrode can be present in the flow cell which allows (the part of) the electrode to contact the fluid that may be present in the flow cell when the cartridge is in use (or when the flow cell contains liquid). In some embodiments, the one or more electrodes comprise titanium and/or are titanium electrodes. In some embodiments, the one or more electrodes are insert molded.

In some embodiments, the one or more electrodes are fluidically connected (or in fluidic connection) to the flow cell when the cartridge is in a closed configuration. In some embodiments, the one or more electrodes are fluidically connected to the flow cell when the cartridge is in an open configuration. In some embodiments, the one or more electrodes are fluidically connected to the flow cell when the cartridge is both in a closed configuration and an open configuration. In some embodiments, the one or more electrodes are fluidically connected to the flow cell when the cartridge is in a closed configuration and not in an open configuration. In some embodiments, the one or more electrodes prevent (or minimize) evaporation.

In some embodiments, the one or more electrodes allow the liquid sample to be loaded into the flow cell. In some embodiments, the one or more electrodes comprise at least one hollow electrode. In some embodiments, the one or more electrodes are hollow electrodes. In some embodiments, the one or more electrodes are one or more loading ports for the liquid sample. In some embodiments, the one or more electrodes are for (or configured as) one or more loading ports for the liquid sample. In some embodiments, the one or more electrodes are sealed off with a thermoplastic elastomer (TPE) seal (e.g., a Versaflex seal) to prevent (or minimize) evaporation when the cartridge is in a closed configuration.

In some embodiments, the one or more electrodes comprise at least one solid electrode. In some embodiments, the one or more electrodes are solid electrodes. In some embodiments, the cartridge comprises one or more loading ports (which are not or are different from the one or more electrodes) for the liquid sample. In some embodiments, the one or more loading ports are sealed off with a thermoplastic elastomer (TPE) seal to prevent (or minimize) evaporation when the cartridge is in a closed configuration.

In some embodiments, the hermetic seal is formed by contacting the electrodes and a thermoplastic elastomer (TPE) seal. In some embodiments, the hermetic seal is formed by the loading ports and a thermoplastic elastomer (TPE) seal. The TPE seal can be an overmolded seal.

Disclosed herein include cartridges, such as cartridges for microscopy, such as fluorescent microscopy (e.g., optical genome mapping). In some embodiments, a cartridge comprises: a caddy. The cartridge can comprise a flow cell. A caddy can comprise a base (or a body or a lower body or a bottom body) and a lid. The base can comprise a central region (or a central part or a central piece). The central region can comprise one or more loading ports (e.g., two loading ports). The central region can comprise one or more electrodes (e.g., two electrodes). The one or more electrodes can be fluidically connected (or in fluidic connection) to the flow cell when the cartridge is both in a closed configuration and an open configuration. For example, (a part of) an electrode can be present in the flow cell which allows (the part of) the electrode to contact the fluid that may be present in the flow cell when the cartridge is in use (or when the flow cell contains liquid). The lid can comprise a seal. The seal and the one or more loading ports can form a hermetic seal when the caddy is in a closed configuration. The seal and the one or more loading ports can be capable of forming a hermetic seal when the caddy is in a closed configuration. The cartridge can comprise a flow cell.

Disclosed herein include cartridges, such as cartridges for microscopy, such as fluorescent microscopy (e.g., optical genome mapping). In some embodiments, a cartridge comprises: a caddy. The caddy can comprise a base (or a body or a lower body or a bottom body) and a lid (or a top body). The base can comprise one or more loading ports (e.g., 2 loading ports). The base can comprise one or more electrodes (e.g., 2 electrodes). The lid can comprise a seal. The seal and the one or more loading ports can form a hermetic seal when the cartridge is in a closed configuration. The cartridge can comprise a flow cell. In some embodiments, the base comprises a central region (or a central part of a central piece) comprising the one or more loading ports and the one or more electrodes.

In some embodiments, the lid is connected to the base. In some embodiments, the lid comprises a hinged lid connected to the base. In some embodiments, the lid is not connected to the base. In some embodiments, the lid is in contact with the base when the cartridge is in a closed configuration, not when the cartridge is in an open configuration. In some embodiments, the lid is in contact with the base when the cartridge is in a closed configuration and when the cartridge is in an open configuration.

In some embodiments, the one or more loading ports are for loading a liquid sample. In some embodiments, the seal and the one or more loading ports form a hermetic seal when the caddy is in a closed configuration. The seal and the one or more loading ports are capable of forming a hermetic seal when the caddy is in a closed configuration. The hermetic seal can prevent (or minimize) evaporation of a liquid sample loaded into the flow cell (or a sample loaded into the flow cell, or the content of the flow cell). The hermetic seal can be capable of preventing (or minimizing) evaporation of a liquid sample loaded into the flow cell (or a sample loaded into the flow cell, or the content of the flow cell). In some embodiments, the prevention (or minimization) of evaporation can be at least or at least about 24 hours, 48 hours, 72 hours, 100 hours, 125 hours, 150 hours, 175 hours, 200 hours, 250 hours, 300 hours, 350 hours, 400 hours, 450 hours, 500 hours, 600 hours, 700 hours, 800 hours, 900 hours, 1000 hours. or more.

In some embodiments, the liquid sample comprises a biological sample. In some embodiments, the biological sample comprises one or more analytes. The analytes can comprise nucleic acid. The nucleic acid can be DNA. In some embodiments, the DNA is high molecular weight DNA, such as DNA that is at least 1 Mb, 1.25 Mb, 1.5 Mb, 1.75 Mb, or 2 Mb in length.

In some embodiments, the base comprises two rounded edges. The number of round edges can be, for example, 1, 2, 3, or 4. The base can comprise two angled edges. The number of angled edges can be, for example, 1, 2, 3, or 4. The two rounded edges can be at a side of the base closer to the lid when the cartridge is in an open configuration. The two angled edges can be at a side of the base away from the lid when the cartridge is in an open configuration.

In some embodiments, the base comprises a polymer, a polycarbonate, a plastic, or a combination thereof. In some embodiments, the base other than the central region is not clear and/or not see through. In some embodiments, the base other than the central region is made in a first shot, and the central region is made in a second shot.

In some embodiments, the caddy comprises a polymer, a polycarbonate, a plastic, or a combination thereof. In some embodiments, the caddy other than the central region is not clear and/or not see through. In some embodiments, the caddy other than the central region and the seal is not clear and/or not see through. In some embodiments, the caddy other than the central region and the seal is made in a first shot, and the central region is made in a second shot.

In some embodiments, the central region comprises a polymer, a polycarbonate, a plastic, or a combination thereof. In some embodiments, the central region is clear and/or see through. In some embodiments, the central region comprises a groove corresponding to (or of or for) each of the one or more loading ports. The groove can be on a top surface of the central region. The central region can comprises a fillet corresponding to (or of or for) each of the one or more loading ports. The fillet can be on a bottom surface of the central region.

In some embodiments, the one or more loading ports comprise two loading ports. In some embodiments, the two loading ports (or all the loading ports) are identical in size and geometry. In some embodiments, a center of one of the one or more loading ports is on a line formed by the two of the one or more electrodes (on the top surface of the central region). In some embodiments, a center of one of the one or more loading ports (e.g., the inlet port) is not on a line formed by the two of the one or more electrodes (on the top surface of the central region). In some embodiments, a center of one of the one or more loading ports (e.g., the outlet port) has an offset from a line formed by the two of the one or more electrodes (on the top surface of the central region). In some embodiments, two (or each) of the one or more loading ports can be identical in shape (size and geometry).

In some embodiments, the one or more loading ports are funnel-shaped. In some embodiments, the one or more loading ports are sample funnels. In some embodiments, the one or more loading ports each has a size and a geometry to accept a pipette tip (e.g., a 5 μL, 10 μL, 15 μL, or 20 μL pipette tip). The one or more loading ports can have a shape to prevent (or minimize) introduction of air bubbles into the flow cell. In some embodiments, the one or more loading ports comprise an inlet port and an outlet port. In some embodiments, a loading port can be connected to a number of fingers (or channels), such as 2 or 3 fingers (or channels). For example, the inlet port can be connected to 2 fingers (or channels). For example, the outlet port can be connected to 3 fingers (or channels). In some embodiments, the one or more loading ports extrude over a top surface of the central region. The one or more loading ports can extrude over a top surface of the central region by, for example, (about) 0.1 mm, 0.15 mm, 0.2 mm, 0.25 mm, 0.3 mm, 0.35 mm, 0.4 mm, 0.45 mm, 0.5 mm, or a number or a range between any two of these values.

In some embodiments, the flow cell is formed by the base and a chip (or a flow cell chip). The chip can be inserted into to an opening at a bottom face of the base. The chip can be glued to the base. In some embodiments, the base comprises a chip orientation key on a bottom surface of the base.

In some embodiments, the one or more electrodes comprise two electrodes. In some embodiments, the one or more electrodes comprise one or more pins. In some embodiments, the one or more electrodes do not extrude from a top surface of the central region. In some embodiments, the one or more electrodes comprise titanium and/or are titanium electrodes. In some embodiments, the one or more electrodes are insert molded.

In some embodiments, the one or more electrodes are fluidically connected (or in fluidic connection) to the flow cell when the cartridge is in a closed configuration. In some embodiments, the one or more electrodes are fluidically connected to the flow cell when the cartridge is in an open configuration. In some embodiments, the one or more electrodes are fluidically connected to the flow cell when the cartridge is both in a closed configuration and an open configuration. In some embodiments, the one or more electrodes are fluidically connected to the flow cell when the cartridge is in a closed configuration and not in an open configuration. In some embodiments, the one or more electrodes prevent (or minimize) evaporation.

In some embodiments, the one or more electrodes allow the liquid sample to be loaded into the flow cell. In some embodiments, the one or more electrodes comprise at least one hollow electrode (e.g., 2 hollow electrodes). In some embodiments, the one or more electrodes are hollow electrodes. In some embodiments, the one or more electrodes are the one or more loading ports.

In some embodiments, the one or more electrodes comprises at least one solid electrode (e.g., 2 solid electrodes). In some embodiments, the one or more electrodes are solid electrodes.

In some embodiments, the seal comprises a thermoplastic elastomer (TPE) seal (e.g., a Versaflex seal). In some embodiments, the seal is overmolded. In some embodiments, the seal is oval in shape. The seal can be rectangular in shape. The seal can have rounded edges. The seal can have a tab.

In some embodiments, the base, the lid, the seal, and the electrodes are one piece. For example, the seal can be overmolded. The electrodes can be insert molded. The base and the lid can be made by the first shot in an injection molding process, and the central region can be made by the second shot in the injection molding process.

In some embodiments, the lid comprises one or more electrical connections for contacting the one or more electrodes. The one or more electrical connections can extrude from a top surface of the lid. The one or more electrical connections may not extrude from a top surface of the lid. The one or more electrical connections may not be exposed at a top surface of the lid. For example, the one or more electrical connections cannot be contacted with electrically at a top surface of the lid. The one or more electrical connections can comprise one or more pins.

In some embodiments, when the cartridge is in an open configuration, the one or more electrical connections are not in contact with the corresponding one or more electrodes. When the cartridge is in a closed configuration, the one or more electrical connections can be in contact with the corresponding one or more electrodes. In some embodiments, when the cartridge is in both an open configuration and a closed configuration, the one or more electrical connections are in contact with the corresponding one or more electrodes. In some embodiments, the one or more electrical connections is each in contact with a wire. The wire can be on or in the lid. The wire can be U-shaped. In some embodiments, the cartridge comprises one or more wires in contact with the one or more electrodes at a bottom surface of the base.

In some embodiments, the cartridge comprises one or more wires in contact with the one or more electrodes. For each of the one or more electrodes, a wire of the cartridge can be in contact with the electrode. Each wire can be in contact with a top of the corresponding electrode. An end of the wire (or the wire towards one end) can be in contact with the corresponding electrode. The other end of the wire (or the wire towards the other end) can be for contacting an electrical source. The other end of the wire (or the wire towards the other end) can for contacting an electrical source at a notch of the base. In some embodiments, each wire is U-shaped. A (vertical) side of the U-shaped wire can be in contact with the corresponding electrode. The other (vertical) side of the U-shaped wire can be for contacting an electrical source, e.g., at a notch of the base. The base can comprise a crevice (e.g., a U-shaped crevice) for embedding the wire (e.g., a U-shaped wire). In some embodiments, the one or more wires comprise stainless steel and/or are stainless steel wires.

In some embodiments, the base comprises one or more notches. The one or more notches corresponding to the one or more wires (one notch per wire). The one or more notches can comprise V-notches (or be V-shaped). Each of the one or more notches can be at a different side of the base. Each of two of the one or more notches can be on the opposite sides of the base. The one or more wires can be exposed at the corresponding one or more notches. The one or more wires can be contacted (or contactable) at the corresponding one or more notches.

In some embodiments, the base comprises a latch. The base can comprise a release button. When the cartridge is in a closed configuration, a tip of the lid can be inserted into the latch to secure (or releasably secure) the lid to the base to form the hermetic seal. When the cartridge is in a closed configuration, a tip of the lid can released from the latch when the release button is depressed (or by depressing the release button). The cartridge can change from an open configuration to a closed configuration by inserting a tip of the lid into the latch to secure (or releasably secure) the lid to the base to form the hermetic seal.

In some embodiments, the lid comprises one or more extrusions. An extrusion can be half-moon shaped (or oval shaped or rectangular shape or square shape). When the cartridge is in a closed configuration, an extrusion can be in contact with a wire to maintain contact of the wire with the base.

In some embodiments, the base comprises at least three. The nests can comprise circular nests. Each of the three nests can comprise at least one extruding retainer (e.g., 1, 2, 3, or more, extruding retainers). In some embodiments, the cartridge comprises a metal ball inserted into each of the nest. In some embodiments, the base comprises a label on a top surface of the base. The label can cover the at least three nests.

In some embodiments, the base is, is about, is at least, is at least about, is at most, or is at most about, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, 50 mm, 51 mm, 52 mm, 53 mm, 54 mm, 55 mm, 56 mm, 57 mm, 58 mm, 59 mm, 60 mm, 61 mm, 62 mm, 63 mm, 64 mm, 65 mm, 66 mm, 67 mm, 68 mm, 69 mm, 70 mm, 71 mm, 72 mm, 73 mm, 74 mm, 75 mm, or a number or a range between any two of these values, in width. The base can be, be about, be at least, be at least about, be at most, or be at most about, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, 50 mm, 51 mm, 52 mm, 53 mm, 54 mm, 55 mm, 56 mm, 57 mm, 58 mm, 59 mm, 60 mm, 61 mm, 62 mm, 63 mm, 64 mm, 65 mm, 66 mm, 67 mm, 68 mm, 69 mm, 70 mm, 71 mm, 72 mm, 73 mm, 74 mm, 75 mm, or a number or a range between any two of these values, in length. The base can be, be about, be at least, be at least about, be at most, or be at most about, 4 mm, 4.1 mm, 4.2 mm, 4.3 mm, 4.4 mm, 4.5 mm, 4.6 mm, 4.7 mm, 4.8 mm, 4.9 mm, 5 mm, 5.1 mm, 5.2 mm, 5.3 mm, 5.4 mm, 5.5 mm, 5.6 mm, 5.7 mm, 5.8 mm, 5.9 mm, 6 mm, 6.1 mm, 6.2 mm, 6.3 mm, 6.4 mm, 6.5 mm, 6.6 mm, 6.7 mm, 6.8 mm, 6.9 mm, 7 mm, 7.1 mm, 7.2 mm, 7.3 mm, 7.4 mm, 7.5 mm, 7.6 mm, 7.7 mm, 7.8 mm, 7.9 mm, 8 mm, or a number or a range between any two of these values, in thickness (e.g., thickest part).

In some embodiments, the lid is, is about, is at least, is at least about, is at most, or is at most about, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, or a number or a range between any two of these values, in width. The lid can be, be about, be at least, be at least about, be at most, or be at most about, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, 50 mm, 51 mm, 52 mm, 53 mm, 54 mm, 55 mm, or a number or a range between any two of these values, in length. The lid can be, be about, be at least, be at least about, be at most, or be at most about, 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, 5 mm, 5.1 mm, 5.2 mm, 5.3 mm, 5.4 mm, 5.5 mm, or a number or a range between any two of these values in thickness (e.g., thickest part).

In some embodiments, the seal is, is about, is at least, is at least about, is at most, or is at most about, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, or a number or a range between any two of these values, in width. The seal can be, be about, be at least, be at least about, be at most, or be at most about, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, or a number or a range between any two of these values, in length. The seal can be, be about, be at least, be at least about, be at most, or be at most about, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, 5 mm, or a number or a range between any two of these values, in thickness.

In some embodiments, the hinge is, is about, is at least, is at least about, is at most, or is at most about, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, or a number or a range between any two of these values, in width. The hinge can be, be about, be at least, be at least about, be at most, or be at most about, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, 5 mm, or a number or a range between any two of these values, in length, The hinge can be, be about, be at least, be at least about, be at most, or be at most about, 0.2 mm, 0.3 mm, 0.4 mm, 0.5 mm, 0.6 mm, 0.7 mm, 0.8 mm, 0.9 mm, 1 mm, or a number or a range between any two of these values, in thickness (e.g., thickest part).

In some embodiments, the tip inserted into the latch is, is about, is at least, is at least about, is at most, or is at most about, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, or a number or a range between any two of these values, in width. The tip inserted into the latch can be, be about, be at least, be at least about, be at most, or be at most about, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2 mm, 3 mm, 4 mm, 5 mm, or a number or a range between any two of these values, in length.

In some embodiments, the latch is, is about, is at least, is at least about, is at most, or is at most about, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, or a number or a range between any two of these values, in width. The latch can be, be about, be at least, be at least about, be at most, or be at most about, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, or a number or a range between any two of these values, in length.

In some embodiments, the nest is, is about, is at least, is at least about, is at most, or is at most about, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, or a number or a range between any two of these values, in diameter (or radius). The nest can be, be about, be at least, be at least about, be at most, or be at most about, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, or a number or a range between any two of these values, in depth.

In some embodiments, the offset (from a center of one loading port and a line formed by two electrodes) is, is about, is at least, is at least about, is at most, or is at most about, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, 5 mm, or a number or a range between any two of these values. Two loading ports can be separated from each other by, by about, by at least, by at least about, by at most, or by at most about, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, or a number or a range between any two of these values.

In some embodiments, the groove is, is about, is at least, is at least about, is at most, or is at most about, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, or a number or a range between any two of these values, in diameter (or radius). The fillet can be, be about, be at least, be at least about, be at most, or be at most about, 1 mm, 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, or a number or a range between any two of these values, in diameter (or radius)

In some embodiments, two electrodes are separated from each other by, by about, by at least, by at least about, by at most, or by at most about, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 16.5 mm, 17 mm, 17.5 mm, 18 mm, 18.5 mm, 19 mm, 19.5 mm, 20 mm, 20.5 mm, 21 mm, 21.5 mm, 22 mm, 22.5 mm, 23 mm, 23.5 mm, 24 mm, 24.5 mm, 25 mm, 25.5 mm, 26 mm, 26.5 mm, 27 mm, 27.5 mm, 28 mm, 28.5 mm, 29 mm, 29.5 mm, 30 mm, or a number or a range between any two of these values.

In some embodiments, the chip is, is about, is at least, is at least about, is at most, or is at most about, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, 50 mm, or a number or a range between any two of these values, in width. The chip can be, be about, be at least, be at least about, be at most, or be at most about, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 16.5 mm, 17 mm, 17.5 mm, 18 mm, 18.5 mm, 19 mm, 19.5 mm, 20 mm, 20.5 mm, 21 mm, 21.5 mm, 22 mm, 22.5 mm, 23 mm, 23.5 mm, 24 mm, 24.5 mm, 25 mm, or a number or a range between any two of these values, in length.

In some embodiments, the opening to which the chip is inserted or glued to is, is about, is at least, is at least about, is at most, or is at most about, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, 50 mm, or a number or a range between any two of these values, in width. The opening to which the chip is inserted or glued to can be, be about, be at least, be at least about, be at most, or be at most about, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 16.5 mm, 17 mm, 17.5 mm, 18 mm, 18.5 mm, 19 mm, 19.5 mm, 20 mm, 20.5 mm, 21 mm, 21.5 mm, 22 mm, 22.5 mm, 23 mm, 23.5 mm, 24 mm, 24.5 mm, 25 mm, or a number or a range between any two of these values, in length.

In some embodiments, an electrode is, is about, is at least, is at least about, is at most, or is at most about, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, 5 mm, 5.1 mm, 5.2 mm, 5.3 mm, 5.4 mm, 5.5 mm, 5.6 mm, 5.7 mm, 5.8 mm, 5.9 mm, 6 mm, 6.5 mm, 7 mm, 7.5 mm, 8 mm, 8.5 mm, 9 mm, 9.5 mm, 10 mm, or a number or a range between any two of these values, in length. An electrode can extrude into the flow cell by, by about, by at least, by at least about, by at most, or by at most about, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, or a number or a range between any two of these values.

Disclosed herein include methods for performing microscopy, such as fluorescent microscopy (e.g., optical genome mapping). In some embodiments, a method of performing for microscopy, such as fluorescent microscopy (e.g., optical genome mapping) comprises using a cartridge disclosed herein. Disclosed herein include methods for performing optical genome mapping. In some embodiments, a method of performing optical genome mapping comprises using a cartridge disclosed herein.

### Optical Genome Mapping

FIG. 15 illustrates a non-limiting exemplary workflow of optical genome mapping (OGM). The OGM workflow can start with mega-base size DNA isolation, e.g., 150 kbp or longer. A single enzymatic reaction can label the genome at a specific sequence motif occurring, e.g., approximately 15 times per 100 kbp in the human genome. The long, labeled DNA molecules can be linearized in nanochannel arrays (e.g., provided by a cartridge or chip, such as the cartridge disclosed herein) and imaged in an automated manner by an OGM instrument (e.g., an OGM system or one or more components described herein). Samples being imaged can be placed precisely (e.g., using the designs, platforms, stages, and/or methods described herein) at the appropriate distance from the optics to produce focused images. The molecules can be assembled into local maps or whole genome maps. Changes in patterning or spacing of the labels can be detected, genome-wide, to call structural variants.

Optical Genome Mapping (OGM) is an imaging technology which evaluates the fluorescent labeling pattern of individual DNA molecules to perform an unbiased assessment of genome-wide structural variants down to, e.g., 500 base pairs (bp) in size, a resolution that far exceeds conventional cytogenetic approaches. OGM can rely on a specifically designed extraction protocol facilitating the isolation of high molecular weight (HMW) or ultra-high molecular weight (UHMW) DNA ultra-high molecular weight (UHMW) DNA. This protocol can, in some embodiments, utilize a paramagnetic disk purposed with trapping DNA for wash steps thereby reducing sheering forces present in standard column-based extraction methods. The result can be DNA fragments (or molecules) of about 150 kilobases (kbp) to megabases (Mbp) in size, about 5-10× longer than the average fragment size from conventional DNA isolations techniques. Referring to FIG. 15, DNA can be fluorescently labeled via covalent modification at a motif (which can be 4, 5, 6, 7, 8, 9, 10, or more nucleotides in length), such as a hexamer motif (e.g., the CTTAAG hexamer motif), generating genome-wide density of a number of labels per 100 kb in sequence specific patterns (e.g., approximately 14-17 labels per 100 kb, or 10, 11, 12, 13, 14, 15, 16, 17, 18, 19, 20, or more or fewer labels per 100 kb). Labeled DNA can be loaded on chips (e.g., silicon chips) composed of hundreds of thousands of parallel nanochannels where individual DNA molecules are linearized, imaged, and digitized. The specific labeling profile of individual DNA molecules, including spacing and pattern of hexamers labels, can be subsequently grouped based on similarity, producing about 500 kbp (or longer or shorter, such as 300 kbp, 400 kbp, 500 kbp, 600 kbp, 700 kbp, 800 kbp, 900 kbp, 1000 kbp) to megabase-sized consensus maps, which can be compared in silico to the expected labeling pattern of a reference genome (FIG. 15). This imaging technology converts DNA into a “barcode” whose labeling profile and characteristics can sensitively and specifically resolve copy number and structural variation without the need for sequence level data (FIG. 15). The quality of the DNA, including both size and labeling characteristics, as well as the number of images captured can influence genome-wide coverage. For example, each flow cell, which can accommodate a single specimen, can generate, for example, up to 5000 Gigabase pairs (Gbp) of raw data (or 3000 Gbp, 4000 Gbp, 5000 Gbp, 6000 Gbp, 7000 Gbp, 8000 Gbp, 9000 Gbp, 10000 Gbp, or more or less, of raw data), achieving a maximum theoretical genome-wide coverage of about 1250× (or 500×, 750×, 1000×, 1250×, 1500×, 1750×, 2000×, or more or less). Bioinformatics analyses can be performed. Example bioinformatics analysis can include: de novo structural variant analysis for typical germline assessments (e.g., greater than about 80×-coverage; requiring greater than about 400 Gbp data collection) or ‘Rare Variant Analysis (RVP)’ for somatic assessment down to a ~5% variant allele fraction (e.g., greater than about 340× coverage; requiring greater than about 1500 Gbp data). Both algorithms facilitate the detection of a wide array of structural variants; from copy number gains/losses to balanced/unbalanced translocations and insertions to inversions.

Optical genome mapping (OGM) can be used to analyze large eukaryotic genomes and their structural features at a high resolution. OGM uses linearized strands of high molecular weight (HMW) or ultra-high molecular weight (UHMW) DNA that are far longer than the DNA sequences analyzed in current second- and third-generation sequencing methods, achieving average read lengths in excess of 200 kbp. The usage of long molecules in OGM can allow repetitive regions and other regions that are complicated to map to be spanned more easily than with short molecules. This leads to the creation of maps that may cover the whole arm of a chromosome and yet allow the detection of insertions and deletions as small as 500 bp (or longer or shorter, such as 300 kbp, 400 kbp, 500 kbp, 600 kbp, 700 kbp, 800 kbp, 900 kbp, 1000 kbp) other SVs may need to be 30 kbp (or 10 kbp, 20k kbp, 30 kbp, 40 kbp, or 50 kbp)) or larger to be detectable. OGM can be used to, for example, detect the breakpoints of chromosomal translocations, for the diagnosis of facioscapulohumeral muscular dystrophy (FSHD). OGM may be used as a cytogenomic tool for prenatal diagnostics

Extraction/Isolation. UHMW DNA can be extracted for OGM, for example. UHMW DNA extraction can be done using isolation kits, such as kits from Bionano Genomics, Inc. (San Diego, CA). In some embodiments, DNA from approximately 1.5×10⁶ cells (or 1×10⁵, 1.5×10⁵, 2.5×10⁵, 5×10⁵, 7.5×10⁵, 1×10⁶, 1.5×10⁶, 2.5×10⁶, 5×10⁶, 7.5×10⁶, 1×10⁷ or more or fewer cells) can be extracted. The extraction can include immobilizing cells in agarose plugs and lysing the immunized cells by proteinase K; thereafter. The extraction can include washing, recovering, and quantifying the genomic DNA. Alternatively or additionally, the genomic DNA can be bound to a magnetic disk. Subsequently, the DNA can be washed, recovered, and quantified.

Labeling and Processing. A sufficient quantity of UHMW DNA (e.g., 250 ng, 500 ng, 750 ng, 1000 ng, 1250 ng, 1500 ng, 1750 ng, 2000 ng, or more UHMW DNA) can be labeled with a fluorophore. Such labeling can be done using a methyltransferase, such as the methyltransferase direct labeling enzyme (DLE-1) at the recognition motif of the methyltransferase, such as CTTAAG. This can generate a number of labels per 100 kbp (e.g., approximately 14-15 labels per 100 kbp, or 10, 11, 12, 13, 14, 15, 16, 17, 18, 19, 20, or more or less labels per kbp) when labeling human genomic DNA. In some embodiments, such labeling can be done using another enzyme (e.g., an endonuclease) at the recognition motif of the enzyme (e.g., GCTCTTCN of endonuclease Nt.BspQI).

Thereafter, the DNA can be dialyzed, its backbone stained, and finally the prepared DNA can be applied to flow cells (e.g., G1.2 flow cells from Bionano Genomics, Inc.) The flow cell can then be inserted into an OGM instrument, such as the Saphyr® or Marvel instrument or newer from Bionano Genomics, Inc. In the instrument, the DNA can be fed by electrophoresis into the nanochannels of the flow cell for linearization. DNA-filled nanochannels can be scanned using, for example, a fluorescence microscope. The captured images can be converted to electronic representations of the DNA molecules. The virtual DNA strands can then filtered and de novo assembled into maps (FIG. 15).

OGM Data Assembly. The data acquired with the OGM instrument can be processed. For example, the raw data can be filtered for a minimum length of 150 kbp (or 100 kbp, 125 kbp, 150 kbp, 175 kbp, 200 kbp, or more) and minimum of nine labels (or 5, 6, 7, 8, 9, 10, 11, 12, 13, 14, 15, or more labels) per molecule (or fragment). The filtered molecules can be assembled, e.g., with de novo assembly. The consensus maps of the molecules can be aligned to a reference genome sequence, such as the human reference genome GRCh38. Variants can be detected. Variants detection can be performed using, for example, a SV pipeline, comparing the maps to the aligned reference genome. There, patterns of markers from the maps deviating from the reference become apparent. Variants detections can be performed using, for example, a CNV pipeline,” which quantifies the mapped molecules and hence is able to detect gains and losses of several hundred kbp in size.

The results of the SV pipeline can then be augmented by, for example, a variant annotation pipeline, which adds quality metrics for the called variants and supplies their estimated frequency in the human population based on an internal database. The optional step of filtering based on the frequency of the SVs in the internal database may (or may not) be used in some implementations. The SVs can be detected or called. Automatic calling can be based on the confidence scores and sizes of the SVs (insertions and deletions: confidence>0, size>500 bp; inversions: confidence >0.7, size>30 kbp; duplications: confidence=−1, size>30 kbp; intrachromosomal translocations: confidence >0.3; interchromosomal translocations: confidence >0.65; CNV confidence >0.99, size>500 kbp). Additionally, each called SV can be required to be spanned by >5 strands of DNA.

The total amount of unfiltered DNA scanned by the OGM system can be, or be about, 750 Gbp, 800 Gbp, 850 Gbp, 900 Gbp, 916 Gbp, 925 Gbp, 950 Gbp, 1000 Gbp, 1250 Gbp, or more, per sample on average. An effective coverage of the reference can be, or can be greater than, 40×, 50×, 60×, 70×, 80×, 90×, or more, per sample. The effective coverage of the reference can be defined as the total length of filtered (≥150 kbp) and aligned molecules divided by the length of the reference genome after de novo assembly

Further details regarding various aspects of OGM can be found in U.S. Pat. Nos. 11,359,244; 11,292,713; 11,291,999; 10,995,364; 10,844,424; 10,676,352; 10,669,586; 10,654,715; 10,435,739; 10,247,700; 10,000,804; 10,000,803; 9,845,238; 9,809,855; 9,804,122; 9,725,315; 9,536,041; 9,533,879; 9,310,376; 9,181,578; 9,061,901; 8,722,327; and 8,628,919; as well as published PCT Application Publication Nos. WO2020/005846; WO2016/036647; WO2015/134785; WO2015/130696; WO2015/126840; WO2015/017801; WO2014/200926; WO2014/130589; WO2014/123822; WO2013/036860; WO2012/054735; WO2011/050147; WO2011/038327 and WO2010/13532; the content of each of which is incorporated herein by reference in its entirety.

### ADDITIONAL CONSIDERATIONS

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. As used in this specification and the appended claims, the singular forms “a,” “an,” and “the” include plural references unless the context clearly dictates otherwise. Any reference to “or” herein is intended to encompass “and/or” unless otherwise stated.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A carousel comprising a plurality of parallel processing lines each for holding a cartridge and comprising a set of electrical contacts for electrophoretically loading a DNA sample into channels in a flow cell of the cartridge.

2. The carousel of claim 1, wherein the plurality of parallel processing lines comprises 2-20 parallel processing lines.

3. The carousel of any one of claims 1-2, wherein the plurality of parallel processing lines comprises 15 parallel processing lines.

4. An optical genome mapping (OGM) system comprising a carousel of any one of claims 1-3.

5. The OGM system of claim 4, wherein the carousel is upstream of an imaging subsystem of the OGM system

6. The OGM system of any one of claims 4-5, wherein the carousel is physically detached from motion axes of the imaging subsystem.

7. The OGM system of any one of claims 4-6, wherein the imaging subsystem is associated with or comprises a motion platform for holding the cartridge and imaging the DNA sample.

8. The OGM system of claim 7, wherein the motion platform comprises 2 motors for adjusting a x-y motion stage and a tip and the tilt (TnT) motion stage of the motion platform.

9. The OGM system of claim 8, wherein a set of consumable engagement effectors associated with or comprised in the imaging subsystem are activated based on a position of the x-y motion stage.

10. The OGM system of any one of claims 4-9, wherein the imaging subsystem is associated with or comprises a set of electrical contacts for electrophoretically loading a DNA sample into channels in a flow cell of the cartridge.

11. The OGM system of claim 10, wherein the imaging subsystem is associated with or comprises a set of consumable engagement effectors comprising the set of electrical contacts, and wherein the set of consumable engagement effectors contributes or enables to precisely positioning the cartridge.

12. The carousel or the OGM system of any one of claims 1-11, wherein the cartridge comprises a set of cartridge electrical contacts for contacting the set of electrical contacts.

13. The carousel or the OGM system of any one of claims 1-12, wherein the set of electrical contacts are spring-loaded.

14. The carousel or the OGM system of any one of claims 1-13, wherein the cartridge comprises two notches each comprising a cartridge electrical contact of the set of cartridge electrical contacts, wherein the two notches are V-shaped, wherein the two notches are at opposite sides of the cartridge, and/or wherein the set of consumable engagement effectors is capable of engaging with the two notches.

15. The OGM system of any one of claims 4-14, comprising a cartridge transfer mechanism for transferring the cartridge between the imaging subsystem, the carousel, and a shuttle mechanism.

16. The OGM system of claim 15, wherein the cartridge transfer mechanism comprises an arm mounted to a rotary motor.

17. The OGM system of any one of claims 4-16, comprising a shuttle mechanism for transferring a cartridge from a nest external of the OGM instrument to a floating core of the OGM instrument.

18. The OGM system of claim 17, wherein the shuttle mechanism comprises a motion axis.

19. The OGM system of claim 18, wherein the motion axis comprises a zone spatially located related to a chassis of the OGM instrument and/or a zone spatially located relative to a floating core of the OGM instrument.

20. The OGM system of any one of claims 18-19, wherein the motion axis is detached from a floating core of the OGM instrument when not transferring a cartridge from a nest external of the OGM instrument to a floating core of the OGM instrument.
